(19) United States
(12) Patent Application Publication
(10) Pub. No.: US 2023/0354867 A1
(43) Pub. Date: Nov. 9, 2023

(54) NUTRITIONAL COMPOSITIONS AND METHODS RELATED THERETO

(71) Applicants: Alistair James CARR, Palmerston North (NZ); Timothy Michael Theo HOEKSTRA, Rakaia (NZ); Hyunah Eustina FRASER, RaKaia (NZ); Anna Marie WILLIAMS, Rakaia (NZ); Craig Thomas BENNISON, Rakaia (NZ); Aoife Katie BUGGY, Rakaia (NZ); SYNLAIT MILK LIMITED, Rakaia (NZ)

(72) Inventors: Alistair James CARR, Palmerston North (NZ); Timothy Michael Theo HOEKSTRA, Rakaia (NZ); Hyunah Eustina FRASER, Rakaia (NZ); Anna Marie WILLIAMS, Rakaia (NZ); Craig Thomas BENNISON, Rakaia (NZ); Aoife Katie BUGGY, Rakaia (NZ)

(73) Assignee: SYNLAIT MILK LIMITED, Rakaia (NZ)

(21) Appl. No.: 18/245,643

(22) PCT Filed: Mar. 8, 2022
(86) PCT No.: PCT/NZ2022/050026

§ 371 Date: Mar. 16, 2023

(30) Foreign Application Priority Data
Mar. 10, 2021 (AU) 2021900672

(51) Int. Cl. A23L 33/19; A23L 33/185; A23L 33/125; A23L 33/00; A23C 21/06; A23C 3/027

(52) U.S. Cl. CPC A23L 33/19; A23L 33/185; A23L 33/125; A23L 33/40; A23C 21/06; A23C 3/027

(57) ABSTRACT

The present invention relates to methods for preparing liquid nutritional compositions, including liquid nutritional compositions comprising one or more proteins such as milk proteins, the liquid nutritional compositions themselves, and to methods for using such liquid nutritional compositions.

### TECHNICAL FIELD

The invention relates to nutritional compositions, including nutritional compositions comprising one or more proteins such as milk proteins, such as liquid nutritional compositions including enteral formulations, sports beverages, medical foods, meal replacers, and ready-to-feed liquid nutritional compositions, and methods for preparing such compositions and of their use.

### BACKGROUND OF THE INVENTION

The following includes information that may be useful in understanding the present inventions. It is not an admission that any of the information provided herein is prior art, or relevant, to the presently described or claimed inventions, or that any publication or document that is specifically or implicitly referenced is prior art. Any discussion of the prior art throughout the specification should in no way be considered as an admission that such prior art is widely known or forms part of the common general knowledge in the field.

Nutritional compositions comprising milk protein are widely used to meet or supplement normal feeding requirements, for example in infant nutrition where the use of ready-to-feed (RTF) formulations and infant powders is common, and to provide specialised nutrition to particular consumers. For example, nutritional compositions enriched in whey protein are commonly used to provide nutritional benefit to those who desire or would benefit from maintained or increased protein needs, or maintained or increased muscle mass, such as growing infants and children, athletes, the elderly, as well as those with more specific therapeutic need, such as cachexic patients or those in need of weight control.

Casein is often used in high-protein, high energy content liquid nutritional compositions. In certain circumstances destabilisation of casein micelles can promote aggregation and coagulation in the intestinal tract, which can be problematic in some consumers. Casein comprising compositions are in many cases desirably provided with one or more whey proteins or whey protein ingredients also present.

Whey proteins can be isolated from milk serum or whey. Whey typically comprises a mixture of beta-lactoglobulin, alpha-lactalbumin, serum albumin and immunoglobulins, of which beta-lactoglobulin is the most dominant. Whey protein is conveniently provided as whey protein concentrates (WPC) and whey protein isolates (WPI), which thus comprise a mixture of these proteins. Whey protein isolates contain higher protein, less fat and lactose than WPC.

Beverages comprising whey proteins are well known. For example, acidic heat-treated beverages comprising whey proteins, including specialised foods, such as meal replacers, supplements, and enteral formulations, are well known.

However, challenges in formulating protein-comprising nutritional compositions, and particularly those comprising high value protein such as whey protein, remain, despite significant effort. For example, high temperature processing, such as that required for pasteurisation, extended shelf life treatment, or ultra high temperature (UHT) treatment, remains challenging, particularly when the native structure of the protein and/or its bioactivity is desirably maintained when formulated in the nutritional composition, and/or when particular physicochemical properties, such as low viscosity, good shelf life, good colour stability, good organoleptic characteristics, and/or product stability, are desired. One method to produce a liquid nutritional formulation (such as one comprising whey proteins) that seeks to employ heat treatment of a protein stream requires substantial pH adjustment through aseptic addition of a pH modifying agent, typically neutralisation of a low pH protein containing stream via aseptic addition of base, prior to further formulation. As such, the manufacturing and product safety and stability advantages obtainable via UHT treatment are potentially compromised when addition of non-UHT treated components occurs during the manufacture of the formulation.

Heat treating complex nutritional compositions leads to interactions between different components present in the composition, where such interactions frequently diminish the benefit provided by one or more of the components present, or indeed lead to the generation of undesirable by-products. One established approach is to minimise heat loading, whereby the temperature to which and the duration for which the composition is heated is reduced as close as possible to the minimum required to provide the required microbial safety. Safety concerns and product monitoring requirements are potentially heightened following such an approach. Another established approach to attempting to resolve such losses has been to include a sufficient excess of the ingredients to ensure that sufficient levels of desired or essential nutrients remain in the final product. Clearly, there are manufacturing inefficiencies and ingredient cost implications to such an approach, notwithstanding the potential negative impact on the consumer of ingesting undesirable by-products produced during processing. For example, thermal processing has been associated with the generation of advanced glycation end products (AGEs), for example through Maillard reactions (Nursten, 2005). Thus, although necessary, the thermal processing of nutritional components can generate compounds or intermediates that may have undesirable nutritional consequences, in addition to manifesting other challenges such as those outlined above.

It is therefore an object of the invention to overcome one or more of these difficulties and to provide a method for producing protein-comprising nutritional compositions having desirable physicochemical and/or organoleptic characteristics, such as colour, pH and/or heat stability, and such compositions, and/or to provide a useful alternative to existing methods and/or compositions, or to at least provide the public with a useful choice.

### SUMMARY OF THE INVENTION

In a first aspect, the invention relates to a method of producing a liquid nutritional composition, the method comprising, consisting essentially of, or consisting of
a. providing a first stream comprising carbohydrate, wherein the first stream is or has been heat-treated; and
b. providing a second stream comprising protein, wherein the second stream is or has been heat-treated; and
c. aseptically admixing the heat-treated first stream and the heat-treated second stream, wherein at admixture
   i. the first stream has a pH of less than about 6; and
   ii. the second stream has a pH of more than about 6;
to provide a heat-treated liquid nutritional composition.

In a second aspect, the invention relates to a method of producing a liquid nutritional composition, the method comprising, consisting essentially of, or consisting of
a. heat-treating a first stream comprising carbohydrate and having a pH of less than about 6; and
b. heat-treating a second stream comprising protein and having a pH of more than about 6; and
c. aseptically admixing the heat-treated first stream and the heat-treated second stream, wherein at admixture
   i. the first stream has a pH less than about 6; and
   ii. the second stream has a pH of more than about 6;
to provide a heat-treated liquid nutritional composition.

In another aspect, the invention relates to a method of producing a liquid nutritional composition, the method comprising, consisting essentially of, or consisting of
a. providing a first stream comprising carbohydrate and/or protein, wherein the first stream is or has been heat-treated; and
b. providing a second stream comprising protein and/or carbohydrate, wherein the second stream is or has been heat-treated; and
c. aseptically admixing the heat-treated first stream and the heat-treated second stream, wherein at admixture
   i. the first stream has a pH of less than about 6; and
   ii. the second stream has a pH of more than about 6;
to provide a heat-treated liquid nutritional composition.

In still another aspect, the invention relates to a method of producing a liquid nutritional composition, the method comprising, consisting essentially of, or consisting of
a. heat-treating a first stream comprising carbohydrate and/or protein and having a pH of less than about 6; and
b. heat-treating a second stream comprising protein and/or carbohydrate and having a pH of more than about 6; and
c. aseptically admixing the heat-treated first stream and the heat-treated second stream, wherein at admixture
   i. the first stream has a pH less than about 6; and
   ii. the second stream has a pH of more than about 6;
to provide a heat-treated liquid nutritional composition.

Any of the embodiments or preferences described herein may relate to any of the aspects herein alone or in combination with any one or more embodiments or preferences described herein, unless stated or indicated otherwise.

In various embodiments, the method comprises aseptically admixing one or more additional heat treated or sterilised streams to the first stream, to the second stream, to the admixture of step c, or to any combination of two or more of the first steam, the second stream, and the admixture of step c.

Accordingly, in one embodiment the method comprises, consists essentially of, or consists of
a. providing a first stream comprising carbohydrate, wherein the first stream is or has been heat-treated; and
b. providing a second stream comprising protein, wherein the second stream is or has been heat-treated; and
c. optionally admixing the heat-treated first stream and one or more additional heat-treated or sterilised streams;
d. optionally admixing the heat-treated second stream and one or more additional heat-treated or sterilised streams;
e. aseptically admixing the heat-treated first stream, the heat-treated second stream, and optionally one or more additional heat-treated or sterilised streams, wherein at admixture
   i. the first stream has a pH of less than about 6; and
   ii. the second stream has a pH of more than about 6;
to provide a heat-treated liquid nutritional composition.

Accordingly, in one embodiment the method comprises, consists essentially of, or consists of
a. heat-treating a first stream comprising carbohydrate and having a pH of less than about 6, and optionally admixing one or more additional heat-treated or sterilised streams; and
b. heat-treating a second stream comprising protein and having a pH of more than about 6, and optionally admixing one or more additional heat-treated or sterilised streams; and
c. aseptically admixing the heat-treated first stream and the heat-treated second stream, and optionally one or more additional heat-treated or sterilised streams, wherein at admixture
   i. the first stream has a pH less than about 6; and
   ii. the second stream has a pH of more than about 6;
to provide a heat-treated liquid nutritional composition.

In various embodiments, at least one of the one or more additional streams comprises protein, for example, up to about 35% w/w protein. For example, at least one of the one or more additional streams comprises whey protein. In one particularly contemplated example, at least one of the one or more additional streams comprises lactoferrin.

In various embodiments, for example when the second stream comprises whey protein, at least one of the one or more additional streams also comprises a whey protein. For example when the second stream comprises whey protein, at least one of the one or more additional streams comprises lactoferrin.

In various embodiments, at least one of the one or more additional streams comprises carbohydrate, for example, up to about 35% w/w carbohydrate. For example, at least one of the one or more additional streams comprises one or more reducing sugars. In one particularly contemplated example, at least one of the one or more additional streams comprises glucose or fructose.

In another embodiment, for example when the first or second stream comprises one or more whey proteins, such as lactoferrin, at least one of the one or more additional streams comprises carbohydrate. For example, at least one of the one or more additional streams comprises one or more reducing sugars. In one particularly contemplated example, at least one of the one or more additional streams comprises glucose or fructose. For example, in one embodiment whe the first stream comprises lactoferrin and the second stream comprises protein and carbohydrate, at least one of the one or more additional streams comprises a reducing sugar, such as glucose or fructose.

In various embodiments, at least one of the one or more additional streams comprises lipid, for example, up to about 50% w/w lipid. For example, at least one of the one or more additional streams comprises a dairy lipid, such as cream, milk fat, anhydrous milk fat (AMF), or an AMF fraction. In one particularly contemplated example, at least one of the one or more additional streams comprises dairy cream.

In one embodiment, at least one of the one or more additional streams comprises one or more vitamins or minerals. In one embodiment, at least one of the one or more additional streams comprises lipid, protein, and one or more vitamins or minerals. In another embodiment, at least one of the one or more additional streams comprises lipid, carbohydrate, and one or more vitamins or minerals.

In various embodiments, at admixture the first stream has a pH of about 6 or less. In various examples, at admixture the first stream has a pH of about 6.0, 5.9, 5.8, 5.7, 5.6, 5.5, 5.4, 5.3, 5.2, 5.1, 5.0, 4.9, 4.8, 4.7, 4.6, 4.5, 4.4, 4.3, 4.2, 4.1, 4.0, 3.9, 3.8, 3.7, 3.6, 3.5, 3.4, 3.3, 3.2, 3.1, 3.0, 2.9, 2.8, 2.7, 2.6, 2.5, or less than about 2.5, and useful ranges may be selected between any of these values (for example, from about 2.5 to about 6, from about 2.5 to about 5.9, from about 2.5 to about 5.5, from about 2.5 to about 5.25, from about 2 to about 5, from about 2.5 to about 4.5, from about 3 to about 6, from about 3 to about 5.9, or from about 3.5 to about 5.5, and the like). For example, at admixture the first stream has a pH in the range of from about 2.5 to about 6, for example, a pH in the range of from about 2.5 to about 5.75, for example a pH in the range of from about 2.75 to about 5.75, or from about 3 to about 5.75, such as from about 3 to about 5.5, from about 3 to about 5.25, or from about 3 to about 5.

In various embodiments, when heat treated the first stream has a pH of about 6 or less. In various examples, at admixture the first stream has a pH of about 6.0, 5.9, 5.8, 5.7, 5.6, 5.5, 5.4, 5.3, 5.2, 5.1, 5.0, 4.9, 4.8, 4.7, 4.6, 4.5, 4.4, 4.3, 4.2, 4.1, 4.0, 3.9, 3.8, 3.7, 3.6, 3.5, 3.4, 3.3, 3.2, 3.1, 3.0, 2.9, 2.8, 2.7, 2.6, 2.5, or less than about 2.5, and useful ranges may be selected between any of these values (for example, from about 2.5 to about 6, from about 2.5 to about 5.9, from about 2.5 to about 5.5, from about 2.5 to about 5.25, from about 2 to about 5, from about 2.5 to about 4.5, from about 3 to about 6, from about 3 to about 5.9, or from about 3.5 to about 5.5, and the like). For example, when heat treated the first stream has a pH in the range of from about 2.5 to about 6, for example, a pH in the range of from about 2.5 to about 5.75, for example a pH in the range of from about 2.75 to about 5.75, or from about 3 to about 5.75, such as from about 3 to about 5.5, from about 3 to about 5.25, or from about 3 to about 5.

In still further specifically contemplated embodiments, both when heat treated and at admixture, the first stream has a pH of about 6 or less. In various examples, at admixture the first stream has a pH of about 6.0, 5.9, 5.8, 5.7, 5.6, 5.5, 5.4, 5.3, 5.2, 5.1, 5.0, 4.9, 4.8, 4.7, 4.6, 4.5, 4.4, 4.3, 4.2, 4.1, 4.0, 3.9, 3.8, 3.7, 3.6, 3.5, 3.4, 3.3, 3.2, 3.1, 3.0, 2.9, 2.8, 2.7, 2.6, 2.5, or less than about 2.5, and useful ranges may be selected between any of these values (for example, from about 2.5 to about 6, from about 2.5 to about 5.9, from about 2.5 to about 5.5, from about 2.5 to about 5.25, from about 2 to about 5, from about 2.5 to about 4.5, from about 3 to about 6, from about 3 to about 5.9, or from about 3.5 to about 5.5, and the like). For example, both when heat treated and at admixture the first stream has a pH in the range of from about 2.5 to about 6, for example, a pH in the range of from about 2.5 to about 5.75, for example a pH in the range of from about 2.75 to about 5.75, or from about 3 to about 5.75, such as from about 3 to about 5.5, from about 3 to about 5.25, or from about 3 to about 5.

Accordingly, in various embodiments, at admixture or when heat treated or both, the first stream has a pH in the range of from about 2.5 to about 6, for example a pH in the range of from about 2.5 to about 5.5.

In various embodiments, the pH of the first stream is not adjusted after heat treatment. For example, the pH of the first stream is not adjusted after heat treatment and prior to admixture. In one example, the pH of the first stream is not adjusted after heat treatment and prior to admixture by addition of a pH modifier, such as an acid or a base. In one example, the pH of the first stream is not raised after heat treatment and prior to admixture by addition of a base.

In various embodiments, the pH of the second stream is not adjusted after heat treatment. For example, the pH of the second stream is not adjusted after heat treatment and prior to admixture. In one example, the pH of the second stream is not adjusted after heat treatment and prior to admixture by addition of a pH modifier, such as an acid or a base. In one example, the pH of the second stream is not lowered after heat treatment and prior to admixture by addition of an acid.

In various embodiments, the pH of the first stream and the pH of the second stream are not adjusted after heat treatment. For example, the pH of the first stream and the pH of the second stream are not adjusted after heat treatment and prior to admixture. In one example, the pH of the first stream and the pH of the second stream are not adjusted after heat treatment and prior to admixture by addition of a pH modifier, such as an acid or a base. In one example, the pH of the first stream is not raised after heat treatment and prior to admixture by addition of a base, and the pH of the second stream is not lowered after heat treatment and prior to admixture by addition of an acid.

In various embodiments, at admixture the second stream has a pH of more than 6. In various examples, at admixture the second stream has a pH of about 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, or more than about 9.0, and useful ranges may be selected between any of these values (for example, from about 6.0 to about 8.9, from about 6.0 to about 8.5, from about 6.0 to about 8, from about 6.0 to about 7.5, from about 6.5 to about 8.5, from about 6.5 to about 8.25, from about 6.5 to about 8.0, from about 7 to about 9, from about 7 to about 8.5, from about 7 to about 8.0, or from about 7 to about 7.5, and the like. For example, at admixture the second stream has a pH in the range of from about 6.75 to about 8.75, for example, a pH in the range of from about 6.75 to about 8.5, for example a pH in the range of from about 6.75 to about 7.75-8, or from about 6.75 to about 7.5-7.75, such as from about 7 to about 8.75, from about 7 to about 8.25, or from about 7 to about 7.75.

In various embodiments, when heat treated the second stream has a pH of more than 6. In various examples, at admixture the second stream has a pH of about 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, or more than about 9.0, and useful ranges may be selected between any of these values (for example, from about 6.0 to about 8.9, from about 6.0 to about 8.5, from about 6.0 to about 8, from about 6.0 to about 7.5, from about 6.5 to about 8.5, from about 6.5 to about 8.25, from about 6.5 to about 8.0, from about 7 to about 9, from about 7 to about 8.5, from about 7 to about 8.0, or from about 7 to about 7.5, and the like. For example, when heat treated the second stream has a pH in the range of from about 6.75 to about 8.75, for example, a pH in the range of from about 6.75 to about 8.5, for example a pH in the range of from about 6.75 to about 7.75-8, or from about 6.75 to about 7.5-7.75, such as from about 7 to about 8.75, from about 7 to about 8.25, or from about 7 to about 7.75.

In still further specifically contemplated embodiments, both when heat treated and at admixture, the second stream has a pH of more than 6. In various examples, at admixture the second stream has a pH of about 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, or more than about 9.0, and useful ranges may be selected between any of these values (for example, from about 6.0 to about 8.9, from about 6.0 to about 8.5, from about 6.0 to about 8, from about 6.0 to about 7.5, from about 6.5 to about 8.5, from about 6.5 to about 8.25, from about 6.5 to about 8.0, from about 7 to about 9, from about 7 to about 8.5, from about 7 to about 8.0, or from about 7 to about 7.5, and the like. For example, both when heat treated and at admixture the second stream has a pH in the range of from about 6.75 to about 8.75, for example, a pH in the range of from about 6.75 to about 8.5, for example a pH in the range of from about 6.75 to about 7.75-8, or from about 6.75 to about 7.5-7.75, such as from about 7 to about 8.75, from about 7 to about 8.25, or from about 7 to about 7.75.

Accordingly, in various embodiments, at admixture or when heat treated or both, the second stream has a pH in the range of from about 6 to about 9, for example of from about 6.5 to about 8.5.

For example, at admixture the first stream has a pH in the range of from about 3 to about 5.5, and/or at admixture the second stream has a pH in the range of about 6.8 to 8.

In one embodiment, the carbohydrate comprises, consists essentially of, or consists of one or more reducing sugars.

In one embodiment, the carbohydrate comprises, consists essentially of, or consists of lactose.

In one embodiment, the first stream comprises from about 1% w/w to about 60% w/w carbohydrate. In certain examples, the first stream comprises from about 1% w/w to about 35% w/w carbohydrate, from about 1% w/w to about 30% w/w carbohydrate, from about 1% w/w to about 25% w/w carbohydrate, or from about 1% w/w to about 20% w/w carbohydrate.

In one embodiment, the first stream comprises at least 3% w/w carbohydrate.

In one embodiment, the second stream comprises less than about 5% w/w carbohydrate.

In one embodiment, the second stream comprises less than about 2% w/w reducing sugar. For example, the second stream comprises less than about 1.5% w/w reducing sugar, less than about 1% w/w reducing sugar, less than about 0.5% w/w reducing sugar, or less than about 0.25% w/w reducing sugar.

In one embodiment, the weight ratio of protein to carbohydrate in the second stream is greater than about 1:5, for example, is greater than about 1:4, than about 1:3, about 1:2, or greater than about 1:1.

In one embodiment, the second stream is substantially free of carbohydrate.

In one embodiment, the weight ratio of protein to lactose in the second stream is greater than about 1:5, for example, is greater than about 1:4, than about 1:3, about 1:2, or greater than about 1:1.

In one embodiment, the second stream is substantially free of lactose.

In one embodiment, the protein comprises, consists essentially of, or consists of one or more milk proteins.

In one example, the one or more milk proteins are selected from the group comprising casein, whey proteins including lactoferrin, lactalbumin, osteopontin, alpha-lactalbumin, and beta-lactoglobulin.

In one embodiment, the protein present in the second stream comprises, consists essentially of, or consists of casein.

In one embodiment, the protein comprises, consists essentially of, or consists of one or more plant proteins.

In one embodiment, the protein is or is provided by one or more of the group comprising skim milk, whole milk, retentate, liquid whey, skim milk powder, whole milk powder, MPC, MPI, sodium caseinate, calcium caseinate, WPC, WPI, SPI, SPC, oat flour, oat protein, soy flour, soy protein, rice flour, rice protein, pea protein, pumpkin protein, barley protein, nut protein, almond protein, spirulina protein, quinoa protein, and hemp protein.

In one embodiment, the second stream comprises at least 0.5% w/w protein.

In one embodiment, the first stream comprises from about 0% w/w to about 15% w/w lipid. For example, the second stream comprises from about 1% w/w to about 15% w/w lipid, from about 1% w/w to about 14% w/w lipid, from about 1% w/w to about 13% w/w lipid, from about 1% w/w to about 12% w/w lipid, from about 1% w/w to about 11% w/w lipid, from about 1% w/w to about 10% w/w lipid, from about 1% w/w to about 9% w/w lipid, from about 1% w/w to about 8% w/w lipid, from about 1% w/w to about 6% w/w lipid, or from about 1% w/w to about 5% w/w lipid. In various embodiments, the first stream comprises less than about 1% w/w lipid, for example, less than about 0.5% w/w lipid, or less than about 0.2% lipid.

In one embodiment, the first stream is substantially free of lipid.

In one embodiment, the second stream comprises from about 0% w/w to about 15% w/w lipid. For example, the second stream comprises from about 1% w/w to about 15% w/w lipid, from about 1% w/w to about 14% w/w lipid, from about 1% w/w to about 13% w/w lipid, from about 1% w/w to about 12% w/w lipid, from about 1% w/w to about 11% w/w lipid, from about 1% w/w to about 10% w/w lipid, from about 1% w/w to about 9% w/w lipid, from about 1% w/w to about 8% w/w lipid, from about 1% w/w to about 6% w/w lipid, or from about 1% w/w to about 5% w/w lipid. In various embodiments, the second stream comprises less than about 1% w/w lipid, for example, less than about 0.5% w/w lipid, or less than about 0.2% lipid.

In one embodiment, the second stream is substantially free of lipid.

In one embodiment, the first stream comprises from about 0.01% w/w to about 15% w/w protein.

In various embodiments, the first stream comprises from about 0.05% w/w to about 35% w/w protein, for example from about 0.05% w/w to about 30% w/w protein, from about 0.05% w/w to about 25% w/w protein, from about 0.05% w/w to about 20% w/w protein, or from about 0.05% w/w to about 15% w/w protein. In various examples, the first stream comprises about 0.05% w/w, about 0.1, about 0.2, about 0.25, about 0.5, about 0.75, about 1, about 1.25, about 1.5, about 1.75, about 2, about 2.25, about 2.5, about 2.75, or about 3% w/w protein, and useful ranges may be selected between any of these values (for example, from about 0.05% w/w to about 3% w/w, from about 0.5 to about 1.5, from about 0.5 to about 3, from about 1 to about 2, from about 1 to about 3, from about 1.5 to about 2.5, from about 1.5 to about 3, from about 2 to about 3, or from about 2.5% w/w to about 3% w/w protein).

In other examples, the first stream comprises about 2.5% w/w, about 3, about 3.5, about 4, about 4.5, about 5, about 5.5, about 6, about 6.5, about 7, about 7.5, about 8, about 8.5, about 9, about 9.5, about 10, about 10.5, about 11, about 11.5, about 12, about 12.5, about 13, about 13.5, about 14, about 14.5, or about 15% w/w protein, and useful ranges may be selected between any of these values (for example, from about 2.5% w/w to about 15% w/w, from about 3% w/w to about 15% w/w, from about 3.5% w/w to about 15% w/w, from about 4% w/w to about 15% w/w, from about 4.5% w/w to about 15% w/w, from about 5% w/w to about 15% w/w, from about 2.5% w/w to about 14% w/w, from about 2.5% w/w to about 13% w/w, from about 2.5% w/w to about 12% w/w, from about 2.5% w/w to about 11% w/w, from about 2.5% w/w to about 10% w/w, from about 2.5% w/w to about 9% w/w, from about 2.5% w/w to about 8% w/w, from about 2.5% w/w to about 7% w/w, from about 2.5% w/w to about 6% w/w, from about 2.5% w/w to about 5% w/w, from about 3% w/w to about 10% w/w, from about 3.5% w/w to about 10% w/w, from about 4% w/w to about 10% w/w, from about 4.5% w/w to about 10% w/w, from about 5% w/w to about 10% w/w protein, and the like).

In various embodiments, the streams in combination comprise sufficient protein to provide a liquid nutritional composition comprising from about 0.05% w/w to about 35% w/w protein, from about 0.05% w/w to about 30% w/w protein, from about 0.05% w/w to about 25% w/w protein, for example from about 0.05% w/w to about 20% w/w protein, or from about 0.05% w/w to about 15% w/w protein. In various examples, the streams in combination comprise sufficient protein to provide a liquid nutritional composition comprising about 0.05% w/w, about 0.1, about 0.2, about 0.25, about 0.5, about 0.75, about 1, about 1.25, about 1.5, about 1.75, about 2, about 2.25, about 2.5, about 2.75, or about 3% w/w protein, and useful ranges may be selected between any of these values (for example, from about 0.05% w/w to about 3% w/w, from about 0.5 to about 1.5, from about 0.5 to about 3, from about 1 to about 2, from about 1 to about 3, from about 1.5 to about 2.5, from about 1.5 to about 3, from about 2 to about 3, or from about 2.5% w/w to about 3% w/w protein).

In other examples, the streams in combination comprise sufficient protein to provide a liquid nutritional composition comprising about 2.5% w/w, about 3, about 3.5, about 4, about 4.5, about 5, about 5.5, about 6, about 6.5, about 7, about 7.5, about 8, about 8.5, about 9, about 9.5, about 10, about 10.5, about 11, about 11.5, about 12, about 12.5, about 13, about 13.5, about 14, about 14.5, or about 15% w/w protein, and useful ranges may be selected between any of these values (for example, from about 2.5% w/w to about 15% w/w, from about 3% w/w to about 15% w/w, from about 3.5% w/w to about 15% w/w, from about 4% w/w to about 15% w/w, from about 4.5% w/w to about 15% w/w, from about 5% w/w to about 15% w/w, from about 2.5% w/w to about 14% w/w, from about 2.5% w/w to about 13% w/w, from about 2.5% w/w to about 12% w/w, from about 2.5% w/w to about 11% w/w, from about 2.5% w/w to about 10% w/w, from about 2.5% w/w to about 9% w/w, from about 2.5% w/w to about 8% w/w, from about 2.5% w/w to about 7% w/w, from about 2.5% w/w to about 6% w/w, from about 2.5% w/w to about 5% w/w, from about 3% w/w to about 10% w/w, from about 3.5% w/w to about 10% w/w, from about 4% w/w to about 10% w/w, from about 4.5% w/w to about 10% w/w, from about 5% w/w to about 10% w/w protein, and the like).

In one embodiment, the first stream comprises one or more whey proteins. For example, the first stream comprises lactoferrin. In another example, the first stream comprises one or more proteins selected from the group comprising lactoferrin, lactalbumin, osteopontin, alpha-lactalbumin, and beta-lactoglobulin.

In various embodiments, the first stream comprises from about 0.5 wt % to about 20 wt % whey protein. In certain examples, the first stream comprises from about 1% w/w, about 1.5, about 2, about 2.5, about 3, about 3.5, about 4, about 4.5, about 5, about 5.5, about 6, about 6.5, about 7, about 7.5, about 8, about 8.5, about 9, about 9.5, about 10, about 10.5, about 11, about 11.5, about 12, about 12.5, about 13, about 13.5, about 14, about 14.5, about 15, about 15.5, about 16, about 16.5, about 17, about 17.5, about 18, about 18.5, about 19, about 19.5, or about 20% w/w whey protein, and useful ranges may be selected between any of these values (for example, from about 2% w/w to about 18% w/w, from about 3% w/w to about 18% w/w, from about 3.5% w/w to about 16% w/w, from about 4% w/w to about 16% w/w, from about 4.5% w/w to about 16% w/w, from about 5% w/w to about 16% w/w, from about 6% w/w to about 16% w/w, from about 7% w/w to about 16% w/w, from about 8% w/w to about 16% w/w, from about 9% w/w to about 16% w/w, from about 10% w/w to about 16% w/w, from about 2% w/w to about 15% w/w, from about 2% w/w to about 14% w/w, from about 2% w/w to about 13% w/w, from about 2% w/w to about 12% w/w, from about 2% w/w to about 11% w/w, from about 2% w/w to about 10% w/w, from about 2% w/w to about 9% w/w, from about 2% w/w to about 8% w/w, from about 2% w/w to about 7% w/w, from about 2% w/w to about 6% w/w, from about 2% w/w to about 5% w/w, from about 3% w/w to about 15% w/w, from about 4% w/w to about 15% w/w, from about 4% w/w to about 13% w/w, from about 5% w/w to about 12% w/w, from about 5% w/w to about 10% w/w whey protein, and the like).

In one embodiment, the first stream is substantially free of protein.

In one embodiment, when heat treated the pH of the second stream is at or above 6.7.

In one embodiment, when heat treated the pH of the first stream is at or below about 6.

In one embodiment, following heat treatment the protein present in the second stream is substantially undenatured.

In one embodiment, following heat treatment:
a. when lactoferrin is present, for example is present in the first stream
   i. functional lactoferrin and/or biological activity associated with or dependent upon functional lactoferrin is detectable in the composition; and/or
   ii. the majority of lactoferrin molecules present are globular; and/or
   iii. at least about 50% of the lactoferrin molecules present have a native conformation; and/or
   iv. the total iron binding capacity of the lactoferrin is at least 50% that of the lactoferrin prior to heat treatment; and/or
b. when lactalbumin is present, for example is present in the first stream
   i. functional lactalbumin and/or biological activity associated with or dependent upon functional lactalbumin is detectable in the composition; and/or
   ii. the majority of lactalbumin molecules present are globular; and/or
   iii. the lactalbumin is substantially undenatured; and/or
   iv. at least about 50% of the lactalbumin molecules present have a native conformation; and/or
c. when alpha-lactalbumin is present, for example is present in the first stream
   i. functional alpha-lactalbumin and/or biological activity associated with or dependent upon functional alpha-lactalbumin is detectable in the composition; and/or
   ii. the majority of alpha-lactalbumin molecules present are globular; and/or
   iii. the alpha-lactalbumin is substantially undenatured; and/or
   iv. at least about 50% of the alpha-lactalbumin molecules present have a native conformation; and/or
d. when beta-lactoglobulin is present, for example is present in the first stream
   i. functional beta-lactoglobulin and/or biological activity associated with or dependent upon functional beta-lactoglobulin is detectable in the composition; and/or
   ii. the majority of beta-lactoglobulin molecules present are globular; and/or
   iii. the beta-lactoglobulin is substantially undenatured; and/or
   iv. at least about 50% of the beta-lactoglobulin molecules present have a native conformation; and/or
e. any combination of two or more of a) to e) above.

In one embodiment, following heat treatment when osteopontin is present in the first stream
i. the majority of osteopontin molecules present are globular; and/or
ii. the osteopontin is substantially undenatured; and/or
iii. at least about 50% of the osteopontin molecules present have a native conformation.

In one embodiment, the first stream comprises lactoferrin and has a pH of from 3 to 5 at heat treatment, and wherein following heat treatment, for example at admixture and/or following admixture
a. functional lactoferrin and/or biological activity associated with or dependent upon functional lactoferrin is detectable; and/or
b. at least about 50% of the lactoferrin molecules present have a native conformation; and/or
c. the total iron binding capacity of the lactoferrin is at least 50% that of the lactoferrin prior to heat treatment.

In one embodiment, for example an embodiment of the production of an RTF composition as herein contemplated, the first stream comprises lactoferrin and has a pH of from 5 to 6 at heat treatment, and wherein following heat treatment, for example at admixture and/or following admixture
a. functional lactoferrin and/or biological activity associated with or dependent upon functional lactoferrin is detectable; and/or
b. at least about 40% of the lactoferrin molecules present have a native conformation; and/or
c. the total iron binding capacity of the lactoferrin is at least 40% that of the lactoferrin prior to heat treatment.

In one embodiment, for example an embodiment of the production of an RTF composition as herein contemplated, the first stream comprises lactoferrin and has a pH of from 3 to 5 at heat treatment, and the second stream has a carbohydrate concentration of from about 0% w/w to about 5% w/w, wherein following heat treatment of the first stream, for example at admixture and/or following admixture
a. functional lactoferrin and/or biological activity associated with or dependent upon functional lactoferrin is detectable; and/or
b. at least about 50% of the lactoferrin molecules present have a native conformation; and/or
c. the total iron binding capacity of the lactoferrin is at least 50% that of the lactoferrin prior to heat treatment.

In one embodiment, for example an embodiment of the production of an RTF composition as herein contemplated, the first stream comprises lactoferrin and has a pH of from 5 to 6 at heat treatment, and the second stream has a carbohydrate concentration of from about 0% w/w to about 5% w/w, and wherein following heat treatment, for example at admixture and/or following admixture
a. functional lactoferrin and/or biological activity associated with or dependent upon functional lactoferrin is detectable; and/or
b. at least about 40% of the lactoferrin molecules present have a native conformation; and/or
c. the total iron binding capacity of the lactoferrin is at least 40% that of the lactoferrin prior to heat treatment.

In a particularly contemplated example, the first stream comprises lactoferrin and has a pH of from 3 to 5 at heat treatment, and the second stream has a carbohydrate concentration of from about 0% w/w to about 5% w/w, wherein at admixture at least about 50% of the lactoferrin molecules present have a native conformation, at least about 60%, at least about 70%, at least about 80%, at least about 90%, at least about 95%, or more than 95% of the lactoferrin molecules present have a native conformation.

In a particularly contemplated example, the first stream comprises lactoferrin and has a pH of from 3 to 5 at heat treatment, and the second stream has a carbohydrate concentration of from about 0% w/w to about 5% w/w, wherein at admixture the total iron binding capacity of the lactoferrin is at least 50% that of the lactoferrin prior to heat treatment, is at least about 60%, at least about 70%, at least about 80%, at least about 90%, at least about 95%, or the total iron binding capacity of the lactoferrin is more than 95% that of the lactoferrin prior to heat treatment.

In a particularly contemplated example, the first stream comprises lactoferrin and has a pH of from 5 to 6 at heat treatment, and the second stream has a carbohydrate concentration of from about 0% w/w to about 5% w/w, wherein at admixture at least about 40% of the lactoferrin molecules present have a native conformation, at least about 45%, at least about 50%, at least about 55%, at least about 60%, at least about 65%, at least about 70%, or more than about 70% of the lactoferrin molecules present have a native conformation.

In a particularly contemplated example, the first stream comprises lactoferrin and has a pH of from 5 to 6 at heat treatment, and the second stream has a carbohydrate concentration of from about 0% w/w to about 5% w/w, wherein at admixture the total iron binding capacity of the lactoferrin is at least 40% that of the lactoferrin prior to heat treatment, is at least about 45%, at least about 50%, at least about 55%, or the total iron binding capacity of the lactoferrin is more than 55% that of the lactoferrin prior to heat treatment.

In one embodiment, for example an embodiment of the production of an RTF composition such as a Stage 4 RTF composition or a sports beverage or supplement as herein contemplated, the first stream comprises lactoferrin and has a pH of from 3 to 5 at heat treatment, and the second stream has a carbohydrate concentration of from about 2% w/w to about 5% w/w, wherein following heat treatment of the first stream, for example at admixture and/or following admixture
a. functional lactoferrin and/or biological activity associated with or dependent upon functional lactoferrin is detectable; and/or
b. at least about 50% of the lactoferrin molecules present have a native conformation; and/or
c. the total iron binding capacity of the lactoferrin is at least 50% that of the lactoferrin prior to heat treatment.

In a particularly contemplated example, such as an example of the production of a Stage 4 RTF composition or a sports beverage or supplement as herein contemplated, the first stream comprises lactoferrin and has a pH of from 3 to 5 at heat treatment, and the second stream has a carbohydrate concentration of from about 2% w/w to about 5% w/w, wherein at admixture at least about 50% of the lactoferrin molecules present have a native conformation, at least about 60%, at least about 70%, at least about 80%, at least about 90%, at least about 95%, or more than 95% of the lactoferrin molecules present have a native conformation. In one example, the first stream comprises lactoferrin and has a pH of from 3 to 5 at heat treatment, and the second stream has a carbohydrate concentration of from about 4% w/w to about 4.5% w/w, wherein at admixture more than 85% or more than 90% of the lactoferrin molecules present have a native conformation.

In a particularly contemplated example, such as an example of the production of a Stage 4 RTF composition or a sports beverage or supplement as herein contemplated, the first stream comprises lactoferrin and has a pH of from 3 to 5 at heat treatment, and the second stream has a carbohydrate concentration of from about 2% w/w to about 5% w/w, wherein at admixture the total iron binding capacity of the lactoferrin is at least 50% that of the lactoferrin prior to heat treatment, is at least about 60%, at least about 70%, at least about 80%, at least about 90%, at least about 95%, or the total iron binding capacity of the lactoferrin is more than 95% that of the lactoferrin prior to heat treatment. In one example, the first stream comprises lactoferrin and has a pH of from 3 to 5 at heat treatment, and the second stream has a carbohydrate concentration of from about 4% w/w to about 4.5% w/w, wherein at admixture the total iron binding capacity of the lactoferrin is at least 50% that of the lactoferrin prior to heat treatment.

In one embodiment, for example an embodiment of the production of a medical food as herein contemplated, the first stream comprises lactoferrin and has a pH of from 3 to 5 at heat treatment, and one or more other streams, such as a second stream and/or a third stream, has a carbohydrate concentration of from 0% w/w to about 5% w/w, wherein following heat treatment of the first stream, for example at admixture and/or following admixture
a. functional lactoferrin and/or biological activity associated with or dependent upon functional lactoferrin is detectable; and/or
b. at least about 50% of the lactoferrin molecules present have a native conformation; and/or
c. the total iron binding capacity of the lactoferrin is at least 50% that of the lactoferrin prior to heat treatment.

In a particularly contemplated example, such as an example of the production of a medical food as herein contemplated, the first stream comprises lactoferrin and has a pH of from 3 to 5 at heat treatment, and one or more other streams, such as a second stream and/or a third stream, has a carbohydrate concentration of from 0% w/w to about 5% w/w, wherein at admixture at least about 50% of the lactoferrin molecules present have a native conformation, at least about 55%, at least about 60%, at least about 65%, at least about 70%, at least about 75%, at least about 80%, at least about 85%, or more than 85% of the lactoferrin molecules present have a native conformation. In one example, the first stream comprises lactoferrin and has a pH of from 3 to 5 at heat treatment, the second stream and optionally a third stream has a carbohydrate concentration of from about 0% w/w to about 4% w/w, wherein at admixture more than 60% of the lactoferrin molecules present have a native conformation.

In a particularly contemplated example, such as an example of the production of a medical food as herein contemplated, the first stream comprises lactoferrin and has a pH of from 3 to 5 at heat treatment, and one or more other streams, such as a second stream and/or a third stream, has a carbohydrate concentration of from 0% w/w to about 5% w/w, wherein at admixture the total iron binding capacity of the lactoferrin is at least 50% that of the lactoferrin prior to heat treatment, is at least about 60%, at least about 70%, at least about 80%, at least about 90%, at least about 95%, or the total iron binding capacity of the lactoferrin is more than 95% that of the lactoferrin prior to heat treatment. In one example, the first stream comprises lactoferrin and has a pH of from 3 to 5 at heat treatment, the second stream and optionally a third stream has a carbohydrate concentration of from about 0% w/w to about 4% w/w, wherein at admixture the total iron binding capacity of the lactoferrin is at least 50% that of the lactoferrin prior to heat treatment.

In one embodiment, the first stream comprises alpha-lactalbumin and has a pH of from 3 to 5 at heat treatment, and wherein following heat treatment, for example at admixture and/or following admixture
a. functional alpha-lactalbumin and/or biological activity associated with or dependent upon functional alpha-lactalbumin is detectable; and/or
b. at least about 50% of the alpha-lactalbumin molecules present have a native conformation.

In one embodiment, for example an embodiment of the production of an RTF composition as herein contemplated, the first stream comprises alpha-lactalbumin and has a pH of from 3 to 5 at heat treatment, and the second stream has a carbohydrate concentration of from about 0% w/w to about 5% w/w, wherein following heat treatment of the first stream, for example at admixture and/or following admixture
a. functional alpha-lactalbumin and/or biological activity associated with or dependent upon functional alpha-lactalbumin is detectable; and/or
b. at least about 50% of the alpha-lactalbumin molecules present have a native conformation.

In a particularly contemplated example, the first stream comprises alpha-lactalbumin and has a pH of from 3 to 5 at heat treatment, and the second stream has a carbohydrate concentration of from about 0% w/w to about 5% w/w, wherein at admixture at least about 50% of the alpha-lactalbumin molecules present have a native conformation, at least about 55%, at least about 60%, at least about 65%, at least about 70%, at least about 75%, or more than 75% of the alpha-lactalbumin molecules present have a native conformation.

In one embodiment, for example an embodiment of the production of an RTF composition such as a Stage 4 RTF composition or a sports beverage or supplement as herein contemplated, the first stream comprises alpha-lactalbumin and has a pH of from 3 to 5 at heat treatment, and the second stream has a carbohydrate concentration of from about 2% w/w to about 5% w/w, wherein following heat treatment of the first stream, for example at admixture and/or following admixture
a. functional alpha-lactalbumin and/or biological activity associated with or dependent upon functional alpha-lactalbumin is detectable; and/or
b. at least about 30% of the alpha-lactalbumin molecules present have a native conformation.

In a particularly contemplated example, such as an example of the production of a Stage 4 RTF composition or a sports beverage or supplement as herein contemplated, the first stream comprises alpha-lactalbumin and has a pH of from 3 to 5 at heat treatment, and the second stream has a carbohydrate concentration of from about 2% w/w to about 5% w/w, wherein at admixture at least about 30% of the alpha-lactalbumin molecules present have a native conformation, at least about 35%, at least about 40%, at least about 45%, at least about 50%, at least about 55%, or more than 55% of the alpha-lactalbumin molecules present have a native conformation. In one example, the first stream comprises alpha-lactalbumin and has a pH of from 3 to 5 at heat treatment, and the second stream has a carbohydrate concentration of from about 4% w/w to about 4.5% w/w, wherein at admixture at least about 30%, or more than 30%, of the alpha-lactalbumin molecules present have a native conformation.

In one embodiment, for example an embodiment of the production of a medical food as herein contemplated, the first stream comprises alpha-lactalbumin and has a pH of from 3 to 5 at heat treatment, and one or more other streams, such as a second stream and/or a third stream, has a carbohydrate concentration of from 0% w/w to about 5% w/w, wherein following heat treatment of the first stream, for example at admixture and/or following admixture
a. functional alpha-lactalbumin and/or biological activity associated with or dependent upon functional alpha-lactalbumin is detectable; and/or
b. at least about 30% of the alpha-lactalbumin molecules present have a native conformation.

In a particularly contemplated example, such as an example of the production of a medical food as herein contemplated, the first stream comprises alpha-lactalbumin and has a pH of from 3 to 5 at heat treatment, and one or more other streams, such as a second stream and/or a third stream, has a carbohydrate concentration of from 0% w/w to about 5% w/w, wherein at admixture at least about 30% of the alpha-lactalbumin molecules present have a native conformation, at least about 35%, at least about 40%, at least about 45%, at least about 50%, at least about 55%, or more than 55% of the alpha-lactalbumin molecules present have a native conformation. In one example, the first stream comprises alpha-lactalbumin and has a pH of from 3 to 5 at heat treatment, the second stream and optionally a third stream has a carbohydrate concentration of from about 0% w/w to about 4% w/w, wherein at admixture at least about 30%, or more than 30%, of the alpha-lactalbumin molecules present have a native conformation.

In one embodiment, the first stream comprises beta-lactoglobulin and has a pH of from 3 to 5 at heat treatment, and wherein following heat treatment, for example at admixture and/or following admixture
a. functional beta-lactoglobulin and/or biological activity associated with or dependent upon functional beta-lactoglobulin is detectable; and/or
b. at least about 50% of the beta-lactoglobulin molecules present have a native conformation.

In one embodiment, for example an embodiment of the production of an RTF composition as herein contemplated, the first stream comprises beta-lactoglobulin and has a pH of from 3 to 5 at heat treatment, and the second stream has a carbohydrate concentration of from about 0% w/w to about 5% w/w, wherein following heat treatment of the first stream, for example at admixture and/or following admixture
a. functional beta-lactoglobulin and/or biological activity associated with or dependent upon functional beta-lactoglobulin is detectable; and/or
b. at least about 50% of the beta-lactoglobulin molecules present have a native conformation.

In a particularly contemplated example, the first stream comprises beta-lactoglobulin and has a pH of from 3 to 5 at heat treatment, and the second stream has a carbohydrate concentration of from about 0% w/w to about 5% w/w, wherein at admixture at least about 50% of the beta-lactoglobulin molecules present have a native conformation, at least about 55%, at least about 60%, at least about 65%, at least about 70%, at least about 75%, or more than 75% of the beta-lactoglobulin molecules present have a native conformation.

In one embodiment, for example an embodiment of the production of an RTF composition such as a Stage 4 RTF composition or a sports beverage or supplement as herein contemplated, the first stream comprises beta-lactoglobulin and has a pH of from 3 to 5 at heat treatment, and the second stream has a carbohydrate concentration of from about 2% w/w to about 5% w/w, wherein following heat treatment of the first stream, for example at admixture and/or following admixture
a. functional beta-lactoglobulin and/or biological activity associated with or dependent upon functional beta-lactoglobulin is detectable; and/or
b. at least about 50% of the beta-lactoglobulin molecules present have a native conformation.

In a particularly contemplated example, such as an example of the production of a Stage 4 RTF composition or a sports beverage or supplement as herein contemplated, the first stream comprises beta-lactoglobulin and has a pH of from 3 to 5 at heat treatment, and the second stream has a carbohydrate concentration of from about 2% w/w to about 5% w/w, wherein at admixture at least about 50% of the beta-lactoglobulin molecules present have a native conformation, at least about 55%, at least about 60%, at least about 65%, at least about 70%, at least about 75%, or more than 75% of the beta-lactoglobulin molecules present have a native conformation. In one example, the first stream comprises beta-lactoglobulin and has a pH of from 3 to 5 at heat treatment, and the second stream has a carbohydrate concentration of from about 4% w/w to about 4.5% w/w, wherein at admixture at least about 50%, or more than 50%, of the beta-lactoglobulin molecules present have a native conformation.

In one embodiment, for example an embodiment of the production of a medical food as herein contemplated, the first stream comprises beta-lactoglobulin and has a pH of from 3 to 5 at heat treatment, and one or more other streams, such as a second stream and/or a third stream, has a carbohydrate concentration of from 0% w/w to about 5% w/w, wherein following heat treatment of the first stream, for example at admixture and/or following admixture
a. functional beta-lactoglobulin and/or biological activity associated with or dependent upon functional beta-lactoglobulin is detectable; and/or
b. at least about 50% of the beta-lactoglobulin molecules present have a native conformation.

In a particularly contemplated example, such as an example of the production of a medical food as herein contemplated, the first stream comprises beta-lactoglobulin and has a pH of from 3 to 5 at heat treatment, and one or more other streams, such as a second stream and/or a third stream, has a carbohydrate concentration of from 0% w/w to about 40% w/w, wherein at admixture at least about 50% of the beta-lactoglobulin molecules present have a native conformation, at least about 55%, at least about 60%, at least about 65%, at least about 70%, at least about 75%, or more than 75% of the beta-lactoglobulin molecules present have a native conformation. In one example, the first stream comprises beta-lactoglobulin and has a pH of from 3 to 5 at heat treatment, the second stream and optionally a third stream has a carbohydrate concentration of from about 0% w/w to about 4% w/w, wherein at admixture at least about 50%, or more than 50%, of the beta-lactoglobulin molecules present have a native conformation.

In one embodiment, the first stream comprises one or more whey proteins and has a pH of from 2.9-3.7 at heat treatment, and wherein following heat treatment, for example at admixture and/or following admixture
a. one or more functional whey proteins and/or biological activity associated with or dependent upon one or more functional whey proteins is detectable; and/or
b. at least about 50% of the molecules of one or more of the one or more whey proteins present have a native conformation; and/or
c. at least about 50% of the molecules of each of the whey proteins present have a native conformation.

In one embodiment, for example an embodiment of the production of an RTF composition as herein contemplated, the first stream comprises one or more whey proteins and has a pH of from 3 to 5 at heat treatment, and the second stream has a carbohydrate concentration of from about 0% w/w to about 5% w/w, wherein following heat treatment of the first stream, for example at admixture and/or following admixture
a. one or more functional whey proteins and/or biological activity associated with or dependent upon one or more functional whey proteins is detectable; and/or
b. at least about 50% of the molecules of one or more of the one or more whey proteins present have a native conformation; and/or
c. at least about 50% of the molecules of each of the whey proteins present have a native conformation.

In a particularly contemplated example, the first stream comprises one or more whey proteins and has a pH of from 3 to 5 at heat treatment, and the second stream has a carbohydrate concentration of from about 0% w/w to about 5% w/w, wherein at admixture at least about 50% of the one or more whey protein molecules present have a native conformation, at least about 55%, at least about 60%, at least about 65%, at least about 70%, at least about 75%, or more than 75% of the one or more whey protein molecules present have a native conformation.

In one embodiment, for example an embodiment of the production of an RTF composition such as a Stage 4 RTF composition or a sports beverage or supplement as herein contemplated, the first stream comprises one or more whey proteins and has a pH of from 3 to 5 at heat treatment, and the second stream has a carbohydrate concentration of from about 2% w/w to about 5% w/w, wherein following heat treatment of the first stream, for example at admixture and/or following admixture
a. one or more functional whey proteins and/or biological activity associated with or dependent upon one or more functional whey proteins is detectable; and/or
b. at least about 50% of the molecules of one or more of the one or more whey proteins present have a native conformation; and/or
c. at least about 50% of the molecules of each of the whey proteins present have a native conformation.

In a particularly contemplated example, such as an example of the production of a Stage 4 RTF composition or a sports beverage or supplement as herein contemplated, the first stream comprises one or more whey proteins and has a pH of from 3 to 5 at heat treatment, and the second stream has a carbohydrate concentration of from about 2% w/w to about 5% w/w, wherein at admixture at least about 50% of the one or more whey protein molecules present have a native conformation, at least about 55%, at least about 60%, at least about 65%, at least about 70%, at least about 75%, or more than 75% of the one or more whey protein molecules present have a native conformation. In one example, the first stream comprises one or more whey proteins and has a pH of from 3 to 5 at heat treatment, and the second stream has a carbohydrate concentration of from about 4% w/w to about 4.5% w/w, wherein at admixture at least about 50%, or more than 50%, of the one or more whey protein molecules present have a native conformation.

In one embodiment, for example an embodiment of the production of a medical food as herein contemplated, the first stream comprises one or more whey proteins and has a pH of from 3 to 5 at heat treatment, and one or more other streams, such as a second stream and/or a third stream, has a carbohydrate concentration of from 0% w/w to about 5% w/w, wherein following heat treatment of the first stream, for example at admixture and/or following admixture
a. one or more functional whey proteins and/or biological activity associated with or dependent upon one or more functional whey proteins is detectable; and/or
b. at least about 50% of the molecules of one or more of the one or more whey proteins present have a native conformation; and/or
c. at least about 50% of the molecules of each of the whey proteins present have a native conformation.

In a particularly contemplated example, such as an example of the production of a medical food as herein contemplated, the first stream comprises one or more whey proteins and has a pH of from 3 to 5 at heat treatment, and one or more other streams, such as a second stream and/or a third stream, has a carbohydrate concentration of from 0% w/w to about 5% w/w, wherein at admixture at least about 50% of the one or more whey protein molecules present have a native conformation, at least about 55%, at least about 60%, at least about 65%, at least about 70%, at least about 75%, or more than 75% of the one or more whey protein molecules present have a native conformation. In one example, the first stream comprises one or more whey proteins and has a pH of from 3 to 5 at heat treatment, the second stream and optionally a third stream has a carbohydrate concentration of from about 0% w/w to about 4% w/w, wherein at admixture at least about 50%, or more than 50%, of the one or more whey protein molecules present have a native conformation.

In one embodiment, the admixture comprises furosine in an amount that is not more than about 5% greater than the total amount of furosine present in the first stream and the second stream prior to heat treatment. In one embodiment, the admixture comprises furosine in an amount that is not more than about 10% greater or not more than 15% greater than the total amount of furosine present in the first stream and the second stream prior to heat treatment.

In one embodiment, the admixture comprises:
a. furosine in an amount that is not more than 20% greater than the total amount of furosine present in the first stream and the second stream prior to heat treatment; and/or
b. less than about 5 g furosine per kg protein present; and/or
c. both a) and b) above.

In one embodiment, the admixture comprises
a. furosine in an amount that is not more than 20% greater than the total amount of furosine present in the first stream and the second stream prior to heat treatment; and/or
b. furosine in an amount or concentration that is not more than 80% of the amount or concentration of furosine present in a control composition prepared in a single stream process with the same ingredients; and/or
c. less than about 5 g furosine per kg protein present; and/or
d. lactulose in an amount that is not more than two-fold greater than the total amount of lactulose present in the first stream and the second stream prior to heat treatment; and/or
e. a lactulose:furosine ratio ((mg lactulose/kg of composition):(mg furosine/100 g protein)) below about 3; and/or
f. any combination of two or more of a) to e) above; and/or
g. each of a) to e) above.

In one embodiment, the admixture comprises
a. furosine in an amount that is not more than 20% greater than the total amount of furosine present in the first stream and the second stream prior to heat treatment; and/or
b. furosine in an amount or concentration that is not more than 80% of the amount or concentration of furosine present in a control composition prepared in a single stream process with the same ingredients; and/or
c. less than about 5 g furosine per kg protein present; and/or
d. lactulose in an amount that is not more than two-fold greater than the total amount of lactulose present in the first stream and the second stream prior to heat treatment; and/or
e. a lactulose:furosine ratio ((mg lactulose/kg of composition):(mg furosine/100 g protein)) below about 2; and/or
f. any combination of two or more of a) to e) above; and/or
g. each of a) to e) above.

In one embodiment, the admixture comprises
a. furosine in an amount that is not more than 20% greater than the total amount of furosine present in the first stream and the second stream prior to heat treatment; and/or
b. furosine in an amount or concentration that is not more than 80% of the amount or concentration of furosine present in a control composition prepared in a single stream process with the same ingredients; and/or
c. less than about 4 g furosine per kg protein present; and/or
d. lactulose in an amount that is not more than two-fold greater than the total amount of lactulose present in the first stream and the second stream prior to heat treatment; and/or
e. a lactulose:furosine ratio ((mg lactulose/kg of composition):(mg furosine/100 g protein)) below about 1; and/or
f. any combination of two or more of c) to e) above; and/or
g. each of a) to e) above.

In another embodiment, the admixture is of a first stream having at heat treatment a pH less than 5, or the admixture is of a second stream comprising less than about 5% w/w carbohydrate, or the admixture is of a first stream having at heat treatment a pH less than 5 and a second stream comprising less than about 5% w/w carbohydrate, wherein the admixture comprises
a. furosine in an amount that is not more than 20% greater than the total amount of furosine present in the first stream and the second stream prior to heat treatment; and/or
b. furosine in an amount or concentration that is not more than 80% of the amount or concentration of furosine present in a control composition prepared in a single stream process with the same ingredients; and/or;
c. less than about 5 g furosine per kg protein present; and/or
d. less than about 4 g furosine per kg protein present; and/or
e. a lactulose:furosine ratio ((mg lactulose/kg of composition):(mg furosine/100 g protein)) below about 1; and/or
f. any combination of two or more of a) to e) above; and/or
g. each of a) to e) above.

In another embodiment, the admixture is of a first stream having at heat treatment a pH of from 3 to 5 and a second stream comprising less than about 4% w/w carbohydrate, wherein the admixture comprises
a. less than about 5 g furosine per kg protein present; and
b. a lactulose:furosine ratio ((mg lactulose/kg of composition):(mg furosine/100 g protein)) below about 1.

In another embodiment, the admixture is of a first stream having a pH of from about 5 to about 6 and a second stream comprising less than about 4% w/w carbohydrate, wherein the admixture comprises
a. less than about 4 g furosine per kg protein present; and
b. a lactulose:furosine ratio ((mg lactulose/kg of composition):(mg furosine/100 g protein)) below about 1.

In one embodiment, for example an embodiment of the production of an RTF composition as herein contemplated, the admixture is of a first stream having at heat treatment a pH of from 3 to 5 and a second stream having a carbohydrate concentration of from 0% w/w to about 5% w/w, wherein the admixture comprises
a. furosine in an amount or concentration that is not more than 80% of the amount or concentration of furosine present in a control composition prepared in a single stream process with the same ingredients; and/or;
b. less than about 5 g furosine per kg protein present; and/or
c. less than about 300 mg lactulose per kg admixture; and/or
d. a lactulose:furosine ratio ((mg lactulose/kg of composition):(mg furosine/100 g protein)) below about 1; and/or
e. any combination of two or more of a) to d) above; or
f. each of a) to d) above.

In one embodiment, for example an embodiment of the production of an RTF composition as herein contemplated, the admixture is of a first stream having at heat treatment a pH of from 5 to 6 at heat treatment and a second stream having a carbohydrate concentration of from about 0% w/w to about 5% w/w, wherein the admixture comprises
a. furosine in an amount or concentration that is not more than 80% of the amount or concentration of furosine present in a control composition prepared in a single stream process with the same ingredients; and/or;
b. less than about 4 g furosine per kg protein present; and/or
c. less than about 500 mg lactulose per kg admixture; and/or
d. a lactulose:furosine ratio ((mg lactulose/kg of composition):(mg furosine/100 g protein)) below about 1; and/or
e. any combination of two or more of a) to d) above; or
f. each of a) to d) above.

In one embodiment, for example an embodiment of the production of an RTF composition such as a Stage 4 RTF composition or a sports beverage or supplement as herein contemplated, the admixture is of a first stream having at heat treatment a pH of from 3 to 5 and a second stream having a carbohydrate concentration of from about 2% w/w to about 5% w/w, wherein the admixture comprises
a. furosine in an amount or concentration that is not more than 80% of the amount or concentration of furosine present in a control composition prepared in a single stream process with the same ingredients; and/or;
b. less than about 3.5 g furosine per kg protein present; and/or
c. less than about 500 mg lactulose per kg admixture; and/or
d. a lactulose:furosine ratio ((mg lactulose/kg of composition):(mg furosine/100 g protein)) below about 3; and/or
e. any combination of two or more of a) to d) above; or
f. each of a) to d) above.

In a particularly contemplated example, such as an example of the production of a Stage 4 RTF composition as herein contemplated, the admixture is of a first stream having at heat treatment a pH of from 3 to 5 and a second stream having a carbohydrate concentration of from about 4% w/w to about 5% w/w, wherein the admixture comprises
a. furosine in an amount or concentration that is not more than 80% of the amount or concentration of furosine present in a control composition prepared in a single stream process with the same ingredients; and/or;
b. less than about 3.5 g furosine per kg protein present; and/or
c. less than about 500 mg lactulose per kg admixture; and/or
d. a lactulose:furosine ratio ((mg lactulose/kg of composition):(mg furosine/100 g protein)) below about 3; and/or
e. any combination of two or more of a) to d) above; or
f. each of a) to d) above.

In a particularly contemplated example, such as an example of the production of a sports beverage or supplement as herein contemplated, the admixture is of a first stream having at heat treatment a pH of from 3 to 5 and a second stream having a reducing sugar concentration of from about 4% w/w to about 5% w/w, wherein the admixture comprises
a. furosine in an amount or concentration that is not more than 80% of the amount or concentration of furosine present in a control composition prepared in a single stream process with the same ingredients; and/or;
b. less than about 2 g furosine per kg protein present; and/or
c. less than about 500 mg lactulose per kg admixture; and/or
d. a lactulose:furosine ratio ((mg lactulose/kg of composition):(mg furosine/100 g protein)) below about 5; and/or
e. any combination of two or more of a) to d) above; or
f. each of a) to d) above.

In one embodiment, for example an embodiment of the production of a medical food as herein contemplated, the admixture is of a first stream having at heat treatment a pH of from 3 to 5 and one or more other streams, such as a second stream and/or a third stream, having a carbohydrate concentration of from 0% w/w to about 5% w/w, wherein the admixture comprises
a. furosine in an amount or concentration that is not more than 80% of the amount or concentration of furosine present in a control composition prepared in a single stream process with the same ingredients; and/or;
b. less than about 4 g furosine per kg protein present; and/or
c. less than about 150 mg lactulose per kg admixture; and/or
d. a lactulose:furosine ratio ((mg lactulose/kg of composition):(mg furosine/100 g protein)) below about 1.5; and/or
e. any combination of two or more of a) to d) above; or
f. each of a) to d) above.

In one embodiment, the admixture is of a first stream having at heat treatment a pH of from 3 to 5 and a second stream having a carbohydrate concentration of 5% w/w or less, or of 4.5% w/w or less, for example of 4% w/w or less, wherein after admixture
a. the composition is shelf stable for at least 28 days following manufacture when stored at 25° C.; and/or
b. the composition has a whiteness index of more than 85 immediately following manufacture; and/or
c. when stored at 25° C. to for 28 days after manufacture the composition exhibits no more than a 10% reduction in whiteness, for example exhibits no more than a 5% reduction in whiteness; and/or
d. the composition has a slower rate of browning over storage at 25° C. for 28 days after manufacture than a control composition prepared in a single stream process with the same ingredients; and/or
e. the composition retains over its shelf life a colour benefit when compared to a control composition prepared in a single stream process with the same ingredients and stored under the same conditions; and/or
f. the composition over its shelf life has less than 50% of the reduction in whiteness observed in a control composition prepared in a single stream process with the same ingredients and stored under the same conditions; and/or
g. when stored at 25° C. for 28 days after manufacture the composition comprises less than about 5 g furosine per kg protein present; and/or
h. when stored at 25° C. for 28 days after manufacture the composition exhibits no more than a two-fold increase, for example no more than a 1.5-fold increase, in furosine concentration; and/or
i. when stored at 25° C. for 28 days after manufacture the concentration of furosine is not more than 80% of the concentration of furosine in a control composition prepared in a single stream process with the same ingredients and stored under the same conditions; and/or
j. when stored at 25° C. for 28 days after manufacture the composition exhibits no more than a two-fold increase in lactulose concentration; and/or
k. any combination of two or more of any of a) to j) above; or
l. each of a) to j) above.

In one embodiment, for example an embodiment of the production of an RTF composition as herein contemplated, the admixture is of a first stream having at heat treatment a pH of from 3 to 6 and a second stream having a carbohydrate concentration of from 0% w/w to about 4% w/w, wherein after admixture
a. the composition is shelf stable for at least 28 days following manufacture when stored at 25° C.; and/or
b. the composition has a whiteness index of more than 85 immediately following manufacture; and/or
c. when stored at 25° C. for 28 days after manufacture the composition exhibits no more than a 10% reduction in whiteness, for example exhibits no more than a 5% reduction in whiteness; and/or
d. the composition has a slower rate of browning over storage at 25° C. for 28 days after manufacture than a control composition prepared in a single stream process with the same ingredients and stored under the same conditions; and/or
e. the composition retains over its shelf life a colour benefit when compared to a control composition prepared in a single stream process with the same ingredients and stored under the same conditions; and/or
f. when stored at 25° C. for 28 days after manufacture the composition comprises less than about 5 g furosine per kg protein present; and/or
g. when stored at 25° C. for 28 days after manufacture the composition exhibits no more than a two-fold increase, for example no more than a 1.5-fold increase, in furosine concentration; and/or
h. when stored at 25° C. for 28 days after manufacture the concentration of furosine is not more than 80% of the concentration of furosine in a control composition prepared in a single stream process with the same ingredients and stored under the same conditions; and/or
i. when stored at 25° C. for 28 days after manufacture the composition exhibits no more than a two-fold increase in lactulose concentration; and/or
j. the lactulose:furosine ratio ((mg lactulose/kg of composition):(mg furosine/100 g protein) of the composition remains below 1 after storage at 25° C. for 28 days after manufacture; and/or
k. the lactulose:furosine ratio ((mg lactulose/kg of composition):(mg furosine/100 g protein) of the composition after storage at 25° C. for 30 days after manufacture is at least 85% that of the composition immediately after manufacture; and/or
l. any combination of two or more of any of a) to k) above; or
m. each of a) to k) above.

In one embodiment, for example an embodiment of the production of an RTF composition such as a Stage 4 RTF composition as herein contemplated, the admixture is of a first stream having at heat treatment a pH of from 3 to 5 and a second stream having a carbohydrate concentration of from about 2% w/w to about 5% w/w, for example a carbohydrate concentration of from about 4% w/w to about 5% w/w or from about 4% w/w to about 4.5% w/w, wherein after admixture
a. the composition is shelf stable for at least 28 days following manufacture when stored at 25° C.; and/or
b. when stored at 25° C. for 28 days after manufacture the composition exhibits no more than a 10% reduction in whiteness, for example exhibits no more than a 5% reduction in whiteness; and/or
c. the composition has a slower rate of browning over storage at 25° C. to 40° C. for 28 days after manufacture than a control composition prepared in a single stream process with the same ingredients and stored under the same conditions; and/or
d. the composition retains over its shelf life a colour benefit when compared to a control composition prepared in a single stream process with the same ingredients and stored under the same conditions; and/or
e. when stored at 25° C. for 28 days after manufacture the composition comprises less than about 5 g furosine per kg protein present; and/or
f. when stored at 25° C. for 28 days after manufacture the composition exhibits no more than a two-fold increase in furosine concentration; and/or
g. when stored at 25° C. for 28 days after manufacture the composition exhibits no more than a two-fold increase, for example no more than a 1.5-fold increase, in lactulose concentration; and/or
h. any combination of two or more of any of a) to g) above; or
i. each of a) to g) above.

In a particularly contemplated example, such as an example of the production of a sports beverage or supplement as herein contemplated, the admixture is of a first stream having at heat treatment a pH of from 3 to 5 and a second stream having a carbohydrate concentration of from about 4% w/w to about 5% w/w, for example from about 4% w/w to about 4.5% w/w, wherein after admixture
a. the composition is shelf stable for at least 28 days following manufacture when stored at 25° C.; and/or
b. when stored at 25° C. for 28 days after manufacture the composition exhibits no more than a 10% reduction in whiteness, for example exhibits no more than a 5% reduction in whiteness; and/or
c. the composition has a slower rate of browning over storage at 25° C. for 28 days after manufacture than a control composition prepared in a single stream process with the same ingredients and stored under the same conditions; and/or
d. the composition retains over its shelf life a colour benefit, such as maintenance of a whiter colour, when compared to a control composition prepared in a single stream process with the same ingredients and stored under the same conditions; and/or
e. the composition over its shelf life has less than 50% of the reduction in whiteness observed in a control composition prepared in a single stream process with the same ingredients and stored under the same conditions; and/or
f. when stored at 25° C. for 28 days after manufacture the composition comprises less than about 5 g furosine per kg protein present; and/or
g. when stored at 25° C. for 28 days after manufacture the composition exhibits no more than a two-fold increase in furosine concentration; and/or
h. when stored at 25° C. for 28 days after manufacture the concentration of furosine is not more than 50% of the concentration of furosine in a control composition prepared in a single stream process with the same ingredients and stored under the same conditions; and/or
i. when stored at 25° C. for 3 months after manufacture the concentration of furosine is not more than 35% of the concentration of furosine in a control composition prepared in a single stream process with the same ingredients and stored under the same conditions; and/or
j. when stored at 25° C. for 28 days after manufacture the concentration of furosine has increased by not more than 80% of the increase in furosine concentration in a control composition prepared in a single stream process with the same ingredients and stored under the same conditions; and/or
k. when stored at 25° C. for 28 days after manufacture the composition exhibits no more than a two-fold increase, for example no more than a 1.5-fold increase, in lactulose concentration; and/or
l. any combination of two or more of any of a) to k) above; or
m. each of a) to k) above.

In one embodiment, for example an embodiment of the production of a medical food as herein contemplated, the admixture is of a first stream having at heat treatment a pH of from 3 to 5 and one or more other streams, such as a second stream and/or a third stream, having a carbohydrate concentration of from 0% w/w to about 4% w/w, wherein after admixture
a. the composition is shelf stable for at least 28 days following manufacture when stored at 25° C.; and/or
b. when stored at 25° C. for 28 days after manufacture the composition exhibits no more than a 10% reduction in whiteness, for example exhibits no more than a 5% reduction in whiteness; and/or
c. the composition has a slower rate of browning over storage at 25° C. for 28 days after manufacture than a control composition prepared in a single stream process with the same ingredients and stored under the same conditions; and/or
d. the composition retains over its shelf life a colour benefit when compared to a control composition prepared in a single stream process with the same ingredients and stored under the same conditions; and/or
e. the composition over its shelf life has less than 50% of the reduction in whiteness observed in a control composition prepared in a single stream process with the same ingredients and stored under the same conditions; and/or
f. when stored ° 28 days after manufacture the composition comprises less than about 8 g furosine per kg protein present; and/or
g. when stored at 25° C. for 28 days after manufacture the composition exhibits no more than a two-fold increase in furosine concentration; and/or
h. when stored at 25° C. for 28 days after manufacture the concentration of furosine is not more than 50% of the concentration of furosine in a control composition prepared in a single stream process with the same ingredients and stored under the same conditions; and/or
i. when stored at 25° C. for 28 days after manufacture the concentration of furosine has increased by not more than 80% of the increase in furosine concentration in a control composition prepared in a single stream process with the same ingredients and stored under the same conditions; and/or
j. when stored at 25° C. for 28 days after manufacture the composition exhibits no more than a two-fold increase in lactulose concentration; and/or
k. any combination of two or more of any of a) to j) above; or
l. each of a) to j) above.

In one embodiment, the admixture comprises:
a. furosine in an amount that is not more than 20% greater than the total amount of furosine present in the first stream and the second stream prior to heat treatment; and/or
b. less than about 5 g furosine per kg protein present; or
c. both of a) and b) above.

In a particularly contemplated example, such as an example of the production of a Stage 4 RTF composition as herein contemplated, the admixture is of a first stream having at heat treatment a pH of from 3 to 5 and a second stream having a carbohydrate concentration of from about 4% w/w to about 5% w/w, wherein the admixture comprises
a. furosine in an amount or concentration that is not more than 80% of the amount or concentration of furosine present in a control composition prepared in a single stream process with the same ingredients; and/or;
b. less than about 3.5 g furosine per kg protein present; or
c. both of a) and b) above.

In a particularly contemplated example, such as an example of the production of a sports beverage or supplement as herein contemplated, the admixture is of a first stream having at heat treatment a pH of from 3 to 5 and a second stream having a reducing sugar concentration of from about 4% w/w to about 5% w/w, wherein the admixture comprises
a. furosine in an amount or concentration that is not more than 80% of the amount or concentration of furosine present in a control composition prepared in a single stream process with the same ingredients; and/or;
b. less than about 2 g furosine per kg protein present; or
c. both of a) and b) above.

In one embodiment, for example an embodiment of the production of a medical food as herein contemplated, the admixture is of a first stream having at heat treatment a pH of from 3 to 5 and one or more other streams, such as a second stream and/or a third stream, having a carbohydrate concentration of from 0% w/w to about 5% w/w, wherein the admixture comprises
a. furosine in an amount or concentration that is not more than 80% of the amount or concentration of furosine present in a control composition prepared in a single stream process with the same ingredients; and/or;
b. less than about 4 g furosine per kg protein present; or
c. both of a) and b) above.

In one embodiment, the admixture is of a first stream having at heat treatment a pH of from 3 to 5 and a second stream having a carbohydrate concentration of 5% w/w or less, or of 4.5% w/w or less, for example of 4% w/w or less, wherein after admixture
a. the composition is shelf stable for at least 28 days following manufacture when stored at 25° C.; and/or
b. the composition has a slower rate of browning over storage at 25° C. for 28 days after manufacture than a control composition prepared in a single stream process with the same ingredients; and/or
c. the composition over its shelf life has less than 50% of the reduction in whiteness observed in a control composition prepared in a single stream process with the same ingredients and stored under the same conditions; and/or
d. when stored at 25° C. for 28 days after manufacture the composition comprises less than about 5 g furosine per kg protein present; and/or when stored at 25° C. for 28 days after manufacture the concentration of furosine is not more than 80% of the concentration of furosine in a control composition prepared in a single stream process with the same ingredients and stored under the same conditions; and/or
e. when stored at 25° C. for 28 days after manufacture the concentration of furosine has increased by not more than 80% of the increase in furosine concentration in a control composition prepared in a single stream process with the same ingredients and stored under the same conditions; and/or
f. any combination of two or more of any of a) to e) above; or
g. each of a) to e) above.

In one embodiment, for example an embodiment of the production of an RTF composition as herein contemplated, the admixture is of a first stream having at heat treatment a pH of from 3 to 6 and a second stream having a carbohydrate concentration of from 0% w/w to about 4% w/w, wherein after admixture
a. the composition is shelf stable for at least 28 days following manufacture when stored at 25° C.; and/or
b. the composition has a slower rate of browning over storage at 25° C. for 28 days after manufacture than a control composition prepared in a single stream process with the same ingredients and stored under the same conditions; and/or
c. the composition retains over its shelf life a colour benefit when compared to a control composition prepared in a single stream process with the same ingredients and stored under the same conditions; and/or
d. when stored at 25° C. for 28 days after manufacture the composition exhibits no more than a two-fold increase, for example no more than a 1.5-fold increase, in furosine concentration; and/or
e. when stored at 25° C. for 28 days after manufacture the concentration of furosine has increased by not more than 80% of the increase in furosine concentration in a control composition prepared in a single stream process with the same ingredients and stored under the same conditions; and/or
f. any combination of two or more of any of a) to e) above; or
g. each of a) to e) above.

In one embodiment, for example an embodiment of the production of an RTF composition such as a Stage 4 RTF composition as herein contemplated, the admixture is of a first stream having at heat treatment a pH of from 3 to 5 and a second stream having a carbohydrate concentration of from about 2% w/w to about 5% w/w, for example a carbohydrate concentration of from about 4% w/w to about 5% w/w or from about 4% w/w to about 4.5% w/w, wherein after admixture
a. the composition is shelf stable for at least 28 days following manufacture when stored at 25° C.; and/or
b. the composition has a slower rate of browning over storage at 25° C. for 28 days after manufacture than a control composition prepared in a single stream process with the same ingredients and stored under the same conditions; and/or
c. the composition retains over its shelf life a colour benefit when compared to a control composition prepared in a single stream process with the same ingredients and stored under the same conditions; and/or
d. when stored at 25° C. for 28 days after manufacture the composition comprises less than about 5 g furosine per kg protein present; and/or
e. when stored at 25° C. for 28 days after manufacture the composition exhibits no more than a two-fold increase in furosine concentration; and/or
f. any combination of two or more of any of a) to e) above; or
g. each of a) to e) above.

In a particularly contemplated example, such as an example of the production of a sports beverage or supplement as herein contemplated, the admixture is of a first stream having at heat treatment a pH of from 3 to 5 and a second stream having a carbohydrate concentration of from about 4% w/w to about 5% w/w, for example from about 4% w/w to about 4.5% w/w, wherein after admixture
a. the composition is shelf stable for at least 28 days following manufacture when stored at 25° C.; and/or
b. the composition has a slower rate of browning over storage at 25° C. for 28 days after manufacture than a control composition prepared in a single stream process with the same ingredients and stored under the same conditions; and/or
c. the composition over its shelf life has less than 50% of the reduction in whiteness observed in a control composition prepared in a single stream process with the same ingredients and stored under the same conditions; and/or
d. when stored at 25° C. for 28 days after manufacture the composition comprises less than about 5 g furosine per kg protein present; and/or
e. when stored at 25° C. for 28 days after manufacture the composition exhibits no more than a two-fold increase in furosine concentration; and/or
f. when stored at 25° C. for 28 days after manufacture the concentration of furosine is not more than 50% of the concentration of furosine in a control composition prepared in a single stream process with the same ingredients and stored under the same conditions; and/or
g. when stored at 25° C. for 3 months days after manufacture the concentration of furosine is not more than 50% of the concentration of furosine in a control composition prepared in a single stream process with the same ingredients and stored under the same conditions; and/or
h. when stored at 25° C. for 28 days after manufacture the concentration of furosine has increased by not more than 80% of the increase in furosine concentration in a control composition prepared in a single stream process with the same ingredients and stored under the same conditions; and/or
i. any combination of two or more of any of a) to h) above; or
j. each of a) to h) above.

In one embodiment, for example an embodiment of the production of a medical food as herein contemplated, the admixture is of a first stream having at heat treatment a pH of from 3 to 5 and one or more other streams, such as a second stream and/or a third stream, having a carbohydrate concentration of from 0% w/w to about 4% w/w, wherein after admixture
a. the composition is shelf stable for at least 28 days following manufacture when stored at 25° C.; and/or
b. the composition has a slower rate of browning over storage at 25° C. t for 28 days after manufacture than a control composition prepared in a single stream process with the same ingredients and stored under the same conditions; and/or
c. when stored at 25° C. for 28 days after manufacture the composition comprises less than about 8 g furosine per kg protein present; and/or
d. when stored at 25° C. for 28 days after manufacture the composition exhibits no more than a two-fold increase in furosine concentration; and/or
e. when stored at 25° C. for 28 days after manufacture the concentration of furosine is not more than 50% of the concentration of furosine in a control composition prepared in a single stream process with the same ingredients and stored under the same conditions; and/or
f. when stored at 25° C. for 28 days after manufacture the concentration of furosine has increased by not more than 80% of the increase in furosine concentration in a control composition prepared in a single stream process with the same ingredients and stored under the same conditions; and/or
g. any combination of two or more of any of a) to f) above; or
h. each of a) to f) above.

In one embodiment, the heat treatment of the first stream, or of the second stream, or of both the first stream and the second stream is UHT treatment.

In one embodiment, the UHT is direct UHT. In one embodiment, the UHT is indirect UHT. In a still further embodiment, both indirect UHT and direct UHT are used.

In one embodiment, at admixture, the temperature of the first stream is at least about 10° C., for example, is more than about 10° C., is at least about 15° C., for example at least about 20° C. In one embodiment, at admixture, the temperature of the first stream is less than about 75° C. For example, at admixture, the temperature of the first stream is from about 15° C. to about 70° C., such as from about 15° C. to about 65° C., from about 15° C. to about 60° C., from about 15° C. to about 55° C., from about 15° C. to about 50° C., from about 15° C. to about 45° C., from about 15° C. to about 40° C., from about 15° C. to about 35° C., from about 15° C. to about 30° C., from about 15° C. to about 25° C., or from about 15° C. to about 20° C.

In one embodiment, at admixture, the temperature of the second stream is at least about 15° C., for example at least about 20° C. In one embodiment, at admixture, the temperature of the second stream is less than about 75° C. For example, at admixture, the temperature of the second stream is from about 15° C. to about 70° C., such as from about 15° C. to about 65° C., from about 15° C. to about 60° C., from about 15° C. to about 55° C., from about 15° C. to about 50° C., from about 15° C. to about 45° C., from about 15° C. to about 40° C., from about 15° C. to about 35° C., from about 15° C. to about 30° C., from about 15° C. to about 25° C., or from about 15° C. to about 20° C.

In one embodiment, when heat treated the first stream comprises one or more soluble mineral salts, and/or one or more insoluble mineral salts, such as one or more soluble metal salts, or one or more insoluble metal salts, for example one or more soluble iron salts, one or more soluble magnesium salts, one of more soluble calcium salts, one or more soluble zinc salts, or one or more soluble potassium salts.

In one embodiment, when heat treated the second stream comprises one or more soluble mineral salts, and/or one or more insoluble mineral salts, such as one or more soluble metal salts, or one or more insoluble metal salts, for example one or more soluble iron salts, one or more soluble zinc salts, one or more soluble magnesium salts, one of more soluble calcium salts, or one or more soluble potassium salts.

In one embodiment, the method comprises, consists essentially of, or consists of:
a. providing a first stream comprising from about 1% w/w to about 35% w/w lactose, wherein the first stream is or has been heat-treated; and
b. providing a second stream comprising from about 0.05% to about 5% w/w protein, wherein the second stream is or has been heat-treated; and
c. aseptically admixing the heat-treated first stream and the heat-treated second stream, wherein at admixture
   i. the first stream has a pH in the range of from about 3 to about 5.5; and
   ii. the second stream has a pH in the range of from about 6.5 to about 8;
to provide a heat-treated nutritional composition.

In one embodiment, the method comprises, consists essentially of, or consists of:
a. UHT treating a first stream comprising from about 1% w/w to about 55% w/w carbohydrate and having a pH of from about 2.5 to about 5.5;
b. UHT treating a second stream having a pH of from about 6.5 to about 9, the second stream comprising
   i. from about 0.05% w/w to about 10% w/w protein;
   ii. from about 0% w/w to about 10% w/w lipid; and
   iii. optionally one or more soluble mineral salts; and
   iv. optionally one or more insoluble mineral salts; and
   v. optionally one or more fat soluble vitamins; and
   vi. optionally one or more water soluble vitamins; and
c. aseptically admixing the heat-treated first stream and the heat-treated second stream, wherein at admixture
   i. the first stream has a pH in the range of from about 2.5 to about 5.5; and
   ii. the second stream has a pH in the range of from about 6.5 to about 9;
to provide a heat-treated nutritional composition.

In one embodiment, the method produces a sterile, heat-treated aqueous nutritional composition that comprises, consists essentially of, or consists of:
a. from about 1% w/w to about 30% w/w carbohydrate;
b. from about 0.1% w/w to about 15% w/w protein;
c. from about 0% w/w to about 10% w/w lipid;
d. optionally one or more soluble mineral salts; and
e. optionally one or more insoluble mineral salts; and
f. optionally one or more vitamins.

In one embodiment, the method consists essentially of:
a. heat-treating a first stream comprising carbohydrate and having a pH of from about 2.5 to about 5.5; and
b. heat-treating a second stream comprising protein and having a pH of from about 6.5 to about 9; and
c. aseptically admixing the heat-treated first stream and the heat-treated second stream, wherein at admixture
   i. the first stream has a pH in the range of from about 2.5 to about 5.5; and
   ii. the second stream has a pH in the range of from about 6.5 to about 9;
to provide a heat-treated nutritional composition.

In one embodiment, the method comprises, consists essentially of, or consists of:
a. providing a first stream comprising from about 1% w/w to about 35% w/w lactose, wherein the first stream is or has been heat-treated; and
b. providing a second stream comprising from about 0.1% to about 20% w/w protein, wherein the second stream is or has been heat-treated; and
c. aseptically admixing the heat-treated first stream and the heat-treated second stream, wherein at admixture
   i. the first stream has a pH in the range of from about 3 to about 5.5; and
   ii. the second stream has a pH in the range of from about 6.5 to about 8;
to provide a heat-treated nutritional composition.

In one embodiment, the method comprises, consists essentially of, or consists of:
a. UHT treating a first stream comprising from about 1% w/w to about 40% w/w carbohydrate and having a pH of from about 2.5 to about 5.5;
b. UHT treating a second stream having a pH of from about 6.5 to about 9, the second stream comprising
   i. from about 0.1% w/w to about 20% w/w protein;
   ii. from about 0% w/w to about 10% w/w lipid; and
   iii. optionally one or more soluble mineral salts; and
   iv. optionally one or more insoluble mineral salts; and
   v. optionally one or more fat soluble vitamins; and
   vi. optionally one or more water soluble vitamins; and
c. aseptically admixing the heat-treated first stream and the heat-treated second stream, wherein at admixture
   i. the first stream has a pH in the range of from about 2.5 to about 5.5; and
   ii. the second stream has a pH in the range of from about 6.5 to about 9;
to provide a heat-treated nutritional composition.

In a further embodiment, the method comprises, consists essentially of, or consists of:
a. providing a first stream comprising from about 1% w/w to about 35% w/w lactose, wherein the first stream is or has been heat-treated; and
b. providing a second stream comprising from about 0.1% to about 35% w/w protein, wherein the second stream is or has been heat-treated; and
c. aseptically admixing the heat-treated first stream and the heat-treated second stream, wherein at admixture
   i. the first stream has a pH in the range of from about 3 to about 5.5; and
   ii. the second stream has a pH in the range of from about 6.5 to about 8;
to provide a heat-treated nutritional composition.

In one embodiment, the method comprises, consists essentially of, or consists of:
a. UHT treating a first stream comprising from about 1% w/w to about 40% w/w carbohydrate and having a pH of from about 2.5 to about 5.5;
b. UHT treating a second stream having a pH of from about 6.5 to about 9, the second stream comprising
   i. from about 0.1% w/w to about 35% w/w protein;
   ii. from about 0% w/w to about 10% w/w lipid; and
   iii. optionally one or more soluble mineral salts; and
   iv. optionally one or more insoluble mineral salts; and
   v. optionally one or more fat soluble vitamins; and
   vi. optionally one or more water soluble vitamins; and
c. aseptically admixing the heat-treated first stream and the heat-treated second stream, wherein at admixture
   i. the first stream has a pH in the range of from about 2.5 to about 5.5; and
   ii. the second stream has a pH in the range of from about 6.5 to about 9;
to provide a heat-treated nutritional composition.

In one embodiment, the method additionally comprises drying the heat-treated composition.

In one embodiment, the method additionally comprises packaging, including aseptically packaging, the heat-treated nutritional composition.

In one embodiment, the heat-treated liquid nutritional composition is a ready to feed formulation. In one embodiment, the heat treated liquid nutritional composition is a medical food. In one embodiment the heat treated liquid nutritional composition is a meal replacer. In one embodiment, the heat treated liquid nutritional composition is a sports beverage or supplement, such as a sports recovery beverage.

In a further aspect, the invention relates to a heat treated liquid nutritional composition produced by the method of any one of the preceding claims.

In still a further aspect, the invention relates to a heat-treated liquid nutritional composition comprising, consisting essentially of, or consisting of:
a. from about 1% w/w to about 30% w/w carbohydrate;
b. from about 0.1% w/w to about 35% w/w protein, such as from about 0.1% w/w to about 30% w/w protein;
c. from about 0% w/w to about 10% w/w lipid;
d. optionally one or more minerals or salts thereof, including one or more soluble mineral salts;
e. optionally one or more vitamins;
f. optionally one or more oligosaccharides, for example one or more glucooligosaccharides, one or more fructooligosaccharides; or one or more human milk oligosaccharides;
wherein the nutritional composition:
g. is shelf stable for at least 28 days following manufacture when stored at 25° C.; and/or
h. has a whiteness index of more than 85 immediately following manufacture; and/or
i. when stored at 25° C. to 40° C. for 28 days after manufacture exhibits no more than a 10% reduction in whiteness; and/or
j. immediately following manufacture comprises less than about 5 g furosine per kg protein present;
k. when stored at 25° C. to 40° C. for 28 days after manufacture comprises less than about 10 g furosine per kg protein present;
l. when stored at 25° C. to 40° C. for 28 days after manufacture exhibits no more than a 3-fold increase in furosine concentration; and/or
m. immediately following manufacture comprises less than about 300 mg lactulose per kg;
n. when stored at 25° C. to 40° C. for 28 days after manufacture exhibits no more than a 3-fold increase in lactulose concentration; and/or
o. any combination of two or more of any of g) to n) above; or
p. each of g) to n) above.

In one embodiment, the heat-treated composition is a composition wherein:
a. the lactulose:furosine ratio ((mg lactulose/kg of composition):(mg furosine/100 g protein)) of the composition is below about 1 immediately after manufacture; and/or
b. the lactulose:furosine ratio ((mg lactulose/kg of composition):(mg furosine/100 g protein)) of the composition is below about 0.8 immediately after manufacture; and/or
c. the lactulose:furosine ratio ((mg lactulose/kg of composition):(mg furosine/100 g protein) of the composition remains below 1 after storage at 25° C. to 40° C. for 28 days after manufacture; and/or
d. the lactulose:furosine ratio ((mg lactulose/kg of composition):(mg furosine/100 g protein) of the composition remains below 0.8 after storage at 25° C. to 40° C. for 28 days after manufacture; and/or
e. the lactulose:furosine ratio ((mg lactulose/kg of composition):(mg furosine/100 g protein) of the composition after storage at 25° C. for 30 days after manufacture is at least 85% that of the composition immediately after manufacture; and/or
f. the lactulose:furosine ratio ((mg lactulose/kg of composition):(mg furosine/100 g protein) of the composition after storage at 40° C. for 30 days after manufacture is at least 85% that of the composition immediately after manufacture; and/or
g. any combination of two or more of any of a) to f) above; or
h. each of a) to f) above.

In one embodiment, the heat-treated composition is a composition wherein:
a. greater than 90% of the particles present in the composition have a size of from 0.1 μm to 10 μm as categorised by the volume weighted average particle size parameter D[4,3]; and/or
b. greater than 90% of the particles present in the composition have a size of from 0.1 μm to 5 μm as categorised by the volume weighted average particle size parameter D[4,3]; and/or
c. greater than 90% of the particles present in the composition comprise a population of particles having an average size of less than 2 μm as categorised by the volume weighted average particle size parameter D[4,3]; and/or
d. greater than 90% of the particles present in the composition comprise a population of particles having an average size of less than 1 μm as categorised by the volume weighted average particle size parameter D[4,3]; and/or
e. the average particle size is less than 2 μm as categorised by the volume weighted average particle size parameter D[4,3];
f. the average particle size is less than 1 μm as categorised by the volume weighted average particle size parameter D[4,3];
g. any combination of two or more of any of a) to f) above;
h. each of a) to f) above.

In one embodiment, when heated at 140° C. the time to greater than 95% coagulation of the second stream is in excess of 400 seconds. In one embodiment, when heated at 140° C. the time to greater than 95% coagulation of the second stream is from about 400 seconds to about 1200 seconds.

In one embodiment, when heated at 140° C. the time to greater than 95% coagulation of a protein-containing stream is in excess of 400 seconds. In one embodiment, when heated at 140° C. the time to greater than 95% coagulation of a protein-containing stream is from about 400 seconds to about 1200 seconds.

In one embodiment, the heat-treated liquid nutritional composition comprises from about 0.1% w/w to about 20% w/w protein, for example, comprises from about 0.1% w/w to about 15% w/w protein, or from about 0.1% w/w to about 10% w/w protein.

In various embodiments, the heat-treated liquid nutritional composition is a low viscosity composition. In certain examples, the heat-treated liquid nutritional composition has an apparent viscosity of from about 1 to about 50 mPa s at 25° C., for example an apparent viscosity of from about 1 to about 50 mPa s at 25° C. at a shear rate relevant for oral processing, for example at a shear rate of about 50 s⁻¹. In various embodiments, the heat-treated liquid nutritional composition has a viscosity commensurate with being considered a thin fluid as that term is used in the medical foods and dysphagia fields, for example as is used in the International Dysphagia Diet Standardisation Initiative Framework and Detailed Level Definitions, July 2019, available at iddsi.org/Framework-Documents.

In one embodiment, the heat-treated composition is selected from the group comprising a ready to feed formulation, an infant formula, and a follow-on formula. In one embodiment, the heat-treated composition is selected from the group comprising a medical food, a meal replacer, a sports beverage, and a dairy beverage.

In one embodiment, the heat-treated composition is a composition wherein the nutritional composition comprises a fermented composition and/or one or more products of fermentation by lactic acid bacteria.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7). These are only examples of what is specifically intended and all possible combinations of numerical values between the lowest value and the highest value enumerated are to be considered to be expressly stated in this application in a similar manner.

Those skilled in the art will appreciate the meaning of various terms of degree used herein. For example, as used herein in the context of referring to an amount (e.g., “about 9%”), the term “about” represents an amount close to and including the stated amount that still performs a desired function or achieves a desired result, e.g. “about 9%” can include 9% and amounts close to 9% that still perform a desired function or achieve a desired result. For example, the term “about” can refer to an amount that is within less than 10% of, within less than 5% of, within less than 1% of, within less than 0.1% of, or within less than 0.01% of the stated amount. It is also intended that where the term “about” is used, for example with reference to a figure, concentration, amount, integer or value, the exact figure, concentration, amount, integer or value is also specifically contemplated.

Other objects, aspects, features and advantages of the present invention will become apparent from the following description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

The invention is exemplified in the following non limiting embodiments and with reference to the accompanying figures.

### BRIEF DESCRIPTION OF THE FIGURES

FIG. 1: is a graphical representation of an exemplary method as described herein.

FIG. 2: is a graph of heat coagulation time for RTF stage 1 (S1) formulations comparing control (n=5) and SSP processing (n=10). Error bars represent standard errors of measurements from different trials.

FIG. 3: is a graph of furosine and lactulose content for Control and SSP process for various Stage 1 (S1) RTF formulations.

FIG. 4: is a graph of furosine content for RTF stage 1 formulations over shelf life after storage at 25° C.

FIG. 5: is a graph of lactulose:furosine ratio for S1 Ready to Feed Infant Formulations a) after conventional processing (control) and SSP processing and b) over storage at 25° C.

FIG. 6: is a graph showing heat coagulation time of conventionally produced control samples vs pH with gluconate, sulfate and insoluble salts (each point represents an individual test).

FIG. 7: is a graph showing Typical Day 0 particle size distributions of RTF post UHT from Trial set 2 (Malvern Mastersizer 3000; RI=1.456).

FIG. 8: whiteness index over shelf life comparing RTF Stage 1 (51) control formulations with Stage 1 and Stage 2 SSP formulations.

FIG. 9: is a graph showing heat coagulation time for RTF stage 1 (51) formulations comparing control and SSP processing and comparing alternative ingredient and processing options including dairy and non-dairy protein and carbohydrate sources for stream 2, fermentation for stream 1 and triple stream. Error bars represent standard errors of measurements from repeated trials or measurements.

FIG. 10: is a graph showing heat coagulation time for a several animal milks and several plant-based milks comparing control and SSP processing. Error bars represent standard errors of measurements from repeated trials or measurements.

FIG. 11: is a graph showing the pH profile during 8 hour fermentation at 42.5° C. of 21% lactose solution at different dosages of lactobacillus (0.1, 0.2 and 0.5 U/kg).

FIG. 12: is a graph depicting average furosine and lactulose content for Control and SSP process for various Stage 1 (51) RTF formulations. Error bars represent standard error from repeated trials. It was not possible to measure the lactulose content in the S1 SSP fructose trial due to the sample matrix using ISO Method 11285:2004.

FIG. 13: is a graph showing heat coagulation time for Stream 2 RTF Stage 4 formulations. Error bars represent standard errors of measurements from repeated trials or measurements.

FIG. 14: is a graph showing pH at heating and the % of undenatured lactoferrin remaining in solution as measured by RP-HPLC.

FIG. 15: is an image of 2.5% lactoferrin samples (left to right—pre UHT, Post UHT at pH 2.5, 3, 3.5, 4, 5, 6, 6.9, and 7.5.

FIG. 16: is a graph showing a comparison of lactoferrin survival and iron binding vs. pH (error bars—1 Standard Deviation).

FIG. 17: is a graph showing heat stability of sports-type nutritional compositions (8% protein, 0.7% fat and 7.2% carbohydrate) comparing control vs. SSP process.

FIG. 18: is a graph of furosine content of sports-type nutritional compositions (8% protein, 0.7% fat and 7.2% carbohydrate) comparing control vs. SSP process.

FIG. 19: is a photograph showing the colour of control vs. SSP for model sports formulations after 3 months storage at 25 deg.

FIG. 20: is a graph showing furosine concentration vs. shelf life for sports formulations stored at 25° C. for up to 3 months.

FIG. 21: is a graph showing heat stability of clinical-type nutritional compositions (4% protein, 5.8% fat and 18.4% carbohydrate) comparing control processing vs. SSP process.

FIG. 22: is a plot showing heat stability of clinical-type nutritional compositions (4% protein, 5.8% fat and 18.4% carbohydrate) comparing control processing vs. SSP process.

FIG. 23: is a graph of heat stability of compositions containing 2 wt % whey protein (error bars represent standard deviation, samples at pH 3 did not coagulate within 1200 seconds).

### DETAILED DESCRIPTION

The present invention relates to nutritional compositions, including nutritional compositions comprising one or more milk proteins, and methods for preparing such compositions and of their use.

A major challenge previously encountered in the production of protein-comprising nutritional compositions is the limited processability and heat-sensitivity of the protein component, and thus of the composition as a whole. The heat treatment given to nutritional compositions in order to provide microbial control frequently requires the protein to be heated above its denaturation temperature, resulting in protein denaturation and polymerisation into aggregates or gels. As a consequence, previous methods for preparing heat-treated liquid nutritional compositions, such as ready to feed formulations and/or liquid compositions, result in compositions having unwanted sensorial attributes like chalkiness, sandiness, lumpiness, and high viscosity. Shelf life of such products has been limited in that gelation, sediment and/or cream layers are formed soon after production. High temperature processing can also lead to the generation of sulphurous off-flavours in nutritional liquid compositions. In compositions with a high protein content, in particular high whey protein content, these problems are exacerbated, leading to products with unwanted aggregates, and a risk of extensive fouling and blocking of production plant, such as UHT heating equipment.

The methods of producing nutritional compositions described herein, in contrast, provide compositions having good sensorial attributes and processability properties that are particularly suited to application in the preparation of liquid nutritional compositions, such as but not limited to ready to feed formulations, sports beverages, sports supplements, meal replacers, and medical foods.

In certain embodiments, the composition is a liquid nutritional composition suitable for infants or children. In other embodiments, the composition is a liquid nutritional composition suitable for the elderly. Accordingly, compositions useful herein include geriatric supplements, maternal formulas, infant formulas, follow-on formulas and growing up formulas. Such products are formulated to target nutrients to the elderly or to an infant or child. In other embodiments, the composition is a liquid nutritional composition suitable for administration to a subject undergoing or who has undergone medical treatment, or convalescents or other patients including those that cannot otherwise get the nutrition required by consuming normal foods, or are unable to feed themselves. Accordingly, compositions useful herein include medical foods, also known as medical liquids, clinical foods, enteral foods, enteral nutrition, enteral nutritional products, enteral formula, and the like. Generally, such medical foods are administered and/or taken under the supervision or at the direction of a medical practitioner. Meal replacers, which are typically formulated to provide complete nutrition to a target consumer, are also specifically contemplated. In certain embodiments, meal replacers are formulated for those looking to control dietary intake while maintaining good nutrition, such as consumers looking to lose weight with products having controlled calorie count while still providing the nutritional requirements of the consumer, including those maintaining a specific diet such as Atkins, Keto, or vegan diets. In other embodiments, meal replacers are desired by consumers looking for convenience, for ease of use (such as ease of consumption on the go), for cost reasons, or for ethical reasons, such as minimising environmental impact or impacts on animal wellbeing.

The term “nutritional composition” refers to a composition that provides nutrition to a consumer, and generally is formulated to be administered orally, usually by eating or drinking. Also contemplated are compositions to be administrated by mouth or by other means, generally by eating, tube feeding, to the stomach or intestines of the consumer or subject. Such other means include naso-gastric feeding, gastric feeding, jejunal feeding, naso-duodenal and naso-jejunal feeding, and duodenal feeding.

The term “liquid nutritional composition” refers to an aqueous nutritional composition. Representative liquid nutritional compositions include medical foods including enteral nutritional compositions, food for special medical purposes, liquid meal replacers, and liquid meal supplement, as well as formulas such as infant formulas, follow-on formulas, growing-up formulas, and maternal formulas, and sports beverages. Concentrates, typically requiring only dilution to a consumable form, as well as ready to consume formulations are contemplated.

In certain embodiments the liquid nutritional compositions of the present invention provide significant amounts of protein and carbohydrate and usually also fat. They may also include vitamins and minerals. In exemplary embodiments they provide balanced meals.

The term “and/or” can mean “and” or “or”.

The term “comprising” as used in this specification means “consisting at least in part of”. When interpreting each statement in this specification that includes the term “comprising”, features other than that or those prefaced by the term may also be present. Related terms such as “comprise” and “comprises”, and the terms “including”, “include” and “includes” are to be interpreted in the same manner.

The term “consisting essentially of” when used in this specification refers to the features stated and allows for the presence of other features that do not materially alter the basic characteristics of the features specified.

The term “infant formula” as used in this specification means a composition for infants aged between 0 days and 6 months old.

The term “follow-on formula” as used in this specification means a composition for infants aged from 6 months. In certain jurisdictions, the term “follow-on formula” is generally used to describe compositions for infants from 6 months to 1 year, with a composition for infants and children older than 1 year being categorised variously as a “growing up formula” (when used in this specification this term means a composition directed to infants and children aged 1 year upwards), as a “formulated supplemented food for young children” for children aged 1 to 3 years, and as a “formulated supplemented food” for children aged 4 years and older. In other jurisdictions, a follow-on formula is used to refer to a composition for subjects aged from 6 to 36 months. Accordingly, as used herein the term “follow-on formula” encompasses growing-up formulas, formulated supplemented foods for young children, and formulated supplemented foods. In certain embodiments, follow-on formula and growing up formula include follow-on powders and growing-up milk powders, as will be understood by those skilled in the art.

The term “ready-to-feed” as used herein, unless otherwise specified, refers to nutritional compositions and formulas in liquid form suitable for administration to a consumer, frequently an infant, including reconstituted powders, diluted concentrates, and manufactured liquids.

Certain embodiments of the liquid nutritional compositions described herein, such as the medical foods, meal replacers, infant formulas, follow-on formulas, or growing up formulas and including ready to feed embodiments thereof contemplated herein, contain sufficient protein, carbohydrate, fat, vitamins, and minerals to potentially serve as the sole source of nutrition when provided in sufficient quantity.

In another embodiment, compositions useful herein include dietetic products. The term “dietetic product” means a product specially processed or formulated to satisfy particular dietary requirements which exist because of a particular physical or physiological condition and/or specific diseases and disorders and which are presented as such.

As used herein, “non-dairy protein” includes any protein that is not a milk protein, that is any protein that is not derived from animal milk. Non-dairy protein includes plant-derived protein, microorganism-derived proteins, and algal proteins.

The term “shelf-stable” as used herein in relation to liquid nutritional compositions refers to compositions that remain in a liquid state in which no undesired sedimentation, gelation or aggregation is observed and negligible bacterial growth occurs when packaged aseptically after prolonged storage at a temperature of about 20° C., 22° C. or about 25° C. for at least about 28 days, and in certain contemplated embodiments for about 2 months, about 3 months, about 6 months or longer.

The term “substantially free” as used herein with respect to a subject and in reference to a specified feature or characteristic contemplates the predominant, but not necessarily complete, absence of the specified feature or characteristic from the subject. In certain examples as will be apparent on reading this disclosure, substantially free means the subject comprises less that 30% w/w of the specified feature or characteristic, for example, less than 25%, less than 20%, less than 15%, less than 10%, less than 5%, or less than 1% w/w of the specified feature or characteristic. The term “substantially undenatured” will be interpreted accordingly.

### Liquid Nutritional Compositions

The liquid nutritional compositions contemplated herein, including ready to feed (RTF) compositions, medical foods, meal replacers, and sports beverages and the like for use herein, in certain embodiments comprise lipid, protein, carbohydrate, minerals, and vitamins, each of which is selected in kind and amount to meet the dietary needs of the intended consumer population.

It will be appreciated that a wide variety of sources and types of these nutrients are known and can be used in the liquid nutritional compositions, provided that such nutrients are compatible with one another in the selected formulation and are otherwise suitable for use in the composition, such as in an infant RTF composition, a meal replacer, or in a medical food composition. Likewise, it will be appreciated on reading this description that the methods described herein are amenable to use with a variety of ingredients and with ingredients provided in both solid and fluid forms, such as dried ingredients including those provided as powders, granules, or pellets, liquid ingredients including those provided as aqueous compositions, oils, and the like, and in certain embodiments gaseous forms, such as water provided as steam.

The carbohydrate used typically comprises digestible carbohydrate as 75-100% of the carbohydrate present. Representative carbohydrates suitable for use herein include simple or complex carbohydrates, lactose-containing or lactose-free, or combinations thereof, non-limiting examples of which include hydrolyzed, intact, naturally and/or chemically modified cornstarch, maltodextrin, glucose polymers, sucrose, corn syrup, corn syrup solids, rice or potato derived carbohydrate, glucose, fructose, lactose, high fructose corn syrup, human milk oligosaccharides (HMO). Oligosaccharides of glucose are typically used. A number of these are commercially available as maltodextrin or corn syrup. Indigestible oligosaccharides such as fructooligosaccharides (FOS), galactooligosaccharides (GOS), inulin, and combinations thereof will in certain embodiments also be present, typically in amounts of 0.1 to about 5% w/w, preferably 0.2 to about 1% w/w of the composition. Fibre, including insoluble fibre, will also be present in certain embodiments.

In certain embodiments, the composition comprises from about 0.1% w/w to about 30% w/w lactose, such as from about 1% w/w to about 25% w/w lactose, from about 1% w/w to about 20% w/w lactose, from about 1% w/w to about 15% w/w lactose, or from about 1% w/w to about 10% w/w lactose. In other embodiments the composition comprises less than about 10%, 9%, 8%, 7%, 6%, 5%, 4%, 3%, 2%, 1%, 0.5% or less than about 0.1% w/w lactose.

Proteins suitable for use herein include hydrolyzed, partially hydrolyzed, and non-hydrolyzed or intact proteins or protein sources, and can be derived from any known or otherwise suitable source such as milk, e.g., casein, whey, animal, e.g., meat, fish, cereal, e.g., rice, corn, oats, barley, plant or vegetable, e.g., soy, pea, hemp, pumpkin, quinoa, spirulina, nut protein, almond protein, or combinations thereof. As will be evident from the description herein, in certain embodiments of the RTF compositions contemplated herein, one or more proteins, such as one or more proteins intended to retain one or more of its biological activities, present in the RTF composition is present in a non-denatured, native state. Particularly contemplated embodiments of the liquid nutritional compositions, particularly the RTF compositions, described herein comprise whey protein.

The lipid used in specifically contemplated embodiments will typically be a dairy lipid, such as a milk fat or butter fat, but embodiments comprising one or more other animal lipids, including marine oils, and fish oils, and embodiments comprising one or more plant lipids, are contemplated. Plant, usually vegetable, oils are often used because of their ease of formulation and lower saturated fatty acid content, and/or because they are good sources of nutritionally important fatty acids and other macronutrients. Exemplary plant oils include coconut oil, canola (rapeseed) oil, corn oil, sunflower oil, high oleic sunflower oil, palm and palm kernel oils, palm olein, olive oil, safflower oil, high oleic safflower oil, algal oil, MCT oil (medium chain triglycerides), soybean oil, cottonseed oils, and combinations thereof.

Animal fats other than milk fat or butter fat are also suitable for use in the RTF compositions contemplated herein.

The formulation of the nutritional composition will in certain embodiments also contain one or more, and frequently a variety of vitamins and minerals, such as those required to meet the recommended nutritional requirements of a consumer, or in certain embodiments to sustain a subject nutritionally for a period of time. Suitable mineral, vitamin, or mineral and vitamin premixes are readily available and are suitable for use herein. The amounts of vitamins and minerals to be used in certain embodiments of the compositions contemplated herein are those typical of such formulations as are known to those skilled in the art.

Minor components such as antioxidants, flavouring, stabilisers, emulsifiers and colouring will in certain embodiments also be present. One or more bioactives, such as but not limited to one or more bioactives from the group comprising amino acids including branched chain amino acids, DHA, EPA, ARA, milk fat globule membrane (MFGM), phospholipids, lactoferrin, lactoperoxidase, lysozyme, choline, lutein, HMO, GOS, FOS, nucleotides, antioxidants, osteopontin, LC-PUFA, BSA, collagen, including hydrolysates of collagen, creatine, stanols (also called phytostanols, plant stanol esters), sterols (also called phytosterols, plant sterol esters), glucosamine, chondroitin, beta-glucan, beta-hydroxy-beta-methylbutyrate, hyaluronic acid, polyphenols including flavonoids such as flavonols, flavanols, flavan-3-ols, flavones, flavanones, anthocyanidins, phenolic acids including hydroxybenzoic acids and hydroxycinnamic acids, phenolic alcohols, stilbenes including resveratrol, lignans, and curcuminoids including curcumin, including polyphenols from, for example, green tea extract, ginger root extract, spirulina extract, black pepper, acai berry, ashwagandha, astragalus, echinacea, fruit extracts, and spices such as turmeric, alpha-lactalbumin, L-carnitine, gamma butyrobetaine, medium chain triglycerides, coenzyme Q10, enzymes, taurine, guarana, caffeine, vitamins, minerals, chitosan, and betaine

It will be appreciated that many governments regulate the composition of food products, such as nutritional compositions such as the medical foods, RTF compositions, meal replacers, and other formulations as contemplated herein, able to be sold. Accordingly, the liquid nutritional compositions contemplated herein desirably comprise nutrients in accordance with the relevant guidelines for the targeted consumer or user population in the market in which they are to be sold.

The micro-nutritional requirements of various sub-groups of the population are well known, and the recommended daily requirements of vitamins and minerals are likewise known for various population subgroups. For example, Dietary Reference Intakes: RDA and AI for vitamins and elements, United States National Academy of Sciences, Institute of Medicine, Food and Nutrition Board (2010) presents recommended intakes for infants 0-6, 6-12 months, children 1-3, and 4-8 years, adults males (6 age classes), females (6 age classes), pregnant (3 age classes) and lactating (3 age classes).

For example, an infant RTF composition to be sold in the US desirably meets the nutritional guidelines set out in, for example, the Infant Formula Act, 21 U.S.C. Section 350a(i). In another example, the level of added minerals can be selected based on European Commission guidelines on Food for Special Medical Purposes (FSMP) directive. In certain embodiments, higher levels of one or more nutrients are included to meet a specific nutritional need.

Vitamins and similar other ingredients suitable for use in the compositions described herein include vitamin A, vitamin D, vitamin E, vitamin K, thiamine, riboflavin, pyridoxine, vitamin B12, niacin, folic acid, pantothenic acid, biotin, vitamin C, choline, inositol, salts and derivatives thereof, and combinations thereof.

Minerals suitable for use in the infant formulas include calcium, phosphorus, magnesium, iron, zinc, manganese, copper, chromium, iodine, sodium, potassium, chloride, and combinations thereof.

Concentrations of desired ingredients, such as nutrients recommended for daily intake, in the nutritional composition will in certain embodiments be tailored for the exemplary serve size for a particular target consumer or application so that the nutrition and ease of delivery requirements can be met simultaneously.

Accordingly, in one embodiment the composition comprises at least about 10, 20, 25, 30, 40, 50, 60, 70, 75, 80, 90 or 100% of the recommended daily intake (RDI) of vitamins and minerals as set by European (FSMP) or USDRA regulations in a 100 mL, in a 250 mL, in a 500 mL, or in a 1 L portion. Many of the samples produced herein include vitamin overages. Overages refer to the common practice of adding a greater quantity of an ingredient (typically an unstable microingredient such as a vitamin) than listed on the nutritional information panel, to ensure the quantity present in the product meets/exceeds the nutritional panel throughout its expected shelf life.

In various embodiments, the liquid nutritional composition comprises from about 0.05% w/w to about 15% w/w protein. In various examples, the liquid nutritional composition comprises about 0.05% w/w, about 0.1, about 0.2, about 0.25, about 0.5, about 0.75, about 1, about 1.25, about 1.5, about 1.75, about 2, about 2.25, about 2.5, about 2.75, or about 3% w/w protein, and useful ranges may be selected between any of these values (for example, from about 0.05% w/w to about 3% w/w, from about 0.5 to about 1.5, from about 0.5 to about 3, from about 1 to about 2, from about 1 to about 3, from about 1.5 to about 2.5, from about 1.5 to about 3, from about 2 to about 3, or from about 2.5% w/w to about 3% w/w protein).

In other examples, the liquid nutritional composition comprises about 2.5% w/w, about 3, about 3.5, about 4, about 4.5, about 5, about 5.5, about 6, about 6.5, about 7, about 7.5, about 8, about 8.5, about 9, about 9.5, about 10, about 10.5, about 11, about 11.5, about 12, about 12.5, about 13, about 13.5, about 14, about 14.5, or about 15% w/w protein, and useful ranges may be selected between any of these values (for example, from about 2.5% w/w to about 15% w/w, from about 3% w/w to about 15% w/w, from about 3.5% w/w to about 15% w/w, from about 4% w/w to about 15% w/w, from about 4.5% w/w to about 15% w/w, from about 5% w/w to about 15% w/w, from about 2.5% w/w to about 14% w/w, from about 2.5% w/w to about 13% w/w, from about 2.5% w/w to about 12% w/w, from about 2.5% w/w to about 11% w/w, from about 2.5% w/w to about 10% w/w, from about 2.5% w/w to about 9% w/w, from about 2.5% w/w to about 8% w/w, from about 2.5% w/w to about 7% w/w, from about 2.5% w/w to about 6% w/w, from about 2.5% w/w to about 5% w/w, from about 3% w/w to about 10% w/w, from about 3.5% w/w to about 10% w/w, from about 4% w/w to about 10% w/w, from about 4.5% w/w to about 10% w/w, from about 5% w/w to about 10% w/w protein, and the like).

In one embodiment, the liquid nutritional composition is a ready to feed composition, including for example a liquid nutritional concentrate composition.

In various embodiments, the ready to feed nutritional composition comprises from about 0.05% w/w to about 15% w/w protein, or from about 0.05% w/w to about 10% w/w protein. In exemplary embodiments of the liquid compositions described herein, the composition comprises from about 0.05% w/w to about 5% w/w protein or from about 0.5% w/w to about 5% w/w protein. For example, the ready to feed nutritional composition comprises about 0.05% w/w, about 0.1, about 0.2, about 0.25, about 0.5, about 0.75, about 1, about 1.25, about 1.5, about 1.75, about 2, about 2.25, about 2.5, about 2.75, or about 3% w/w protein, and useful ranges may be selected between any of these values (for example, from about 0.05% w/w to about 3% w/w, from about 0.5 to about 1.5, from about 0.5 to about 3, from about 1 to about 2, from about 1 to about 3, from about 1.5 to about 2.5, from about 1.5 to about 3, from about 2 to about 3, or from about 2.5% w/w to about 3% w/w protein).

Accordingly, in one embodiment, the ready to feed nutritional composition, such as the liquid nutritional concentrate composition, comprises from about 2.5% w/w to about 15% w/w protein, or from about 3% w/w to about 15% w/w, from about 3.5% w/w to about 15% w/w, from about 4% w/w to about 15% w/w, from about 4.5% w/w to about 15% w/w, from about 5% w/w to about 15% w/w, from about 2.5% w/w to about 14% w/w, from about 2.5% w/w to about 13% w/w, from about 2.5% w/w to about 12% w/w, from about 2.5% w/w to about 11% w/w, from about 2.5% w/w to about 10% w/w protein.

In other embodiments, the liquid nutritional composition comprises about 10% w/w, about 10.5, about 11, about 11.5, about 12, about 12.5, about 13, about 13.5, about 14, about 14.5, about 15, about 15.5, about 16, about 16.5, about 17, about 17.5, about 18, about 18.5, about 19, about 19.5, or about 20% w/w protein, and useful ranges may be selected between any of the values set out herein (for example, from about 1% w/w to about 20% w/w, from about 2% w/w to about 20% w/w, from about 3% w/w to about 20% w/w, from about 4% w/w to about 20% w/w, from about 5% w/w to about 20% w/w, from about 6% w/w to about 20% w/w, from about 7% w/w to about 20% w/w, from about 8% w/w to about 20% w/w, from about 9% w/w to about 20% w/w, from about 10% w/w to about 20% w/w, from about 11% w/w to about 20% w/w, from about 12% w/w to about 20% w/w, from about 13% w/w to about 20% w/w, from about 14% w/w to about 20% w/w, from about 15% w/w to about 20% w/w, from about 16% w/w to about 20% w/w, from about 17% w/w to about 20% w/w, from about 18% w/w to about 20% w/w, from about 19% w/w to about 20% w/w, from about 10% w/w to about 19% w/w, from about 10% w/w to about 18% w/w, from about 10% w/w to about 17% w/w, from about 10% w/w to about 16% w/w, from about 11% w/w to about 19% w/w, from about 11% w/w to about 18% w/w, from about 11% w/w to about 17% w/w, from about 11% w/w to about 16% w/w, from about 11% w/w to about 15% w/w, from about 12% w/w to about 19% w/w, from about 12% w/w to about 18% w/w, from about 12% w/w to about 17% w/w, from about 13% w/w to about 19% w/w protein, and the like).

In other embodiments, the liquid nutritional composition comprises about 20% w/w, about 20.5, about 21, about 21.5, about 22, about 22.5, about 23, about 23.5, about 24, about 24.5, about 25, about 25.5, about 26, about 26.5, about 27, about 27.5, about 28, about 28.5, about 29, about 29.5, or about 30% w/w protein, and useful ranges may be selected between any of the values set out herein (for example, from about 11% w/w to about 30% w/w, from about 12% w/w to about 30% w/w, from about 13% w/w to about 30% w/w, from about 14% w/w to about 30% w/w, from about 15% w/w to about 30% w/w, from about 16% w/w to about 30% w/w, from about 17% w/w to about 30% w/w, from about 18% w/w to about 30% w/w, from about 19% w/w to about 30% w/w, from about 20% w/w to about 30% w/w, from about 21% w/w to about 30% w/w, from about 22% w/w to about 30% w/w, from about 23% w/w to about 30% w/w, from about 24% w/w to about 30% w/w, from about 25% w/w to about 30% w/w, from about 26% w/w to about 30% w/w, from about 27% w/w to about 30% w/w, from about 28% w/w to about 30% w/w, from about 29% w/w to about 30% w/w, from about 20% w/w to about 29% w/w, from about 20% w/w to about 28% w/w, from about 20% w/w to about 27% w/w, from about 20% w/w to about 26% w/w, from about 21% w/w to about 29% w/w, from about 21% w/w to about 28% w/w, from about 21% w/w to about 27% w/w, from about 21% w/w to about 26% w/w, from about 21% w/w to about 25% w/w, from about 22% w/w to about 29% w/w, from about 22% w/w to about 28% w/w, from about 22% w/w to about 27% w/w, from about 23% w/w to about 29% w/w protein, and the like).

In various embodiments, the liquid nutritional composition is a medical food, including for example a medical food concentrate. In various embodiments, the medical food comprises from about 1% w/w to about 20% w/w protein, or from about 2% w/w to about 20% w/w protein. In exemplary embodiments of the liquid compositions described herein, the medical food comprises from about 1% w/w to about 15% w/w protein, or from about 2% w/w to about 15% w/w protein. For example, the medical food comprises about 1% w/w, about 2, about 3, about 4, about 5, about 6, about 7, about 8, about 9, about 10, about 11, about 12, about 13, about 14, or about 15% w/w protein, and useful ranges may be selected between any of these values (for example, from about 2% w/w to about 14% w/w, from about 2% w/w to about 13% w/w, from about 2% w/w to about 12 w/w, from about 3% w/w to about 14% w/w, or from about 3% w/w to about 13% w/w protein).

In various embodiments, the medical food, such as a medical food concentrate composition, comprises from about 2% w/w to about 20% w/w protein. For example, in certain embodiments the medical food concentrate composition comprises from about 10% w/w to about 20% w/w, from about 11% w/w to about 20% w/w, from about 12% w/w to about 20% w/w, from about 13% w/w to about 20% w/w, from about 14% w/w to about 20% w/w, from about 15% w/w to about 20% w/w, from about 16% w/w to about 20% w/w, from about 17% w/w to about 20% w/w, from about 18% w/w to about 20% w/w, from about 19% w/w to about 20% w/w protein.

In various embodiments, the liquid nutritional composition is a sports beverage, including for example a sports beverage concentrate. In various embodiments, the sports beverage comprises from about 1% w/w to about 15% w/w protein, for example, comprises at least about 2% w/w protein, about 3% w/w, about 4% w/w, about 5% w/w, about 6% w/w, about 7% w/w, about 8% w/w, about 9% w/w, or about 10% w/w protein.

In various embodiments, the liquid nutritional composition is a meal replacer, including for example a meal replacer concentrate. In various embodiments, the meal replacer comprises from about 1% w/w to about 15% w/w protein, for example, comprises at least about 2% w/w protein, about 3% w/w, about 4% w/w, about 5% w/w, about 6% w/w, about 7% w/w, about 8% w/w, about 9% w/w, or about 10% w/w protein. In certain embodiments, the protein comprises dairy protein. In certain embodiments, the protein comprises a plant protein, such as soy protein.

Representative formulations for liquid nutritional compositions as discussed above are provided herein in Tables 1 to 7, and particular formulations of liquid nutritional compositions exemplified herein are provided in Tables 9 to 11, 13 and 14.

In one embodiment, the liquid nutritional composition comprises from about 1% w/w to about 40% w/w carbohydrate, and useful ranges may be selected between any of the values encompassed by this range of values. In an exemplary embodiment of the liquid composition, the composition comprises from about 1% w/w to about 35% w/w carbohydrate, from about 1% w/w to about 30% w/w carbohydrate, from about 1% w/w to about 25% w/w carbohydrate, or from about 1% w/w to about 20% w/w carbohydrate.

In one embodiment, the liquid nutritional composition comprises of from about 0% w/w to about 10% w/w lipid. In an exemplary embodiment of the liquid composition, the composition comprises from about 1% w/w to about 10% w/w lipid, from about 1% w/w to about 8% w/w lipid, from about 1% w/w to about 6% w/w lipid, or from about 1% w/w to about 5% w/w lipid.

In certain embodiments of the invention, the lipid content is from about 1% to about 35% by weight, for example 5% to about 20%, or between 5% and 15%. In certain exemplary embodiments, for example higher fat compositions, the lipid content is from about 15% by weight to about 35% by weight.

In various embodiments, the liquid nutritional composition has, for example the composition comprises nutrients such as fat, protein and carbohydrate sufficient to provide an energy density of at least 0.5 kJ/mL. In certain embodiments, particularly in medical food or enteral product embodiments, higher energy density is desirable, such that compositions comprising nutrients such as fat, protein and carbohydrate sufficient to provide an energy density of at least about 1 kJ/mL, at least about 2 kJ/mL, at least about 3 kJ/mL, or at least about 4 kJ/mL or more are contemplated. Still higher energy density compositions are also contemplated, including those with an energy density of at least about 5 kJ/mL, at least about 7.5 kJ/mL, or at least about 10 kJ/mL are contemplated.

In certain embodiments, the liquid nutritional composition is mixed with one or more other ingredients to produce a protein-containing food product. Typically, the protein-containing food product is an edible consumer product that is able to carry protein.

In various embodiments, the protein-containing food product comprises at least about 1%, 1.5%, 2%, or 2.5% total protein by weight. In certain embodiments, the protein-containing food product comprises from about 1% to about 25% total protein by weight, and useful ranges may be selected from between any of these values (for example, from about 1% to about 20%, or about 1% to about 16%, 1% to about 15%, 1% to about 14%, or about 1% to a bout 12%, or about 1% to about 10%, or about 2% to about 20%, or about 2% to about 16%, 2% to about 15%, 2% to about 14%, or about 2% to about 12%, or about 2% to about 10%, about 4% to about 20%, or about 4% to about 16%, 4% to about 15%, 4% to about 14%, or about 4% to about 12%, or about 4% to about 10%, about 5% to about 20%, or about 5% to about 16%, 5% to about 15%, 5% to about 14%, or about 5% to about 12%, or about 5% to about 10% total protein by weight).

Specifically contemplated protein-containing food products include protein bars, beverages including dairy beverages, ice creams, acidified/fermented milks, cheeses, puddings, frozen desserts, coffee whiteners, components in a final food product such as a cream or foam component (such as a layer) in a cake, dessert, biscuit, bar, or in chocolate, creams, and gels. For example, dairy beverages such as fortified milks, flavoured milks, low lactose milks, protein-enriched, and mineral-enriched milks comprising a liquid nutritional composition contemplated herein, such as one produced by a method described herein, are specifically contemplated.

Proteins

The compositions contemplated herein can comprise, and the methods described herein are amenable to use with, a variety of protein and protein compositions. In particularly contemplated embodiments, the proteins are or comprise dairy proteins, including whey protein, and/or casein.

Whey protein is recognised as a complete protein, having a desirable amino acid composition which provides all of the essential amino acids, high cysteine content, high leucine content, ease of digestion. Whey protein also provides proteins associated with bioactivity, such as lactoglobulins, lactalbumins, immunoglobulins, and lactoferrin.

Exemplary whey protein preparations include whey protein concentrates (WPCs), whey powder, demineralised whey powder, and whey protein isolates (WPIs). WPC is rich in whey proteins, but also contains other components such as fat, lactose, and, in the case of cheese whey-based WPCs, glycomacropeptide (GMP), a casein-related non-globular protein that is non-denaturable. Typical methods of production of whey protein concentrate utilise membrane filtration.

Accordingly, as used herein “WPC” is a fraction of whey from which lactose has been at least partially removed to increase the protein content to at least 20% (w/w). In certain embodiments, the WPC has at least 35%, at least 40%, at least 55% (w/w), at least 65%, and in certain embodiments at least 80% of the total solids (TS) as whey protein. In some examples, the proportions of the whey proteins are substantially unaltered relative to those of the whey from which the WPC is derived.

WPI consists primarily of whey proteins with negligible fat and lactose content. Accordingly, the preparation of WPI typically requires a more rigorous separation process such as a combination of micro filtration and ultra-filtration or ion exchange chromatography. It is generally recognised that a WPI refers to a composition in which at least 90 weight % of the solids are whey proteins.

Whey proteins may originate from any mammalian animal species, such as, for instance cows, sheep, goats, horses, buffalos, and camels. In certain specifically contemplated embodiments, the whey protein is bovine.

In certain exemplary embodiments, the whey protein source is available as a powder, preferably the whey protein source is a WPC or WPI. In other specifically contemplated embodiments, the whey protein source is a liquid whey protein source, or a combination of liquid whey protein and solid whey protein sources.

Other protein that may be included in the liquid nutritional composition includes mixtures of milk proteins, in certain embodiments provided from a milk protein concentrate, casein, caseinate, or similar.

Casein for use in any of the compositions described herein includes soluble casein in the form of non-micellar casein, micellar casein, non-micellar caseinate, alpha-casein, beta-casein, kappa-casein, a casein fraction, an alpha-casein fraction, a beta-casein fraction, a kappa-casein fraction, casein treated by ultra high-pressure (UHP) processing, translucent casein or any combination of any two or more thereof.

In various embodiments the casein is micellar casein, non-micellar casein, or micellar and non-micellar casein. Non-micellar casein results from dissociation of the casein micelle resulting in smaller fractions or soluble caseins. Ingredients that comprise non-micellar casein are well known in the art.

In various embodiments the casein comprises or is provided by an ingredient comprising milk protein isolate (MPI), milk protein concentrate (MPC), micellar casein isolate (MCI), micellar casein concentrate (MCC), retentate such as an ultrafiltration retentate of skim milk, proteins of liquid condensed milk, skim milk, condensed skim milk, skim milk powder, whole milk, whole milk powder, a caseinate, total milk protein (TMP), milk co-precipitates, an MPC or MPI that has been modified to dissociate casein micelles, calcium-chelated casein micelles, a charge-modified casein, a casein ingredient, such as an MPC or MPI, where at least a portion of the calcium or phosphate or both the calcium and phosphate has been replaced with sodium, potassium, zinc, magnesium and like, or a combination of any two or more thereof; a glycosylated casein or a combination of any two or more thereof.

In various embodiments the composition comprises one or more, two or more or three or more non-dairy proteins selected from the group comprising microbial proteins, algal proteins, plant proteins, and animal proteins, and hydrolysed forms thereof.

Suitable non-dairy proteins for use in the compositions described herein in certain embodiments include proteins that are soluble at a pH of about 2 to about 8, or proteins provided in a form that is suspendable in solution. In one embodiment the non-dairy protein is at least partially hydrolysed. In another embodiment the non-dairy protein is non-hydrolysed. In one embodiment the composition comprises a blend of two or more non-dairy proteins wherein at least one non-dairy protein is at least partially hydrolysed and at least one non-dairy protein is non-hydrolysed.

In one embodiment the composition comprises one or more of soy protein, rice protein, hemp protein, pumpkin protein, oat protein, rice protein, barley protein, nut protein, almond protein, spirulina protein, quinoa protein, or pea protein. In another embodiment the composition comprises soy and pea protein.

Protein Denaturation

A number of nutritionally and functionally important proteins are susceptible to denaturation, for example on heating under permissive conditions, and while denaturation may not negatively impact the nutritional value of the protein, it usually will markedly decrease or ablate that protein's activity. Moreover, denaturation will typically affect the physicochemical properties of the protein and any compositions comprising the protein. For example, whey protein comprises high levels of globular proteins that are sensitive to aggregation in the denatured state.

The methods described herein enable the processing of protein-comprising streams in a manner that, when desired, minimises protein denaturation. For example, in certain embodiments, in compositions produced by the methods described herein comprising one or more whey proteins, the majority of one or more of said one or more whey proteins have a native conformation or are undenatured. For example, compositions comprising biologically active whey proteins, such as biologically active lactoferrin, are specifically contemplated, such that maximised retention of native protein conformation is desired.

The methods described herein are amenable to the preparation of such compositions. It will be appreciated that for compositions in which the degree of protein denaturation is a consideration, for example in compositions for which the retention of protein function is desired for at least one of the one or more proteins present, protein-containing ingredients are to be selected accordingly. Accordingly, in various embodiments wherein one or more proteins, such as one or more whey proteins, are present, one or more of the proteins, such as one or more of the one or more whey proteins, comprises or is provided by an ingredient that comprises at least about 55% of the heat-denaturable protein present in a non-denatured state. In certain embodiments the protein comprises, consists essentially of, or consists of at least about 65% of the heat-denaturable protein present in a non-denatured state, at least about 70% of the heat-denaturable protein present in a non-denatured state, at least about 75% of the heat-denaturable protein present in a non-denatured state, at least about 80% of the heat-denaturable protein present in a non-denatured state, at least about 85% of the heat-denaturable protein present in a non-denatured state, at least about 90% of the heat-denaturable protein present in a non-denatured state, or at least about 95% of the heat-denaturable protein present in a non-denatured state.

In certain embodiments, the nutritional composition comprises a fermented composition. For example, one or more of the process streams comprises a fermented composition, such as a carbohydrate-comprising composition fermented by one or more lactic acid bacteria, or a protein-comprising composition fermented by one or more lactic acid bacteria, or both.

In certain embodiments, the fermented composition comprises one or more components of mammalian milk, including for example one or more milk proteins, and/or lactose. In one example, a fermented milk-derived protein comprising composition is provided by incubation of a combination of at least one strain of lactic acid bacterium, such as one or more Lactococci spp., one or more Lactobacilli spp., one or more Streptococci spp., and/or one or more Bifidobacteria spp., and milk (for example, skim milk), or a milk derived product (for example, MPC, MPI, whey, WPI, WPC, milk or milk product retentates, permeates, and hydrolysates, such as whey retentates, whey permeates, and whey hydrolysates, and the like) under conditions permissive to fermentation.

In specifically contemplated embodiments of the RTF formulations described herein, the one or more lactic acid bacteria are suitable for use in the preparation of compositions for administration to infants or children, including lactic acid bacteria that are themselves GRAS, or safe for consumption by infants or children. A wide variety of lactic acid bacteria, including various probiotic lactic acid bacteria, suitable for use as contemplated herein are commercially available, such as the widely known Lactobacillus GG (ATCC 53103) and Lactobacillus johnsonii Lal strains.

Physicochemical and Organoleptic Properties

In specifically contemplated embodiments, the nutritional compositions described herein such as the RTF formulations contemplated herein are shelf stable for at least about 28 days following manufacture when stored at 25° C.

In other specifically contemplated embodiments, the nutritional compositions described herein such as the RTF formulations contemplated herein, have improved colour stability, and/or have improved whiteness, such as improved whiteness immediately after manufacture, or improved whiteness after a period of storage, compared to an otherwise equivalent composition (i.e., equivalent from an ingredient perspective) prepared using a conventional UHT process. In further embodiments, the nutritional compositions such as the RTF formulations when stored at 25° C. to 40° C. for 28 days after manufacture exhibit no more than a 10% reduction in whiteness.

In various embodiments, the nutritional compositions described herein such as the RTF formulations contemplated herein comprise furosine in an amount that is not more than 20% greater than the total amount of furosine present in the first stream and the second stream prior to heat treatment; and/or comprise less than about 5 g furosine per kg protein present.

In various embodiments, the nutritional compositions described herein such as the RTF formulations contemplated herein comprise lactulose in an amount that is not more than 10-fold greater than the total amount of lactulose present in the first stream and the second stream prior to their respective heat treatment.

In various embodiments, the ratio of lactulose (mg/kg composition) to furosine (mg/100 g protein) present in the nutritional composition, such as an RTF formulation as contemplated herein, is less than 1. In one embodiment, said ratio is less than 1 immediately after manufacture. In one embodiment, said ratio is less than 1 after storage at 25° C. for 28 days after manufacture.

In further embodiments, the nutritional compositions described herein such as the RTF formulations contemplated herein have a lactulose/furosine ratio that does not significantly change on storage, for example when stored at 25° C. for 28 days after manufacture.

Representative RTF Formulations

Various representative RFT formulations suitable for manufacture using methods described herein are presented below. Table 1 below presents a model formulation for a simplified RTF composition.

TABLE 1
Representative RTF formulation

| | Quantity in | Main ingredient |
|---|---|---|
| Nutrient | final Product | sources |
| Whey | 0.8 g/100 mL | WPC 80, Trim Milk, lactoferrin |
| Casein | 0.5 g/100 mL | Trim Milk |
| Fat | 3.4 g/100 mL | Sunflower Oil |
| Lactose | 7.0 g/100 mL | Lactose Powder |
| Lactoferrin | 0.06 g/100 mL | Lactoferrin Powder |
| Iron | 0.54 mg/100 mL | Iron Gluconate |
| Zinc | 0.5 mg/100 mL | Zinc Gluconate |
| Vitamin A | 62 ug/100 mL | Vitamin A Acetate Beadlet |
| Vitamin D | 1.3 ug/100 mL | Cholecalciferol SD |
| Vitamin C | 17.4 mg/100 mL | Sodium Ascorbate |
| Mixed | 0.21 mg/100 mL | Mixed Tocopherol Syrup |
| Tocopherols | | |

RTF formulations can be classified by reference to the target consumer, whereby stage 1 (S1) RTF formulations (referred to in the ANZ Food Standards Code as infant formulas) are prepared for administration to infants from 0 to 6 months, stage 2 (S2) RTF formulations (referred to in the ANZ Food Standards Code as follow-on formulas) are prepared for administration to infants from 6 months, stage 3 (S3) RTF formulations (referred to in the ANZ Food Standards Code as formulated supplemented foods for young children) are prepared for administration to infants aged 1 to 3 years, and stage 4 (S4) RTF formulations (referred to in the ANZ Food Standards Code as formulated supplemented foods) are prepared for administration to children from 4 years and older. As a consequence, the composition of for example a stage 1 RTF formulation will typically differ to some extent to that of a stage 4 RTF formulation, given the differing nutritional needs of the respective target consumer groups, and/or any regulatory requirements or considerations relevant to those respective target consumer groups. Table 2 below presents typical formulations for various representative stage 1, stage 2, stage 3 and stage 4 RTF compositions, while table 3 presents representative formulations for hypoallergenic, premature, and soy ready to feed compositions.

TABLE 2
Representative Stage 1 - stage 4 RTF formulations

| | Quantity in final Product | | | | | | | |
|---|---|---|---|---|---|---|---|---|
| | (g/100 mL unless otherwise specified) | | | | | | | |
| | Stage 1, | Stage 1, | Stage 2, | Stage 3, | Stage 3, | Stage 4, | Stage 4, | Stage 4, |
| Ingredient | A | B | A | A | B | A | B | C |
| Whey | 0.8 | 0.88 | 1.2 | 0.3 | 1.1 | 0.3 | 0.76 | 0.7 |
| Casein | 0.5 | 0.59 | 1.2 | 1.2 | 1.7 | 1.2 | 3.04 | 2.6 |
| Fat | 3.4 | 3.5 | 3.5 | 2.7 | 2.9 | 2.2 | 3 | 3.2 |
| Carbohydrate | 7 | 7.3 | 7.9 | 4.7 | 7.84 | 4.7 | 7 | 7.5 |
| Lactoferrin | 0.06 | | | | | | | 0.06 |
| Iron ^{A} | 0.54 | 0.75 | 0.99 | 1.2 | 1.6 | 1.2 | 1.4 | 1.4 |
| Zinc ^{A} | 0.5 | 0.7 | 0.61 | | 0.65 | | 1.2 | 1.2 |
| Vitamin A ^{B} | 62 | 90.7 | 121.3 | 89.5 | 52.0 | 89.9 | 88.0 | 75 |
| Vitamin D ^{B} | 1.3 | 1.3 | 1.7 | 4.1 | 1.0 | 4.1 | 1.2 | 1 |
| Vitamin C ^{A} | 17.4 | 38 | 32 | 30 | 24 | 30 | 14.8 | 10 |
| Mixed | 0.21 | | | | | | | 0.21 |
| Tocopherols ^{A} | | | | | | | | |

^{A} = (mg/100 mL),
^{B} = (ug/100 mL)

TABLE 3
Representative RTF formulations

| | Quantity in final Product | | |
|---|---|---|---|
| | (g/100 mL unless otherwise specified) | | |
| | Hypoallergenic | Premature | Soy |
| Ingredient | formula | formula | formula |
| Protein | 1.86 | 2.08 | 1.57 |
| Fat | 3.74 | 4.09 | 3.5 |
| Carbohydrate | 6.89 | 7.51 | 6.67 |
| Iron ^{A} | 1.2 | 1.3 | 1.2 |
| Zinc ^{A} | 0.5 | 0.9 | 0.5 |
| Vitamin ^{A} | 203 IU | 260 IU | 192 IU |
| Vitamin D | 41 IU | 52 IU | 38 IU |
| Vitamin C ^{A} | 6 | 11.16 | 5.8 |

^{A} = (mg/100 mL)

Representative Medical Food Formulations

Various representative medical food formulations suitable for manufacture using methods described herein are presented below. Table 4 below presents a typical formulation for a low fat medical food, and a high fat medical food targeted to subjects recovering from surgery.

TABLE 4
Representative medical foods

| | Quantity in final Product | | |
|---|---|---|---|
| | (g/100 mL unless otherwise specified) | | |
| | Standard | High | Compact |
| Nutrient | medical food | Protein | Formulation |
| Energy density | 0.9 | 0.45 | 1.9 |
| kJ/100 mL | | | |
| Protein | 3.3 | 7.9 | 6.6 |
| Fat | 3.0 | 0.8 | 5.8 |
| Carbohydrate | 16.0 | 6.0 | 8.8 |
| Iron ^{A} | 25% | 25% | 25% |
| Zinc ^{A} | 25% | 25% | 10% |
| Magnesium | 20% | 30% | 10% |
| Calcium | 30% | 50% | 10% |
| Vitamin ^{A} | 25% | 30% | 10% |
| Vitamin D ^{A} | 25% | 70% | 50% |
| Vitamin C ^{A} | 50% | 50% | 25% |
| Vitamin E | 50% | 25% | 25% |
| Other | Omega | caffeine | Omega |
| nutrients | 3 & ALA | | 3 & ALA |

^{A} = % DV per serve

Representative Sports Supplement Formulations

Various representative sports supplement formulations suitable for manufacture using methods described herein are presented below. Table 5 below presents a range of typical formulations for various sports drinks and protein shakes, including a high carbohydrate formulation, a high protein formulation, and muscle recovery sports beverages, sports drinks, smoothies, and shakes.

TABLE 5
Representative sports drinks

| | Quantity in final Product | | | | | | | |
|---|---|---|---|---|---|---|---|---|
| | (g/100 mL unless otherwise specified) | | | | | | | |
| | A - | B - High | C - Pre- | D - High | | | | |
| Ingredient | Recovery | Protein | workout | Carb | E | F | G | H |
| protein | 8.48 | 8.19 | 8.35 | 8.77 | 7.38 | 6.80 | 5.35 | 6.06 |
| fat | 1.31 | 0.37 | 0.40 | 1.47 | 1.08 | 3.00 | 0.75 | 0.30 |
| Carbs | 3.79 | 6.53 | 6.67 | 8.53 | 1.85 | 2.60 | 5.14 | 2.12 |
| Fibre | 0.21 | 0.35 | 0.88 | 0.51 | 0.31 | 0.20 | 0.21 | 1.21 |
| sodium | 0.21 | 0.06 | 0.09 | 0.17 | 0.09 | 0.06 | 0.03 | 0.08 |
| Calcium | | 0.18 | 0.18 | | | | 0.08 | 9.1% ^{A} |
| iron | | | | | | 1.26 | 0.00 | 0.6% ^{A} |
| potassium | | | | | | | 0.07 | 0.19 |
| Vitamin A ^{A} | | | | | | | | 9.1% |
| Vitamin D ^{A} | | | | | | | | 9.1% |
| Magnesium ^{A} | | | | | | | | 9.1% |
| Vitamin C ^{A} | | | | | | | | 9.1% |
| Phosphorus ^{A} | | | | | | | | 9.1% |
| Other | Glutamine | Antioxid | Caffeine | High carb | | | | |
| | and | ants | | | | | | |
| | BCAA's | | | | | | | |

^{A} = % DV per serve

Representative Meal Replacers

Various representative formulations for meal replacers suitable for manufacture using methods described herein are presented below. Table 6 below presents a typical formulation for a low carbohydrate, high protein meal replacer, and balanced carbohydrate & protein meal replacers, one of which comprises soy protein.

TABLE 6
Representative meal replacers

| | Quantity in final Product | | |
|---|---|---|---|
| | (g/100 mL unless otherwise specified) | | |
| Ingredient | High protein | Balanced - soy | Balanced |
| protein | 9.2 | 4.8 | 3.08 |
| fat | 1.5 | 5.8 | 1.54 |
| Carbs | 2.5 | 8.7 | 7.69 |
| Fibre | 2.2 | 0.7 | 1.54 |
| sodium | 0.1 | 0.1 | 0.04 |
| Calcium | 18.5% | 3.6% | 10.8% |
| Iron | 0.6% | 4.8% | 10.8% |
| Zinc ^{A} | 6.2% | 4.8% | |
| Magnesium ^{A} | 9.2% | 4.8% | |
| Potassium ^{A} | 1.8% | 4.8% | 4.6% |
| Vitamin A ^{A} | 0.0% | 4.8% | |
| Vitamin D ^{A} | 6.2% | 4.8% | 10.8% |
| Vitamin C ^{A} | 3.1% | 4.8% | |
| Vitamin E ^{A} | 6.2% | 4.8% | |

^{A} = % DV per serve

Methods of Manufacture

The methods described herein provide nutritional compositions that are shelf stable, have good colour stability, and retain high nutritional value while minimising the presence and development of undesired by-products of thermal processing, such as products of Maillard browning.

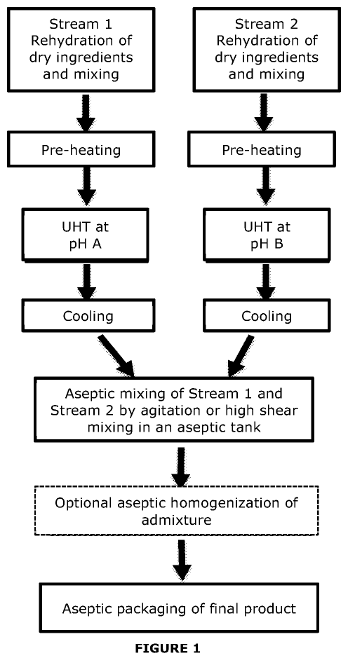

Exemplary methods for producing liquid nutritional compositions as contemplated herein are presented in the Examples, and a representative method is presented below and shown in FIG. 1. Suitable alterations to the methods specifically set out herein that provide the liquid nutritional compositions described herein will be apparent to those skilled in the art on reading this description.

In one representative, non-limiting embodiment:
a carbohydrate-comprising first stream and a protein-comprising second stream are provided;
   either or both of these streams are typically prepared from dry ingredients or blends by dispersal and hydration in water. Hydration will in certain circumstances take up to about 60 minutes. In certain embodiments, the water is heated (typically to a temperature of approximately 50° C.) to aid hydration of the dry ingredients. Although not usually required in the methods contemplated herein, in certain embodiments emulsifiers, anti-foam agents, and/or stabilisers are added to a stream, for example to a lipid-containing stream;
   one or more minerals, trace elements, and/or vitamins are added to the first stream, to the second stream, or to both the first stream and the second stream;
   optionally, lipid is added to the first stream, or to the second stream, or to both the first stream and the second stream;
   where necessary, the components of the first stream are homogenised, and/or the components of the second stream are homogenised, to ensure uniformity;
each of the first and second streams is heat treated to a temperature and for a duration sufficient to provide microbial control;
the first and second streams are aseptically admixed, wherein at admixture:
   the first stream has a pH in the range of from about 2.5 to about 5.5; and
   the second stream has a pH in the range of from about 6.5 to about 9.

Generally, said admixture is performed with good agitation to provide rapid and thorough mixing—for example using a high shear/flow inline mixer, mixing tank, and/or homogeniser.

In specifically contemplated embodiments, the pH of the first stream and the pH of the second stream is adjusted to the desired pH before or during heat treatment and is not adjusted further before admixture.

Following the heat treatment of the first and second streams, the aseptic processing thereafter provides a sterilised, shelf stable composition that does not require separate or subsequent sterilisation to achieve commercially acceptable sterilisation. Commercially acceptable sterilisation in this context contemplates a product free of those microorganisms which are otherwise capable of growing under normal non-refrigerated conditions at which the product is likely to be held during distribution and storage.

Heat Treatment

As described herein, the nutritional compositions contemplated here are heat treated primarily to increase shelf life and minimise the potential for growth of food spoilage and pathogenic microorganisms. As will be appreciated by those skilled in the art, the lethal effect of high temperatures on microorganisms is dependent on both temperature and holding time, and the reduction in time required to kill the same number of microorganisms as temperature is increased is well known.

The time taken to reduce initial microbial numbers, at a specified temperature, by a particular amount, is commonly referred to as a “F₀ value”. As described in Mullan, W. M. A. (2007) (Mullan, W. M. A., Calculator for determining the F value of a thermal process. [On-line], available from: www.dairyscience.info/calculators-models/134-f-value-thermal-process.html) and references therein, the F₀ value of a thermal process can be calculated by plotting lethal rates against process time, where lethal rate can be calculated using the following equation (Stobo, 1973):

Lethal rate=10^{(T-Tr)/z}

where T is the temperature at which the lethal rate is calculated, Tr is the reference temperature at which the equivalent lethal effect is compared, and z is the reciprocal of the slope of the thermal death curve for the target microorganism or spore (all values in degrees Celsius).

F₀ values can thus be used to describe the thermal input into a particular process, and thus establish some equivalency in the sterilising effect of the various heat treatments that will in different embodiments be used. While it has been observed that the use of F₀ assumes that the z value is independent of temperature, and that this is not strictly correct, it has also been observed that the change in z value over the range of temperatures used in UHT treatment is small and insignificant. An alternative definition (using the dimensionless index B* at a value of 1, which refers to 9 log reductions of a mixed heat-resistant spore population) corresponds to a heat treatment of similar intensity (see Heat Treatment Definitions, CX/MMP 00/15 Dec. 1999, Codex Alimentarius Commission, available at fao.org/tempref/codex/Meetings/CCMMP/CCMMP4/mm00_15e.pdf, and references cited therein).

Ultra-high temperature (UHT) treatment is particularly contemplated. UHT treatment is commonly considered to be heating to a minimum temperature of 138.5° C., and heating to at least about 140° C. is conveniently done in practice. In exemplary embodiments, the methods contemplated herein employ ultra-high temperature (UHT) treatment, in which one or more of the process streams are subjected to a heat treatment step comprising heating the stream to 140° C. for at least about 2.3 s or more, for example, at least about 2.5 s, at least about 3 s, at least about 3.5 s, at least about 4 s, at least about 4.5 s, at least about 5 s, or for from about 2 s to about 20 s. UHT conditions are typically 140° C. to 150° C. for 2 to 18 seconds, noting that it is a widespread view that the minimum duration of heating required to meet the desired sterility is usually advantageous for product quality parameters. In certain embodiments of the methods set forth herein, longer UHT durations are contemplated, for example 140° C. to 150° C. for 10 seconds, 15 seconds, 20 seconds, or more.

In various embodiments, the heat treatment of the first stream comprises a heat treatment step comprising heating the stream to 140° C. for at least about 2 s or more, for example, at least about 2.3 s, at least about 2.5 s, at least about 3 s, at least about 3.5 s, at least about 4 s, at least about 4.5 s, at least about 5 s, at least about 6 s, at least about 7 s, at least about 8 s, at least about 9 s, at least about 10 s, or from about 10 s to about 20 s.

In various embodiments, the heat treatment of the second stream comprises a heat treatment step comprising heating the stream to 140° C. for at least about 2 s or more, for example, at least about 2.5 s, at least about 3 s, at least about 3.5 s, at least about 4 s, at least about 4.5 s, at least about 5 s, at least about 6 s, at least about 7 s, at least about 8 s, at least about 9 s, at least about 10 s, or from about 10 s to about 20 s.

In exemplary embodiments, the methods contemplated herein employ ultra-high temperature (UHT) treatment, in which one or more of the process streams are typically subjected to a heat treatment step equivalent to heating to 140° C. for 5 s.

In various embodiments, the heat treatment of the first stream comprises a heat treatment equivalent to 140° C. for 2.3 s, or comprises a heat treatment equivalent to 140° C. for 4.6 s, or comprises a heat treatment equivalent to 140° C. for 9.2 s.

In various embodiments, the heat treatment of the second stream comprises a heat treatment equivalent to 140° C. for 2.3 s, or comprises a heat treatment equivalent to 140° C. for 4.6 s, or comprises a heat treatment equivalent to 140° C. for 9.2 s.

In exemplary embodiments, the methods contemplated herein employ ultra-high temperature (UHT) treatment, in which one or more of the process streams are typically subjected to a heat treatment step having an F₀-value of 5-6, being approximately equivalent to heating to 140° C. for 5 s.

In various embodiments, the heat treatment of the first stream comprises a heat treatment with an F₀ of about 3, such as 140° C. for 2.3 s, or comprises a heat treatment with an F₀ of about 6, such as 140° C. for 4.6 s, or comprises a heat treatment with an F₀ of 12, such as 140° C. for 9.2 s.

In various embodiments, the heat treatment of the second stream comprises a heat treatment with an F₀ of about 3, such as 140° C. for 2.3 s, or comprises a heat treatment with an F₀ of about 6, such as 140° C. for 4.6 s, or comprises a heat treatment with an F₀ of 12, such as 140° C. for 9.2 s.

As will be appreciated on reading the above, equivalent F₀ heat treatments at differing temperatures can be readily achieved by altering the duration of heating. Examples of such heat treatments can have F₀ values well in excess of the minimum threshold. Other combinations of equivalent heat treatment are known and are applicable to the methods described herein given appropriate adherence to the requirements of microbial stability and sterility.

For example, in certain embodiments, the methods contemplated herein employ ultra-high temperature (UHT) treatment for longer durations, in which one or more of the process streams are typically subjected to a heat treatment step equivalent to heating to 140° C. for about 8 s, for about 10 s, for about 12 s, for about 15 s, for about 18 s, for about 20 s, or longer.

In other embodiments, the methods contemplated herein employ high temperature treatment to provide an extended shelf life (ESL) composition, or a sterilized composition. Generally, such methods comprise subjecting the first stream and/or the second stream to a heat treatment step having an F₀-value of at least equivalent to 121° C. for 5 s for an ESL composition, or at least equivalent to 121° C. for 3 minutes or 115° C. for 13 minutes for a sterilised composition.

It should be appreciated that in certain embodiments, the high temperature treatment employed for heat treating the first stream, the second stream, and in embodiments in which one or more additional streams are present and/or admixed, said one or more additional streams, can be the same or may differ. For example, embodiments in which the first stream is UHT-treated, and the second stream is sterilised, or is ESL treated, are specifically contemplated, as are embodiments in which the first stream is sterilised, or is ESL treated, and the second stream is UHT-treated. Embodiments in which both streams are UHT-treated, or ESL treated, or sterilised, are also contemplated.

In one embodiment, one or more of the process streams is UHT treated, while another one or more of the process streams is treated at high temperature equivalent to that required to provide an ESL composition, that is, ESL-treated. In one particularly contemplated embodiment, one or more of the process streams comprising one or more proteins the biological activity or function of which is desirably maintained in the liquid nutritional composition is heat treated using a heat treatment step that minimises denaturation of said one or more proteins. For example, certain embodiments directed to the preparation of a liquid nutritional composition for which the retention of protein function is desired, for example a liquid nutritional composition comprising one or more proteins from the group comprising lactoferrin, lactalbumin, osteopontin, alpha-lactalbumin, and beta-lactoglobulin, conveniently employ a heat treatment in which the stream comprising said protein is heat treated in a heat treatment step equivalent to heating the stream to 140° C. for less than about 2.3 s. For example, in one embodiment, said stream is ESL-treated. In another embodiment, said stream is sterilised.

Observation of aseptic handling processes following heat treatment of the process streams means other established non-thermal sterilisation processes will not typically be used, certain embodiments of the methods contemplated herein will employ such non-thermal processes, such as microfiltration, in combination with heat treatment to inhibit microbiological activity in the final liquid nutritional composition.

Either or both the first stream and/or the second stream may be homogenised before, during, or after heating. Furthermore, the admixing of the first and second stream may itself be carried out under conditions sufficient to provide a homogeneous admixture.

When employed in the methods of preparing a nutritional composition as contemplated herein, homogenisation involves the application of shear forces to reduce droplet or particle size. For some embodiments high shear stirring, for example, in a homogeniser or high shear rotor-stator disperser is used. In certain embodiments the first stream, the second stream, or the liquid nutritional composition after admixture has an average particle size of less than 20 μm as characterised by the surface weighted average particle size parameter D[3,2] and/or the volume weighted mean diameter D[4,3], for example less than 10 μm, even for example less than 2 μm, or in certain embodiments less than 1 μm.

In one exemplary embodiment the composition is homogenised at 60° C. at 150/50 bar. In certain embodiments, for example of the liquid nutritional composition, the composition has after admixture a mean surface weighted particle size, D[3,2] and/or a volume weighted mean diameter D[4,3] of from about 0.3 μm to about 2 μm, or from about 0.5 μm to about 1.5 μm. For example, the composition has a mean particle size of about 1, 0.5, 0.4 or about 0.3 μm.

In one embodiment the heat-treated liquid nutritional composition is filled and packed.

In another embodiment the heat-treated liquid composition is dried. In one embodiment the heat-treated liquid composition is dried to produce a powder. Methods for drying such compositions are known in the art and suitable methods for use herein will be apparent to those skilled in the art. The low viscosity of the heat-treated liquid composition means that the composition may be evaporated to higher solids prior to spray drying without fouling resulting in better energy efficiency and higher throughput.

The heating systems used for UHT, ESL, and ultrapasturisation processing are generally functionally similar and comprise two major types, direct and indirect. In direct systems, heating occurs through direct contact between steam and the process stream/product, while in indirect systems the heat is transferred to the process stream/product from a heat source, such as steam or hot water through a barrier in a heat exchanger.

In most direct heating processes, the stream is first heated indirectly in a plate or tubular heat exchanger, typically to about 70 to 80° C., then heated to the required temperature by direct contact with steam. The stream is held at the required temperature for the required period of time to achieve the desired heat treatment. Two modes of steam heating are typically employed: steam injection, and steam infusion, also referred to in dairy processing as steam-into-milk, and milk-into-steam, respectively.

Indirect heating utilises plate or tubular heat exchangers for heating and cooling stages. Indirect systems can be very efficient (and thus, more economic), as a significant proportion of the heat can be recovered as the process stream is cooled and used to heat the incoming stream.

A distinction between direct heating methods and indirect heating methods is the rate of heating and cooling. Direct methods can readily achieve temperature increases in excess of 50° C. per second, while the rates of heating and cooling in the high-temperature sections of indirect systems are typically much slower.

Another process used to ensure sterility is retort heat treatment—often 120-130° C. for 10 to 20 minutes. Examples of such heat treatments can have F₀ values well in excess of the minimum threshold required for sterility. Other combinations of equivalent heat treatment are known and are applicable to embodiments contemplated herein, given appropriate adherence to the requirements of microbial stability and sterility.

While other known art non-thermal processes can be used in combination with heat treatment to inhibit microbiological activity in the nutritional composition, one advantage of particularly contemplated embodiments of the methods described herein is the preparation of heat treated, for example UHT-treated, compositions without the need for additional processing steps beyond said heat treatment and subsequent admixture, as set out in certain recited aspects herein.

It should be appreciated that the method employed for heat treating the first stream, the second stream, and in embodiment in which one or more additional streams are present and/or admixed, said one or more additional streams, can be the same or may differ. For example, embodiments in which the first stream is UHT-treated using direct UHT, and the second stream is treated using indirect UHT, are specifically contemplated, as are embodiments in which the first stream is UHT-treated using indirect UHT, and the second stream is treated using direct UHT. Representative embodiments in which both streams are heat treated using direct UHT, and in which both streams are heat treated using indirect UHT, are presented herein in the Examples.

It will be appreciated that the heat treatment is for microbial control, wherein the heat-treated nutritional composition produced by the methods described herein are sterile.

Exemplary heat treatments include heat treatment at least equivalent to 121° C. for 10 minutes, including for example heat treatment at least equivalent to 140° C. for 5 s.

In one exemplary embodiment, prior to packaging or consumption the liquid composition undergoes no heat treatment other than the heat treatment of step (a). In one exemplary embodiment, prior to packaging or consumption the liquid composition undergoes no further sterilisation. In one exemplary embodiment, prior to packaging or consumption no further ingredients are added to the liquid composition, such that its composition is unchanged.

In one embodiment, recovery of the liquid composition comprises or consists of aseptic handling, bottling, or packaging, or any combination thereof.

The methods provided herein produce nutritional compositions having desirable shelf stability and/or organoleptic properties. These include stable colour, wherein the colour of the composition does not change markedly over its shelf life. For example, in certain embodiments of the compositions contemplated herein comprising whey proteins, the whiteness index of the composition exhibits no more than a 10% reduction in whiteness (relative to its initial value) over its shelf life.

Shelf stability of liquid nutritional compositions as contemplated herein includes heat stability. For liquid nutritional compositions described herein, heat stability includes having no gelation or aggregation either directly after manufacture or after prolonged storage at temperatures of about 20° C., for example after at least about 28 days, or after about 2 months, after about 3 months, or after about 6 months or longer. Gelation of a liquid nutritional composition is considered to be a change in state from a liquid to a soft to firm solid. Gelation can be assessed visually and by touch. If the solution no longer flows following heating and/or storage, it is considered to have gelled.

Exemplary methods for assessing the heat stability of process streams, such as a dairy stream such as milk, are well known in the art, and include measuring the heat coagulation time (HCT) as described herein in the Examples.

Those skilled in the art on reading this disclosure will recognise that there is some flexibility in the relative proportion (for example, relative volume) of the first, second, and optionally any additional streams being admixed. A principal consideration when determining the relative proportions of the streams to be admixed is the desired makeup of the final composition to be produced. Additional considerations include, but are not limited to, the composition of a or each stream, the temperature of the stream or streams at admixture, the viscosity of a or each stream, and the like. Certain exemplary embodiments of first and second streams, such as first and second streams suitable for the preparation of RTF formulations (and particularly Stage 1 RTF formulations), and their relative proportions at admixture (that is, that proportion of the final composition derived from each stream), are presented in Table 7 below. As those skilled in the art will appreciate, various alternative compositions and proportions for each stream are contemplated and exemplified herein.

TABLE 7
Exemplary embodiments

| | Embodiment 1 | | Embodiment 2 | | Embodiment 3 | |
|---|---|---|---|---|---|---|
| | Stream 1 | Stream 2 | Stream 1 | Stream 2 | Stream 1 | Stream 2 |
| protein % w/w | 1.466 | 0.39 | 1.76 | 0.204 | 2.48 | 0.12 |
| fat % w/w | 4.02 | 0 | 4.8 | 0 | 6.8 | 0 |
| Lactose % w/w | 0.995 | 40 | 1.19 | 21 | 1.68 | 12.3 |
| Proportion of final composition | 84.6 | 15.4 | 70.7 | 29.3 | 50 | 50 |

In certain embodiments, the first stream comprises a fermented composition, for example a lactose-comprising composition fermented by one or more lactic acid bacteria.

In certain embodiments, the second stream comprises a fermented composition, for example a protein composition fermented by one or more lactic acid bacteria.

The invention further relates to a food or food product comprising, consisting essentially of, or consisting of a liquid nutritional composition of the present invention. Foods or food products of the invention for providing nutrition to a person in need thereof are specifically contemplated, as is the use of compositions as described herein in the preparation of a medicament, for example a medicament for use in the treatment of a condition or its symptoms or sequelae as contemplated herein.

Representative Uses of the Liquid Compositions, Including Therapeutic Methods and Uses

The invention also relates to a method of providing nutrition to a subject in need thereof, the method comprising the steps of administering to the subject a nutritional composition as described herein.

In various embodiments, the subject in need of nutrition may be suffering from or predisposed to a disease or condition, or may be undergoing or have undergone treatment for a disease or condition, is an elderly subject, a subject that is recovering from a disease or condition, or a subject that is malnourished. In other embodiments, the subject is healthy, such as a sportsperson or sporting animal, an active elderly subject, such as a subject having particular nutritional requirements.

In various embodiments the liquid nutritional composition is administered to a subject to maintain or increase muscle protein synthesis, maintain or increase muscle mass, prevent or reduce loss of muscle mass, maintain or increase growth, prevent or treat cachexia, increase satiation, reduce food intake, reduce calorie intake, improve glucose metabolism, increase rate of recovery following surgery or chemotherapy, increase rate of recovery following injury, increase rate of recovery following exercise, increase sports performance, and/or provide nutrition to said subject in need thereof.

A “subject” as used herein is an animal, usually a mammal, including a mammalian companion animal, or a human. Representative companion animals include feline, equine, and canine. Representative agricultural animals include bovine, ovine, caprine, cervine, and porcine.

It will be appreciated that the various methods of therapy contemplated herein will typically embody the administration of an effective amount of the nutritional composition.

An “effective amount” is an amount sufficient to effect beneficial or desired results including clinical results. An effective amount can be administered in one or more administrations by various routes of administration. The effective amount will vary depending on, among other factors, the disease or condition indicated, the severity of the disease or condition, the age and relative health of the subject, the potency of the agent administered, the mode of administration and the treatment desired. A person skilled in the art will be able to determine appropriate dosages having regard to these any other relevant factors.

Specifically-contemplated diseases, disorders, pathologies or conditions to be treated include those that would benefit from the provision of particular nutritional requirements, and/or the provision of one or more bioactive proteins, to the subject.

The term “treatment”, and related terms such as “treating” and “treat”, as used herein relates generally to treatment, of a human or a non-human subject, in which some desired therapeutic effect is achieved. The therapeutic effect may, for example, be inhibition, reduction, amelioration, halt, or prevention of a disease or condition.

Generally, the compositions contemplated herein are formulated to allow for administration to a subject by oral or enteral administration.

The liquid nutritional compositions described herein are in certain embodiments used in therapeutic methods, for example, in the treatment of one or more diseases, disorders, pathologies, or conditions in a subject in need thereof, or are used in treating or ameliorating one or more symptoms or sequelae of such diseases, disorders, pathologies or conditions or of one or more treatments thereof. For example, certain nutritional or nutraceutical formulations are contemplated for use in meeting the specific nutritional needs of subjects undergoing or who have undergone medical treatment, such as those who have undergone surgery, or who are undergoing or have undergone cancer therapy, including those who may be cachexic, those with a growth condition or who would benefit from regulated or defined nutritional intake.

Accordingly, in certain aspects the invention relates to a method of maintaining or increasing muscle protein synthesis, maintaining or increasing muscle mass, preventing or reducing loss of muscle mass, maintaining or increasing growth, venting or treating cachexia, increasing satiation, reducing food intake, reducing calorie intake, improving glucose metabolism, increasing rate of recovery following surgery or chemotherapy, increasing compliance, increasing rate of recovery following injury, increasing rate of recovery following exercise, increasing sports performance, and/or providing nutrition to a subject in need thereof, the method comprising the steps of administering to the subject a liquid nutritional composition described herein.

In another aspect the invention relates to the use of a liquid nutritional composition described herein in the preparation of a composition, for example a supplement or medicament, for maintaining or increasing muscle protein synthesis, maintaining or increasing muscle mass, preventing or reducing loss of muscle mass, maintaining or increasing growth, preventing or treating cachexia, increasing satiation, reducing food intake, reducing calorie intake, improving glucose metabolism, increasing rate of recovery following surgery or chemotherapy, increasing rate of recovery following injury, increasing rate of recovery following exercise, increasing sports performance, and/or providing nutrition to a subject in need thereof.

In still a further aspect the invention relates to a liquid nutritional composition described herein for maintaining or increasing muscle protein synthesis, maintaining or increasing muscle mass, preventing or reducing loss of muscle mass, maintaining or increasing growth, preventing or treating cachexia, increasing satiation, reducing food intake, reducing calorie intake, improving glucose metabolism, increasing rate of recovery following surgery or chemotherapy, increasing rate of recovery following injury, increasing rate of recovery following exercise, increasing sports performance, and/or providing nutrition to a subject in need thereof.

The invention is further described with reference to the following examples. It will be appreciated that the invention as claimed is not intended to be limited in any way by these examples.

### EXAMPLES

### Example 1: Methods

This example describes the plant, methods and materials utilised in the Examples presented below, with salient differences or adaptations specific to a particular example identified as applicable.

The small-scale pilot plant comprised an indirect tubular heater, operated at a flowrate of 1.6 L/min, with a pre-heat treatment of 85° C. and a product heat treatment to 142° C. and held for 4 s. The commercial scale pilot plant comprised an indirect heater, operated at a flowrate of 5.0±0.1 L/min, with a pre-heat treatment of 85° C. and a product heat treated to 142° C. and held for 4 s. The product was then cooled to 75° C. and homogenised at 250 bar. After the heat treatment, product was cooled to between 10 to 20° C. and packed using a laminar flow hood or aseptic filling system into 250 mL PET bottles. Representative methods as contemplated herein, which are collectively referred to in these Examples as ‘SSP’, ‘SSP processes’, and the like, generally comprised processing two streams, Stream 1 at pH 2.8-6.0, and Stream 2 at pH 6.9-7.7, with aseptic mixing post UHT and cooling. Particular SSP examples, in which one or more additional streams were used, are described below. The control samples were processed as a single stream at pH 6.8-7.3. Lactulose, furosine, lactoferrin and whey proteins determinations and compositional testing were carried out. pH was measured using standard techniques. Other characterisation tests were performed as follows.

### Heat Coagulation

Heat coagulation time is a common method for determination of heat stability of dairy beverages. The specific limits of heat stability depend on plant configuration including heat, holding times, plant design, heating type (direct, indirect, infusion) etc. Heat coagulation time was measured by observing the time before visible coagulation of a 2 mL sample when slowly rocked (10 second oscillation time) in sealed 15 mL test tubes in a 140° C. silicone oil bath. The results were measured in at least in duplicate, usually on the day or day after production, with samples refrigerated overnight and added to the oil bath at room temperature.

For SSP trials, Stream 2 was tested for heat coagulation time, whereas for the control trials, the whole composition was tested.

### Colour Measurement

Sample colour measurements were made using applicant's standard colorimeter method. A 10 mm deep petri dish was filled with sample, then placed on top of the colorimeter (D65 illuminant). A black light trap was then placed over the sample and measure until a concordant result was achieved. Results were measured in the L*a*b* colour space (L*—lightness—high value indicates white, a*—positive is red, negative is blue, b*—positive value is yellow (referred to in this report as yellowness), negative is green). Duplicate bottles were measured, with duplicate colour measurements recorded. Whiteness index (WI) is calculated as follows from Judd and Wysecki (1963):

WI=100−[(100−L*)²+(a*²+b*²)]^{0.5}

### Particle Size Distribution

Particle size was measured over shelf life using a Mastersizer 3000, using an obscuration of ˜5%, refractive index of 1.456 & absorption index of 0.001. Bottles were inverted twice before sample was removed and added to Hydro LV unit, where the sample was dispersed & diluted into RO water and measured via light diffraction. A single bottle was tested once at each time point, with the added sample measured five times per test. Four or more concordant replicates were indicative of high data quality (low residual, weighted residual), such that a measurement was accepted. Otherwise, measurements were repeated.

### Shear Viscosity Measurement

Shear viscosity was measured over shelf-life using a Kinexus Rheometer, using a cylinder geometry. Bottles were equilibrated to 20° C., inverted 5 times before sample was added into the loading cell. The viscosity was determined at an increasing shear rate from 0.05 s⁻¹ to 200 s⁻¹, measuring every 2.5 seconds. Viscosity was recorded at a shear rate of 100 s⁻¹ in this document. Bottles stored at 4, 25 and 40° C. were measured over shelf-life.

### Emulsion Stability Measurements

Emulsion stability was measured using three different methods—cream layer mass, sediment mass and particle size. Cream mass refers to the mass of residue cream on the top of a bottle, with bottles being measured in duplicate. Sediment mass refers to the mass of any residue left on the bottle of the bottle after the bottle is inverted and drained and the bottles were measured in duplicate. Particle size was measured using a Mastersizer 3000. The refractive index was set at 1.456, absorption index set at 0.001. All measurements were conducted at room temperature with five replicates.

### HPLC

HPLC measurement of proteins was carried out using two different columns, following the sample preparation and operating conditions included in Table 8. Sample preparation method depended on the type of sample being evaluated.

TABLE 8
HPLC method details

| Columns | PolymerXTM 5 μm RP-1 100 | BioZen 3.6 μm Intact XB-C8 200 |
|---|---|---|
| Column flowrate | 1 mL/min | 0.5 mL/min |

| | |
|---|---|
| Injection volume | 10 μL |
| Column temperature | 28° C. |
| UV detection | 214 nm and 280 nm |
| | (analysis at 280 nm) |
| Mobile phase A | 10% Acetonitrile |
| | 0.1% Trifluoroacetic acid |
| | MiliQ water |
| Mobile phase B | 90% Acetonitrile |
| | 0.1% Trifluoroacetic acid |
| | MiliQ water |
| Sample preparation Step 1- | Adjust to pH 4.6 |
| removal of casein and oil | 1M Sodium hydroxide or 0.5M Phosphoric acid. |
| (milk samples only) | Centrifuge at 4000 rpm for 20 minutes |
| Step 2 - Whey protein sample | Adjust to pH 6.9 |
| prep | 1M Sodium hydroxide or 0.5M Phosphoric acid. |
| | Centrifuge at 4000 rpm for 20 minutes |
| Step 2 - Lactoferrin | Adjust to pH 8.6 |
| measurement | 1M Sodium hydroxide or 0.5M Phosphoric acid. |
| | Centrifuge at 4000 rpm for 20 minutes |
| Step 3 - dilution and filtering | Samples are diluted 0.02-0.1% protein with MiliQ water filtered |
| prior to sample loading | through a 0.22 μm filter |

### Sensory

Samples were evaluated by a sensory panel (n=5) over shelf life after being stored at 4° C. & 25° C. Participants were asked to describe the sensory attributes of each sample and look for any concerning sensory defects. Samples were equilibrated to room temperature and consumed at room temperature; water was provided to cleanse the palate between samples.

### Iron Binding

Samples were adjusted to pH 6.9 with 0.1 mol/L sodium hydroxide and then diluted with water to 1 wt % lactoferrin, Samples were inoculated with 200 μL solution of 0.5 wt % ferric chloride, and 200 μL solution of 1 wt % sodium bicarbonate. Blanks were prepared identically but had 400 μL of water added instead of ferric chloride and sodium bicarbonate. Samples were then filtered through a 0.45 μm nylon filter. Absorbance at 465 nm was measured using a spectrophotometer (Thermo Scientific Evolution 201 UV-Visible, path length 10 mm). Samples were measured at 20° C. on the day of inoculation. Percentage Iron Binding Retention was calculated using 465 nm absorbances as follows:

$$\% Iron Binding Retention = \frac{\begin{matrix}Post UHT Inoculated - \\ Post UHT Blank\end{matrix}}{\begin{matrix}Pre UHT Inoculated - \\ Pre UHT Blank\end{matrix}} * 100$$

### Example 2: RTF Stage 1

This example presents trials carried out to investigate the production of a Ready to Feed (RTF) Stage 1 nutritional composition using representative methods as described in Example 1. A representative RTF infant formula composition as set out in Table 9 below was used in these trials. The technical details for these trials are included in Table, and Table 11 lists the number of trials carried out for each type of formulation. SSP was heat treated in two streams, Stream 1 at pH 3.0-6.0 and Stream 2 at pH 6.9-7.7, and these streams were mixed aseptically post UHT and cooling. The control sample in each case was processed as a single stream at pH 6.9-7.3. The SSP trials split the acid stream components into 29-30 wt % of the total mass of the final composition, meaning lactose was processed 20-21 wt % and lactoferrin was processed at 200 mg/100 mL.

TABLE 9
Target composition of a RTF Stage 1 formulation.

| | Quantity in Stage 1 | | |
|---|---|---|---|
| Nutrient | formulation per 100 g | Unit | Ingredient sources |
| Whey | 0.8 | g | WPC 80, Low fat milk, lactoferrin |
| Casein | 0.5 | g | Low fat milk |
| Fat | 3.4 | g | Sunflower oil |
| Lactose | 7.0 | g | Low fat milk, Lactose powder |
| Lactoferrin | 0.06 | g | Lactoferrin powder |
| Iron | 0.54 | mg | Iron sulphate |
| Zinc | 0.5 | mg | Zinc sulphate |
| Vitamin A* | 58 | μg | Vitamin A Acetate |
| Vitamin D3* | 1.6 | μg | Cholecalciferol |
| Vitamin B1* | 0.06 | mg | Thiamine HCl |
| Vitamin B2* | 0.11 | mg | Riboflavin |
| Vitamin B9* | 13 | μg | Folic acid |
| Vitamin C** | 10.5 | mg | Ascorbic acid, Sodium Ascorbate |
| Mixed tocopherols | 14.7 | mg | Mixed tocopherol syrup |
| GOS | 0.43 | g | GOS powder 66% |
| FOS | 0.08 | g | FOS powder |
| 2-fucosyllactose (2-FL) | 0.1 | g | 2-FL powder |
| Lacto-N-neotetraose | 0.05 | g | LNnT powder |
| (LNnT) | | | |
| Sodium | 24 | mg | Sodium ascorbate, trisodium Citrate |
| Potassium | 88 | mg | Di potassium phosphate, potassium |
| | | | hydroxide |
| Chloride | 54 | mg | Choline chloride, Calcium chloride, |
| | | | Magnesium chloride |
| Calcium | 42 | mg | Calcium carbonate, calcium chloride |
| Phosphorus | 34 | mg | Di potassium phosphate |
| Phosphate | 104 | mg | Di potassium phosphate |
| Magnesium | 5.3 | mg | Magnesium chloride |
| Copper | 52 | μg | Cupric sulfate |
| Vitamin E* | 1.1 | mg | Vitamin E Acetate |
| Vitamin K1* | 41 | μg | Vitamin K1 5% |
| Vitamin B3* | 0.43 | mg | Niacinmide |
| Vitamin B5* | 0.54 | mg | Calcium D-Pantothenate |
| Vitamin B6* | 0.05 | mg | Pyridoxine Hydrochloride |
| Vitamin B7* | 1.8 | μg | Biotin |
| Vitamin B12* | 0.17 | μg | Cyanocobalamin |
| Choline | 22 | mg | Choline chloride |
| Phospholipid | 15 | mg | Milk phospholipid concentrate |
| Inositol | 7 | mg | Inositol powder |
| L-carnitine | 2.1 | mg | L-carnitine powder |
| Taurine | 5.4 | mg | Taurine powder |
| Nucleotides | 2.3 | mg | Nuceotide Premix |
| MFGM | 15 | mg | Milk phospholipid concentrate |

*The quantities for Vitamins A, D3, E, K1, B1, B2, B3, B5, B6, B7, B9, B12 does not include the 33% overage.
**The quantity for Vitamin C does not include the 100% overage.

TABLE 10
Small Commercial Plant Trials Technical Details

| | | | | Single | Stream 1 | Stream 2 |
|---|---|---|---|---|---|---|
| | Protein | Carbohydrate | Macros | stream | may | may |
| Product | Sources | sources | Composition | control | contain | contain |
| Model | Low fat | Lactose | 0.8% Whey | pH - 7.3 | pH 3-4 | pH 7.38-7.7 |
| Stage 1 | Milk, | | 0.5% | Low fat milk, | Lactose, | Low fat milk, WPC |
| (S1) RTF | WPC 80 | | Casein | WPC 80, | Lactoferrin, WPC | 80, Sunflower oil, |
| infant | | | 3.4% Fat | Lactose, | 80, Vit B1, B2, | Fe, Zn, Vit A, D3, |
| formula | | | 7% Lactose | Lactoferrin, | C | B9, Mixed |
| | | | | Sunflower oil, | Fe, Zn, | Tocopherols, |
| | | | | Fe, Zn, Vit B1, | Phosphoric Acid | Sodium ascorbate, |
| | | | | B2, B9, A, C, | | Sodium Hydroxide |
| | | | | D3, Mixed | | |
| | | | | Tocopherols | | |
| Complete | Low fat | Lactose | 0.8% Whey | pH 6.9 | pH 3.5-6 | pH 6.9-7.6 |
| Stage 1 | Milk, WPC | | 0.5% | Low fat milk, | Lactose, | Low fat milk, |
| (S1) RTF | 80 | | Casein | WPC 80, | Lactoferrin, | Sunflower oil, |
| infant | | | 3.4% Fat | Lactose, | GOS, Fe, Zn, | WPC, Choline, Cu, |
| formula | | | 7% Lactose | Lactoferrin, | WPC, Vit B1, | Ca, Na, K, Vit A, |
| | | | | GOS, Fe, Cu, | B2, C, Mg, HMO, | D3, K, E, FOS, |
| | | | | Zn, Mg, HMO, | Inositol, | MFGM, B3, B5, B6, |
| | | | | Choline, Ca, | Phosphoric Acid | B7, B9, B12, Mixed |
| | | | | Na, K, FOS, | | Tocopherols, |
| | | | | MFGM, Vit A, | | Sodium ascorbate, |
| | | | | D3, K, E, C, | | L-Carnitine, |
| | | | | B1, B2, B3, | | Taurine, |
| | | | | B5, B6, B7, | | Nucleotides, |
| | | | | B9, B12, | | Potassium |
| | | | | Mixed | | Hydroxide |
| | | | | Tocopherols, | | |
| | | | | Inositol, L- | | |
| | | | | Carnitine, | | |
| | | | | Taurine, | | |
| | | | | Nucleotides | | |

TABLE 11
List of RTF Stage 1 trials

| Trial name | Number of trials |
|---|---|
| RTF Stage 1 Control | 5 |
| RTF Stage 1 SSP model formulation | 9 |
| RTF Stage 1 complete formulation control | 1 |
| RTF Stage 1 SSP complete formulation | 3 |

### Results and Discussion

### Processing Observations & Data

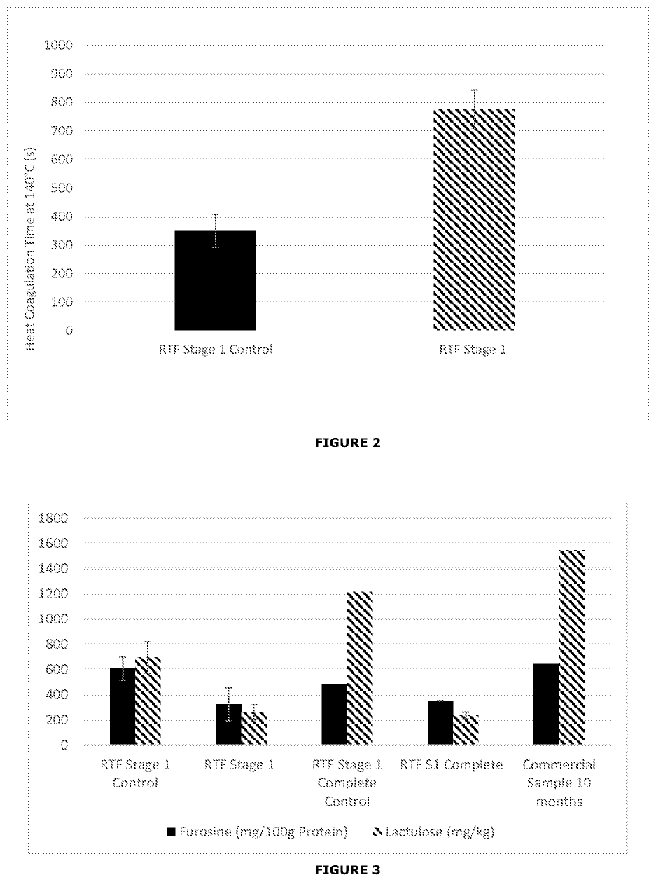

All trials were processed through the UHT plant and products were collected aseptically. Significant fouling was observed when processing RTF using the control, single stream, process. This was evident in the UHT temperature and pressure logs, which showed clear signs the product was adhering to pipe surfaces, causing temperatures & pressures to spike and fluctuate. These observations were supported by heat coagulation data. As can be seen in FIG. 2, products produced by the representative SSP methods utilised here exhibited substantially longer heat coagulation times than control samples. Without wishing to be bound by any theory, applicants believe that this may in part be due to the SSP formulations' higher processing pH stabilising casein micelles or other proteins by enhancing the electrostatic repulsion between micelles or protein particles and maintaining the mineral balance during heating. After processing, SSP samples showed the product benefits including reduced Maillard reaction (product colour & whiteness) and furosine level compared with standard single stream processing and the presence of >40% of undenatured lactoferrin.

Maillard Reaction

This example presents the results establishing the minimization of Maillard reaction and attendant Maillard products in the SSP processes. The concentration of Maillard indicators furosine and lactulose, and the lactulose:furosine ratio, was determined for each of the SSP trials and the conventionally processed control. FIG. 3 presents the lactulose and furosine results at initial shelf life for all trials, compared to a commercially available comparator product. The SSP process maintained similar furosine levels as observed in the SSP streams pre-UHT and the lactulose level only increased to a limited extent compared to the conventionally produced control sample. The RTF Stage 1 Complete samples covered the range of pH from 3.0-6.0. Notably, the conventionally produced control samples had considerably higher levels of furosine and lactulose after heating. The reduction in Maillard reaction products was observed at a range of different Stream 2 lactose concentrations. This data was repeatable across the different SSP formulations.

These results strongly indicate that the methods contemplated herein (exemplified in these trials by the SSP process) reduced the Maillard reaction during heat treatment when compared to a conventional process. Furosine levels have significant nutritional relevance as a measure of protein quality. Furosine is reportedly derived from Amadori products and has been used to quantify ‘blocked’ lysine which is not nutritionally available as a lysine source for higher organisms (Erbersdobler, H., & Somoza, V. 2007).

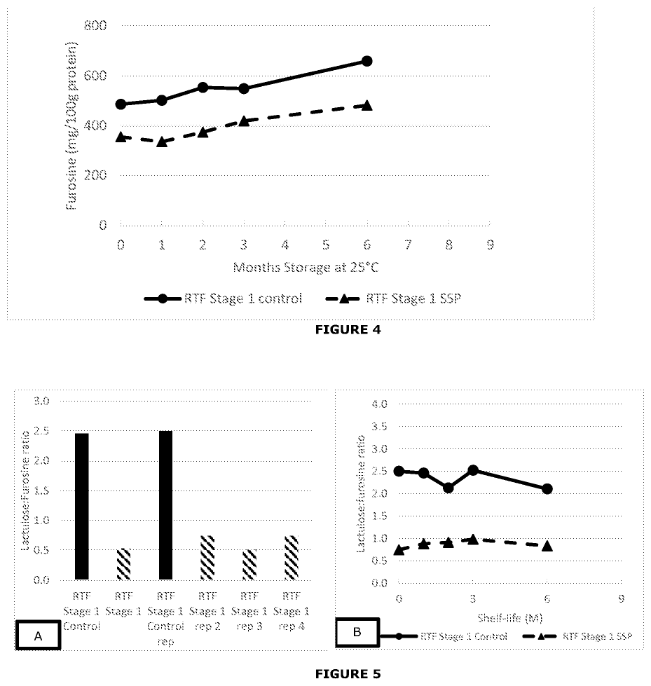

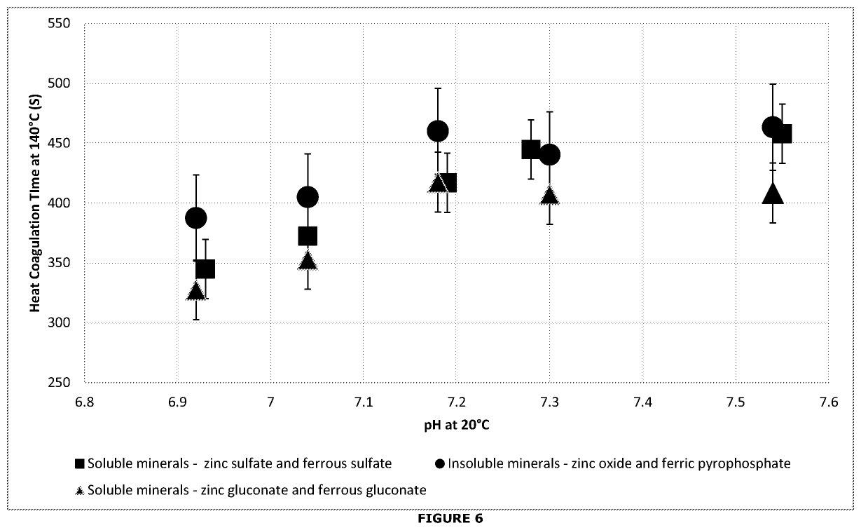

Measuring Maillard indicators over 6 months' storage at 25° C. showed that the relative difference in furosine content (FIG. 4) between SSP products and the control products remained constant over shelf life.

As can be seen in FIGS. 5a and 5b, the lactulose:furosine ratio for all SSP samples was lower than that of conventionally processed control samples. The lactulose:furosine ratio for all SSP samples remained low over shelf life. This indicates that the exemplary SSP processes described in this, and previous examples provide nutritional compositions having substantially improved protein availability and protein quality compared to conventional processes, and enable processing of liquid nutritional compositions in which the production of furosine and the conversion of lactose to lactulose are both reduced.

### Lactoferrin Stability

This example presents the results of trials establishing improved protein stability (in this case, lactoferrin stability) in products of the representative SSP processes compared to products prepared using conventional processing.

Error! Reference source not found. shows the collated results of lactoferrin survival from a range of RTF SSP trials compared to the control as measured by RP-HPLC. For the SSP samples, these measurements were made for both Stream 1 (in which the lactoferrin was present prior to admixture) and final product streams. The pH of Stream 1 varied from 3.0-6.0.

As can be seen in Table 12, irrespective of formulation or pH, more native lactoferrin survived UHT treatment using the exemplary SSP processes than survived in an equivalent UHT treatment using conventional processing. It is also noted that this advantage of lactoferrin survival for SSP was also observed beyond model formulations. This lactoferrin survival benefit was also demonstrated in complete Stage 1 RTF infant formula compositions.

TABLE 12
Estimated lactoferrin survival over UHT based
on native lactoferrin quantification by RP-HPLC

| | % Lactoferrin | % Lactoferrin |
|---|---|---|
| | Survival in | Survival in |
| Process | Stream 1 | product stream |
| Conventionally processed control | N/A | 0% |
| RTF Stage 1 SSP Trials model | 40-95% | |
| formulations (pH 3-4) | | |
| RTF Stage 1 SSP Complete | 40% | 29% |
| formulations (pH 3.5) | | |
| RTF Stage 1 SSP Complete | 44-69% | |
| formulations (pH 5-6) | | |

Some differences in the magnitude of the survival benefit were observed. This is believed to predominantly be a result of the analytical methods employed, the compositional characteristics of the samples being analysed, and the interaction between sample composition and the analytical method employed. However, in all cases, samples prepared using the conventional process showed no detectable native lactoferrin left after UHT treatment.

In comparison, using the SSP process, >40% of the lactoferrin was still in a native conformation after processing as measured by RP-HPLC. As shown in Table 12, the proportion of lactoferrin present in its native conformation was dependent on formulation and processing conditions.

It will be appreciated that this high level of survival of native lactoferrin has significant implications for the preparation of nutritional compositions comprising functionally active proteins as contemplated herein, and nutritional compositions comprising other biologically relevant ingredients that have previously been challenging to formulate in UHT treated RTF formulations and other compositions as contemplated herein.

### Protein Stability

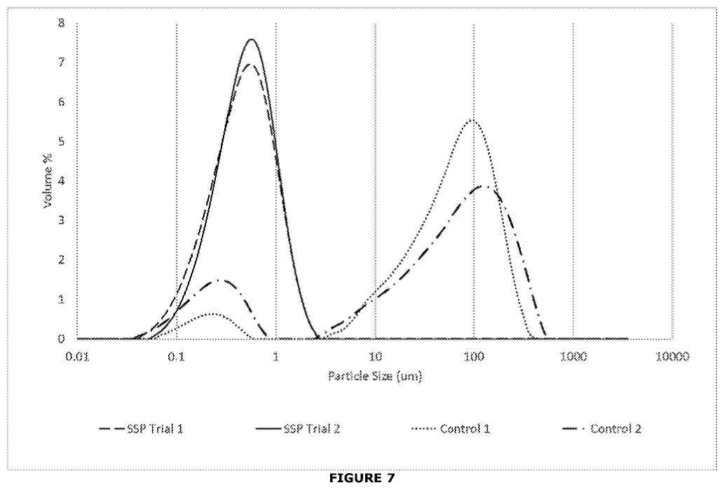

This example investigated certain characteristics of the UHT-treated samples associated with a potential impact on shelf life, in this case, the average particle size and particle size distribution of products produced by the exemplary SSP process and those prepared by conventional production methods. It is desirable to use soluble salts when fortifying infant formula as these salts have a higher bioavailability. However, these soluble salts affect the processability of the formulation, so insoluble forms of mineral salts are frequently used by infant formula manufacturers. As described herein, using SSP processing, the applicants were able to use soluble salts (e.g. zinc sulfate and ferrous sulfate) to fortify the infant formula base. As can be seen in FIG. 7, samples comprising these soluble salts produced by SSP clearly demonstrated the suitability of the methods described herein to prepare liquid nutritional compositions comprising soluble salts for mineral fortification without adversely affecting the stability and processability of the composition. Both the small particle size, and the particle size distribution, observed with products prepared using the SSP process are indicative of excellent protein stability.

In contrast, in the conventional process protein instability was observed, as evidenced by the increased protein aggregation responsible for increased average particle size, decreased heat coagulation time sedimentation in final product (data not shown), and plant fouling. Notably, the SSP process appears to have a stability advantage over conventional processing even when destabilising ingredients are used in the former. Indeed, insoluble salts (e.g. zinc oxide and ferric pyrophosphate) needed to be used to fortify the infant formula base for standard processing to provide sufficient heat stability to allow processing using conventional methods.

### Emulsion Stability

This example investigated certain characteristics of the UHT-treated samples associated with a potential impact on shelf life, in this case, the emulsion stability of products produced by the exemplary SSP process and control products prepared by conventional methods. The final product bottles produced have been observed over shelf life to record product performance over time. The shelf stability of SSP is comparable to the control over 9 months storage at 25° C. as indicated by sedimentation data.

The differences in particle size and particle size distribution between the compositions produced by the SSP process and those prepared using conventional technology immediately after manufacture can readily be seen in FIG. 7. Substantially larger particles were observed in samples prepared using the conventional process compared to the particles present in samples produced by the SSP process. Indeed, essentially all of the particles present in the SSP products were below ˜10 μm, whereas a very substantial proportion of the particles present in the control samples prepared by conventional methods were greater than ˜10 um, as can readily be seen in FIG. 7.

### Colour Stability

Colour was measured via applicant's standard colorimeter method (see Example 1 above).

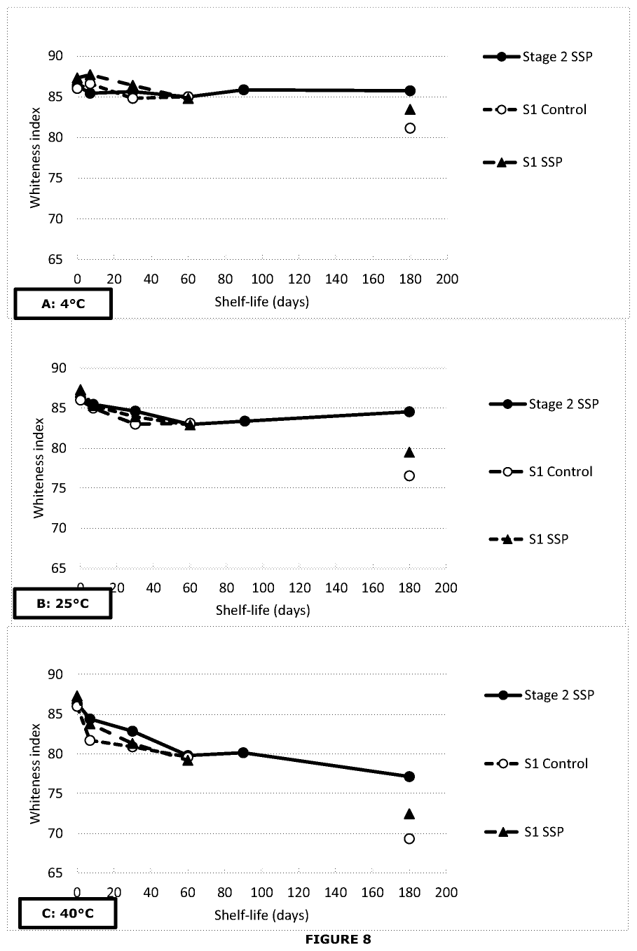

FIG. 8 shows the whiteness data of samples stored up to 180 days at 4° C. (FIG. 8A), at 25° C. (FIG. 8B), and at 40° C. (FIG. 8C) after production. This data shows that the colour benefit provided by SSP as determined by this colorimetric method is initially small, but is clearly apparent and increases markedly over continued storage. Notably, colour difference between SSP samples and control samples was observed by eye at both Day 0 and after storage. In both trial sets, the control product was visibly browner than SSP samples. Without wishing to be bound by any theory, applicants believe that this is likely a combination of Maillard browning, and the larger particle size present in the control samples refracting less light and causing the emulsion to appear darker. The colourimetric data concords with the observed colour results.

Measuring colour over shelf life using the accelerated test at 40° C. shows the control samples were brown at Day 0 and were brownest over shelf life. In contrast, the samples produced using the SSP process, exhibited a reduced decrease in whiteness index (i.e., became less brown) over storage, particularly at 25° C. (FIG. 8B) and at 40° C., compared to control samples.

### Sensory

No obvious sensory difference between the conventionally produced control samples and SSP products was observed.

### Example 3: RTF Stage 1 Alternatives

This example presents trials carried out to investigate the production of a Ready to Feed (RTF) Stage 1 nutritional composition using representative SSP methods as described in Example 1. A representative RTF infant formula composition as set out in Table 13 below and Table 14 identifies the varying composition of the first, second and third streams used in the different SSP trials and the composition of the single stream used in the control process. In this example, SSP product was generally processed in two streams, Stream 1 at pH 3.0-4.0 and Stream 2 at pH 7.4-7.6 and mixed aseptically post UHT and cooling. The control sample was processed as a single stream at pH 6.9. As shown in Table 14, in one SSP trial a third stream was heat treated, cooled to 75° C. and homogenised at 50 bar prior to admixture with the first and second streams, followed by the final packing step.

In one trial, Stream 1 was fermented using a dosage of 0.1-0.5 U/kg of cultures (Lactobacillus bulgaricus and Streptococcus thermophilus) and the pH reduced over 8 hours incubation at 42.5° C. from pH 6.0 to pH 4.0. This may then be optionally further pH adjusted to pH 3.0. In one trial a complete formulation for stage 1 RTF infant formula, which included a range of vitamins and minerals as well as key nutrients such as GOS, FOS, Inositol, Choline, HMO, MFGM, L-Carnitine, Taurine and Nucleotides, was processed in a representative example of a triple stream SSP process.

The SSP trials exemplified in this example provided the acid stream (stream 1) components as 10 wt % to 30 wt % of the total mass of the final product, meaning lactose was processed 21-31 wt % and lactoferrin was processed at 200-600 mg/100 mL.

TABLE 13
Target composition of RTF formulations.

| | Quantity | | |
|---|---|---|---|
| | in stage 1 | | |
| | formulation | | |
| Nutrient | per 100 g | Unit | Ingredient sources |
| Protein | 1.3 | g | WPC 80, Low fat milk, |
| | | | Lactoferrin, |
| | | | Soy Protein Isolate |
| Fat | 3.4 | g | Sunflower oil |
| Carbohydrate | 7.0 | g | Low fat milk, |
| | | | Lactose powder, |
| | | | Fructose powder |
| Lactoferrin | 0.06 | g | Lactoferrin powder |
| Iron | 0.54 | mg | Iron sulphate |
| Zinc | 0.5 | mg | Zinc sulphate |
| Vitamin A* | 58 | μg | Vitamin A Acetate |
| Vitamin D3* | 1.6 | μg | Cholecalciferol |
| Vitamin B1* | 0.06 | mg | Thiamine HCl |
| Vitamin B2* | 0.11 | mg | Riboflavin |
| Vitamin B9* | 13 | μg | Folic acid |
| Vitamin C** | 10.5 | mg | Ascorbic acid, |
| | | | Sodium Ascorbate |
| Mixed tocopherols | 14.7 | mg | Mixed tocopherol syrup |

*The quantities for Vitamins A, D3, B1, B2, B9 do not include the 33% overage.
**The quantity for Vitamin C do not include the 100% overage.

TABLE 14
List of trials for RTF Stage 1 alternatives

| | | Protein | Stream 1 | Stream 2 | Stream 3 |
|---|---|---|---|---|---|
| | Carbohydrate | source | may | may | may |
| Trial name | source used | used | contain | contain | contain |
| RTF Stage 1 | Lactose | Low fat Milk, | pH 6.9 | | |
| Control | | WPC 80, | Low fat milk, WPC | | |
| (n = 2) | | | 80, Lactose, | | |
| | | | Lactoferrin, | | |
| | | | Sunflower Oil | | |
| | | | Fe, Zn, Vit B1, | | |
| | | | B2, B9, A, C, D3, | | |
| | | | Mixed | | |
| | | | Tocopherols | | |
| RTF Stage 1 | Lactose | Low fat Milk, | pH 3-5 | ~pH 7.5 | |
| SSP model | | WPC 80, | Lactose, | Low fat milk, WPC 80, | |
| formulation | | | Lactoferrin, WPC | Sunflower Oil, Fe, Zn, | |
| | | | 80, Vit B1, B2, C, | Vitamins A, D3, B9, | |
| | | | Fe, Zn, | Mixed Tocopherols, | |
| | | | Phosphoric Acid | Sodium Ascorbate, | |
| | | | | Sodium Hydroxide | |
| RTF Stage 1 | Lactose | Low fat Milk, | pH 3-5 | ~pH 7.5 | |
| SSP fermented | | WPC 80, | Lactose, | Low fat milk, WPC 80, | |
| formulation | | | Lactoferrin, WPC | Sunflower Oil, Fe, Zn, | |
| | | | 80, Vit B1, B2, C | Vitamins A, D3, B9, | |
| | | | Fe, Zn, Cultures | Mixed Tocopherols, | |
| | | | | Sodium Ascorbate, | |
| | | | | Sodium Hydroxide | |
| RTF Stage 1 | Fructose | Low fat Milk, | pH 3-5 | ~pH 7.5 | |
| SSP fructose | | WPC 80, | Lactose, WPC 80, | Low fat milk, WPC 80, | |
| formulation | | | Vit B1, B2, C | Sunflower Oil, Fe, Zn, | |
| | | | Fe, Zn, | Vitamins A, D3, B9, | |
| | | | Phosphoric Acid | Mixed Tocopherols, | |
| | | | or | Sodium Ascorbate, | |
| | | | Cultures | Sodium Hydroxide | |
| RTF Stage 1 | Fructose | Soy Protein | pH 3-5 | ~pH 7.5 | |
| SSP SPI + | | Isolate | Fructose, WPC | Soy Protein Isolate, | |
| fructose | | | 80, Vit B1, B2, C | Sunflower Oil, Fe, Zn, | |
| formulation | | | Fe, Zn, | Vit A, D3, B9, Mixed | |
| | | | Phosphoric Acid | Tocopherols, Sodium | |
| | | | | Ascorbate, Sodium | |
| | | | | Hydroxide | |
| RTF Stage 1 | Lactose | Low fat Milk, | pH 3.5 | pH 7.5 | pH 4 |
| Triple stream | | WPC 80 | 30.5% Lactose, | Low fat milk, WPC 80, | Lactoferrin |
| | | | 0.3% WPC 80, | Sunflower Oil, FOS, | |
| | | | GOS, HMO, | Choline, Vitamin A, D3, | |
| | | | Inositol; Vitamins | E, K1, B3, B5, B6, B7, | |
| | | | B1, B2, C; Fe, Zn, | B9, B12, Sodium | |
| | | | Mg | Ascorbate, Trisodium | |
| | | | | Citrate, Mixed | |
| | | | | Tocopherols, L- | |
| | | | | carnitine, Taurine, | |
| | | | | Nucleotides, Calcium | |
| | | | | chloride, Di potassium | |
| | | | | phosphate, Copper | |
| | | | | sulphate | |

### Results and Discussion

### Processing Observations & Data

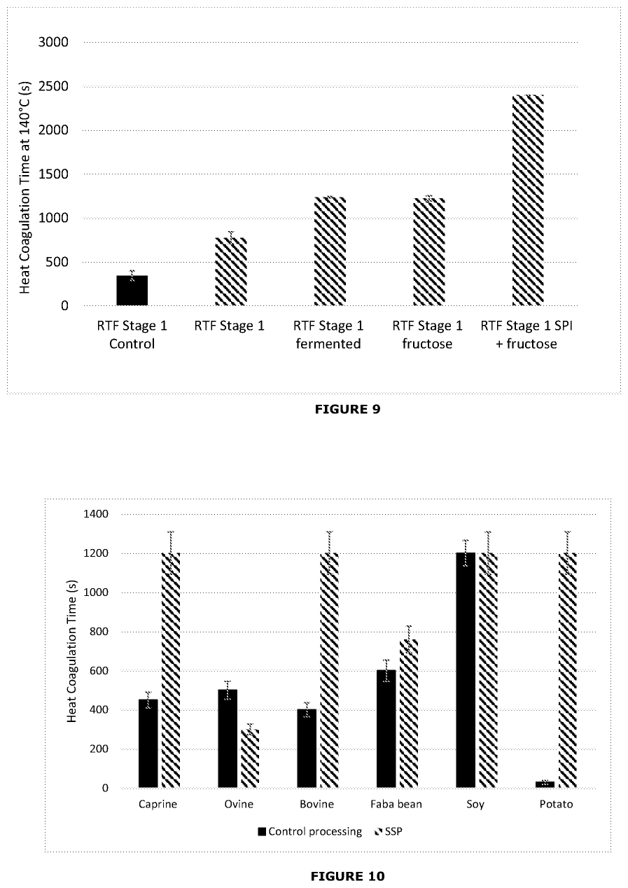

All streams were UHT sterilised prior to admixture to form the final compositions. As can be seen from FIGS. 9 and 10, the product benefits associated with longer heat coagulation times were achieved in SSP compositions comprising non-dairy protein and sugar sources, as was observed here and in previous examples herein for SSP compositions comprising bovine dairy proteins and/or sugars. As shown in FIG. 9, very long coagulation times were observed when the SSP formulation included a non-dairy protein source (soy protein isolate, SPI) and non-dairy sugar source (fructose). As for the trials utilising bovine milk and soy protein isolate to formulate the RTF SSP formulations shown in FIG. 9, the representative SSP processes using other animal milks and plant-based milks (as set forth in Table 15 below) also produced products having comparably long heat coagulation times, as shown in FIG. 10. These data, together with the compositional and processing flexibility established here by the use of alternative milk sources, including milk sources having very different solids content and protein concentrations/composition as shown in Table 15, strongly support the utility of the SSP processes exemplified herein in producing a variety of nutritional compositions.

TABLE 15
List of alternative milk sources and compositions

| | Solids | Protein |
|---|---|---|
| Milk sources | Concentration [%] | Concentration [%] |
| Bovine | 13.3 | 3.8 |
| Caprine | 13 | 3.6 |
| Ovine | 14.4 | 4.7 |
| Faba bean (from powder) | 7.1 | 6 |
| Soybean (from powder) | 2.9 | 2.6 |
| Potato (from powder) | 2.5 | 2.4 |

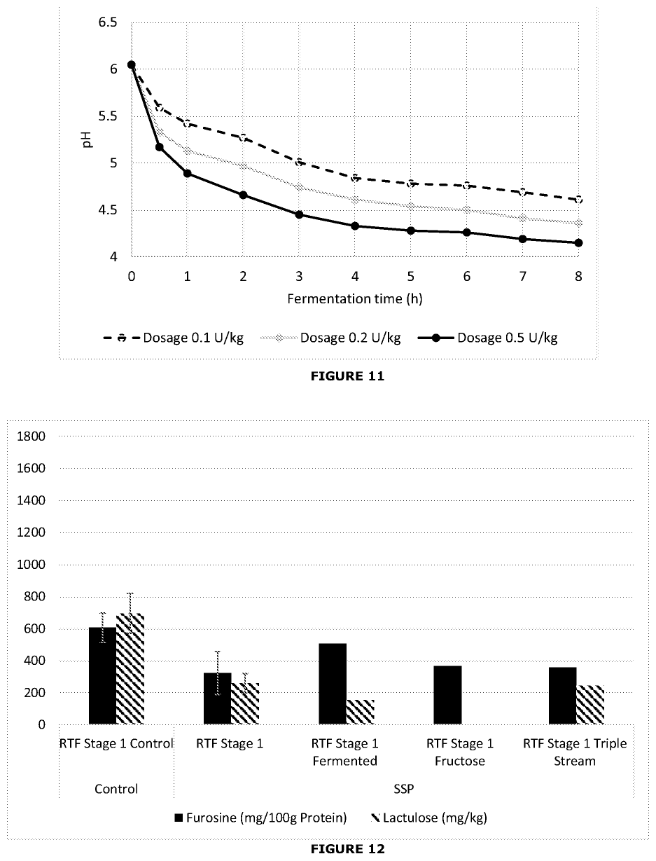

Fermentation of Stream 1 (21 wt % lactose stream) resulted in a pH reduction over incubation time, and the degree of acidification was able to be controlled by varying the initial dosage of cultures (see FIG. 11). This stream was then UHT treated with no processing issues or increase in viscosity as a result of fermentation and combined with Stream 2. After processing, SSP samples showed the similar product benefits as other SSP trials including reduced Maillard reaction (product colour & whiteness) and furosine level compared with standard single stream processing. Notably, the SSP product resulting from this fermentation trial exhibited excellent protein survival, with >83% of lactoferrin remaining undenatured.

### Maillard Reaction

This example presents the results establishing the minimization of the Maillard reaction and the reduction in Maillard products in the SSP processes. The concentration of Maillard indicators furosine and lactulose was determined for each of the SSP trials and the conventionally processed control. Furosine concentration is presented as mg Furosine per 100 g of protein present, and lactulose concentration is presented as mg lactulose per kg of final composition.

FIG. 12 presents the lactulose and furosine concentrations observed in the various RTF formulations after production. As can be seen in FIG. 12, each of the SSP products had lower furosine concentration than that present in the control samples, and this advantage of lower furosine levels with SSP was observed when the SSP method used fermentation to acidify Stream 1, used a non-dairy sugar source (fructose), or comprised admixture of more than 2 streams (see FIG. 12, RTF Stage 1 Fermented, RTF Stage 1 Fructose, and RTF Stage 1 Triple stream, respectively). Notably, the conventionally-produced control samples had considerably higher levels of lactulose as well as furosine after heating. These results indicate that the methods contemplated herein (exemplified in these trials by the SSP process) reduced the Maillard reaction during heat treatment when compared to a conventional process.

This indicates that the exemplary SSP processes described in this, and previous examples provide nutritional compositions having substantially improved protein availability and protein quality compared to conventional processes, and enable processing and production of liquid nutritional compositions in which lactose to lactulose conversion is reduced.

### Lactoferrin Stability

The lactoferrin content of the fermented and triple stream SSP products was tested using RP-HPLC. Table 16 shows lactoferrin survival in Stream 1 where the pH of the acidic lactoferrin-containing stream used in the respective SSP process was pH 4.0. As can be seen in Table 16, the benefit of the SSP process to lactoferrin survival observed in the previous examples was also observed when Stream 1 was fermented and when more than two streams were used.

TABLE 16
Estimated lactoferrin survival over UHT based
on native lactoferrin quantification by RP-HPLC

| | % Lactoferrin Survival |
|---|---|
| Process | in Stream 1 |
| RTF Stage 1 SSP fermented | 83.7% |
| RTF Stage 1 SSP Triple Stream | 73.0% |

It will be appreciated that this high level of survival of native lactoferrin has significant implications for the preparation of nutritional compositions comprising functionally-active proteins as contemplated herein.

### Emulsion Stability

This example investigated certain characteristics of the UHT-treated samples associated with a potential impact on shelf life, in this case, the emulsion stability of products produced by the exemplary SSP process and those prepared by conventional control methods. The final product bottles produced were observed over shelf life to record product performance over time. The shelf stability of SSP was comparable to the control over 1 month storage at 25° C. as assessed by sedimentation data (data not shown).

### Colour

Colour was measured via the applicant's standard colorimeter method (see Example 1 above). Table 17 below lists the whiteness index after UHT treatment for various RTF Stage 1 products. This data shows that the colour of products manufactured using SSP processing is comparable irrespective of whether dairy proteins, dairy sugar, non-dairy protein sources (e.g., soy protein isolate), or non-dairy sugar sources (e.g., fructose) are used, or when the SSP process utilizes more than two streams.

TABLE 17
Whiteness index after UHT heat treatment.

| | Whiteness index after UHT heat |
|---|---|
| Sample | treatment |
| RTF Model Stage 1 SSP | 87.1 |
| RTF Model Stage 1 SSP fermented | 87.1 |
| formulation | |
| RTF Stage 1 SSP fructose and Soy | 86.3 |
| Protein Isolate | |
| RTF Stage 1 SSP fructose and milk | 86.3 |
| RTF Complete Stage 1 SSP Triple | 86.3 |
| stream | |

### Example 4: RTF Stage 2 & Stage 4

This example presents two trials carried out to investigate the production of a Ready to Feed (RTF) Stage 2 nutritional composition and an RTF Stage 4 nutritional composition using representative SSP methods as described in Example 1. The compositions of the representative RTF infant formulations used in these trials are set out in Table 18 below, and related details of these trials are outlined in Table 19.

SSP was processed in two streams, Stream 1 at pH 3.5-4.1 and Stream 2 at pH 6.9-7.5 and mixed aseptically post UHT and cooling. The control sample was processed as a single stream at pH 6.9. The SSP trials split the acid stream components into 15 wt % to 27 wt % of the total mass, meaning lactose was processed 21-22 wt % and lactoferrin was processed at 220-400 mg/100 mL.

TABLE 18
Target composition of RTF formulations.

| | Quantity in | | | | |
|---|---|---|---|---|---|
| | Stage 2 | Quantity in Stage 4 | Quantity in Stage 4 | | |
| | formulation | formulation per 100 g - | formulation per 100 g - | | |
| Nutrient | per 100 g | Casein: whey at 80:20 | Casein: whey at 70:30 | Unit | Ingredient sources |
| Whey | 1.2 | 0.8 | 1.2 | g | WPC 80, Low fat or Protein- |
| | | | | | enriched low fat milk, |
| | | | | | lactoferrin |
| Casein | 1.2 | 3.2 | 2.8 | g | Low fat or Protein-enriched |
| | | | | | low fat milk |
| Fat | 3.2 | 3.4 | 3.4 | g | Sunflower oil or cream |
| Lactose | 7.8 | 7.0 | 7.0 | g | Lactose powder |
| Lactoferrin | 0.06 | 0.06 | 0.06 | g | Lactoferrin powder |
| Iron | 0.99 | 1.4 | 1.4 | mg | Iron(II) sulphate; Ferric |
| | | | | | pyrophosphate |
| Zinc | 0.61 | 1.2 | 1.2 | mg | Zinc sulphate; Zinc oxide |
| Vitamin A* | 121 | 75 | 75 | μg | Retinol Acetate |
| Vitamin D3* | 1.7 | 1 | 1 | μg | Cholecalciferol |
| Vitamin B1* | 0.06 | 0.06 | 0.06 | mg | Thiamine HCl |
| Vitamin B2* | 0.15 | N.A. | N.A. | mg | Riboflavin |
| Vitamin B9* | 16 | N.A. | N.A. | μg | Folic acid |
| Vitamin C** | 10.5 | 10.5 | 10.5 | mg | Ascorbic acid, Sodium |
| | | | | | ascorbate |
| Mixed | 14.7 | 14.7 | 14.7 | mg | Mixed tocopherol syrup |
| tocopherols | | | | | |

*The quantities for Vitamins A, D3, B1, B2, B9 do not include the 33% overage.
**The quantity for Vitamin C do not include the 100% overage.

TABLE 19
Small Commercial Plant Trials Technical Details

| | | | | Single | Stream 1 | Stream 2 |
|---|---|---|---|---|---|---|
| | Protein | Carbohydrate | Macro | stream | may | may |
| Product | Sources | sources | Composition | control | contain | contain |
| Model Stage | Low fat | Lactose | 1.2 Whey | N/A | pH 4 | ~pH 7.05 |
| 2 (S2) RTF | fat Milk, | | 1.2% Casein | | Lactose, | Low fat milk, WPC 80, |
| infant | WPC 80 | | 3.2% Fat | | Lactoferrin, | Sunflower oil, |
| formula | | | 7.8% Lactose | | Vitamin B1, B2, C, | Fe, Zn, Vitamin A, D3, B9, C, |
| | | | | | Phosphoric Acid | Mixed Tocopherols, Sodium |
| | | | | | | Hydroxide |
| Model Stage | Protein- | Lactose | Casein: whey | pH 6.8 | pH 3-4 | ~pH 6.9-7.5 |
| 4 (S4) RTF | enriched | | ratio - 70:30- | insoluble | Lactose, | Protein-enriched low fat milk, |
| infant | low fat | | 80:20) | Fe & Zn | Lactoferrin, WPC, | WPC 80, Cream, |
| formula | milk, WPC | | 0.8-1.2% Whey - | | Vitamin B1, C, | Fe, Zn, Vitamin A, D3, C, Mixed |
| | 80 | | 2.8-3.2% Casein | | Phosphoric Acid | Tocopherols |
| | | | 3.4% Fat | | | |
| | | | 7% Lactose | | | |

### Results and Discussion

### Processing Observations & Data

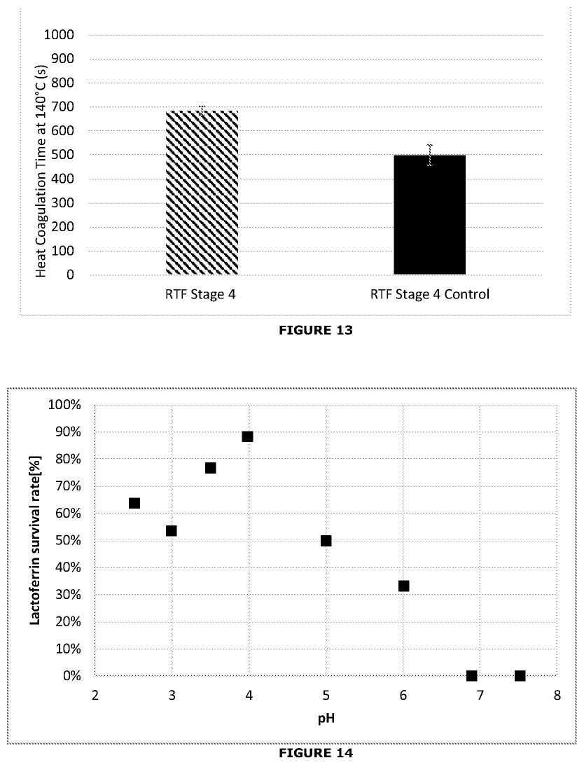

All product streams were processed through the commercial scale UHT plant and aseptically mixed to form final product compositions. The RTF Stage 4 control required formulation with insoluble minerals to prevent fouling and enable production, whereas the SSP process allowed formulation of an RTF Stage 4 composition with soluble (and more bioavailable) minerals. Despite the presence of soluble minerals (which have previously been reported to negatively impact product and protein stability), as can be seen in FIG. 13 the products of the SSP process still exhibited a substantially longer heat coagulation time compared to the products produced by the conventional processing method (see FIG. 13, RTF Stage 4 vs RTF Stage 4 control).

### Maillard Reaction

The concentration of the Maillard indicators furosine and lactulose was determined for the RTF Stage 2 infant formulations. As with Stage 1 SSP formulations discussed in Examples 2 and 3, a minimal increase in the concentration of these indicators was observed in the SSP products after heat treatment, and the lactulose:furosine ratio of the RTF Stage 2 infant formula prepared using SSP was <1 after processing.

These results strongly indicate that the methods contemplated herein (exemplified in these trials by the SSP process) reduced the Maillard reaction during heat treatment when compared to a conventional process.

### Lactoferrin Stability

The lactoferrin content of RTF Stage 2 and RTF Stage 4 SSP products and of an RTF Stage 4 conventionally produced control sample was tested using RP-HPLC. The pH of the acidic lactoferrin-containing stream used in the SSP processes was approximately pH 4.0. Lactoferrin survival measurements were made in final product streams.

As can be seen in Table 20, in the final products produced by the SSP process, more than 85% of the lactoferrin was in a native conformation as measured by RP-HPLC. This very high degree of lactoferrin survival was observed for both RTF formulations prepared using SSP, indicating the protein stability and survival benefits observed in the production of RTF Stage 1 formulations by SSP were also observed when SSP was used to produce other model RTF formulations beyond Stage 1. In contrast, no native lactoferrin was observed in control samples prepared using conventional processing. In the final product produced by the SSP process, >85% of the lactoferrin was in a native conformation as measured by RP-HPLC. It will be appreciated that this high level of survival of native lactoferrin in products produced using SSP methods as described here has significant implications for the preparation of nutritional compositions comprising functionally-active proteins as contemplated herein.

TABLE 20
Estimated lactoferrin survival over UHT based
on native lactoferrin quantification by RP-HPLC

| | % Lactoferrin Survival |
|---|---|
| Process | in product stream |
| Conventionally processed | 0% |
| control (RTF Stage 4) | |
| Stage 2 SSP Trial | 85.4% |
| Stage 4 SSP Trials | 93.0% |

### Emulsion Stability

This example investigated certain characteristics of the UHT-treated samples associated with a potential impact on shelf life, in this case, the emulsion stability of products produced by the exemplary SSP process and those prepared by conventional methods.

The final product bottles produced were observed over shelf life to record product performance over time. The shelf stability of SSP was comparable to the control over 6 months storage at 25° C. as indicated by sedimentation and particle size data (data not shown).

### Sensory

No obvious sensory difference between the conventionally produced control samples and SSP products were observed.

### Example 5: Lactoferrin Survival

This example presents data from trials carried out using stream 1 of the Ready to Feed (RTF) nutritional composition using representative SSP methods as described herein, in this case using a small-scale UHT pilot plant as detailed in Example 1. In this example, Stream 1 was composed of a 2.5 wt % lactoferrin solution.

### Results and Discussion

FIG. 14 shows that the survival of native lactoferrin in Stream 1 was affected by the pH at heating. Optimal native lactoferrin survival was observed when the pH was between pH 3 and 5, however some undenatured lactoferrin was detected at any acidic pH below about pH 6.

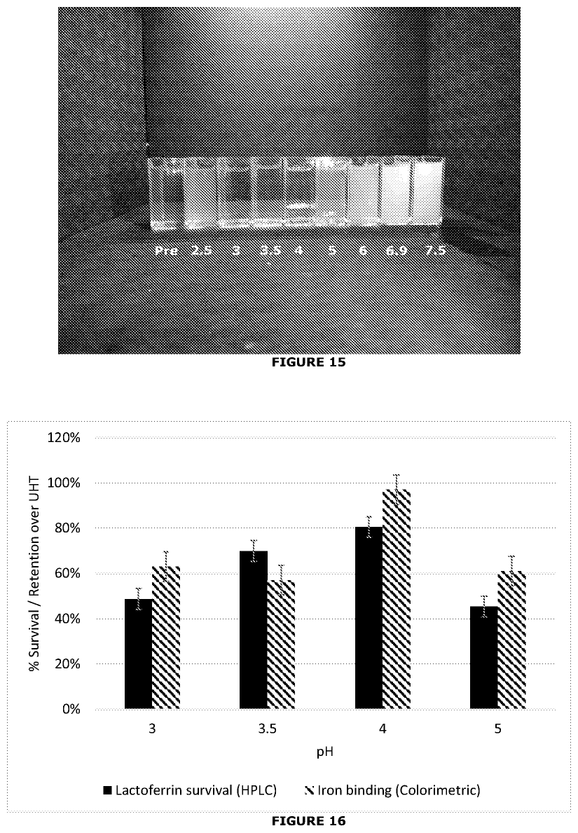

FIG. 15 shows the colour change of lactoferrin in Stream 1 when heated at various pH. As can be seen in FIG. 15, lactoferrin-containing samples heated at a pH of between 3 to 5 did not show any sedimentation or turbidity. Turbidity was observed when the pH was above 6 at heating.

The bioactivity of lactoferrin present in the RTF formulations was then assessed by assaying iron binding. FIG. 16 shows how the iron binding of lactoferrin in Stream 1 correlated well with lactoferrin survival, and is likewise affected by the pH of the lactoferrin-containing stream at heating. This data supports the hypothesis that retaining more undenatured lactoferrin means better preservation of the bioactivity of lactoferrin, indicated by the level of iron binding. Iron binding was greater than 50% in samples heated at the optimal survival range of pH 3-5, with more than 90% iron binding observed at pH 4.

Here, the retention of the iron binding activity of lactoferrin clearly establishes that the SSP processes exemplified herein are able to produce UHT-treated nutritional compositions comprising valuable bioactive components, including ingredients such as bioactive proteins the survival and bioactivity of which is challenging if not impossible to preserve using conventional processing methods.

### Example 6: Sports

This example presents data from trials carried out using nutritional compositions typically referred to as Sports formulations having the compositions as set forth in Table 21. These trials used representative SSP methods as described herein, here using a small-scale UHT pilot plant and a commercial scale UHT pilot plant as detailed in Example 1. SSP samples were processed in two streams, Stream 1 at pH 3.9 and Stream 2 at pH 6.9 and mixed aseptically post UHT and cooling. The control sample was processed as a single stream at pH 7.0.

TABLE 21
Composition of model sport formulations.

| | | Model sports | Complete Sports |
|---|---|---|---|
| Nutrient | Unit | formulation | formulation |
| Protein | g/100 g | 8.3 | 8.3 |
| Whey | g/100 g | 0.66 | 0.66 |
| Casein | g/100 g | 7.64 | 7.64 |
| Fat | g/100 g | 0.74 | 0.74 |
| Carbohydrates | g/100 g | 7.25 | 7.25 |
| Lactose | g/100 g | 3.75 | 3.75 |
| Lactoferrin | g/100 g | 0.06 | 0.06 |
| Ingredients | | Calcium caseinate, Low fat | Calcium caseinate, Low fat milk, |
| | | milk, dextrose powder, | dextrose powder, lactoferrin, |
| | | lactoferrin | FOS, glucosamine sulfate, |
| | | | creatine, and L-carnitine |

### Results and Discussion

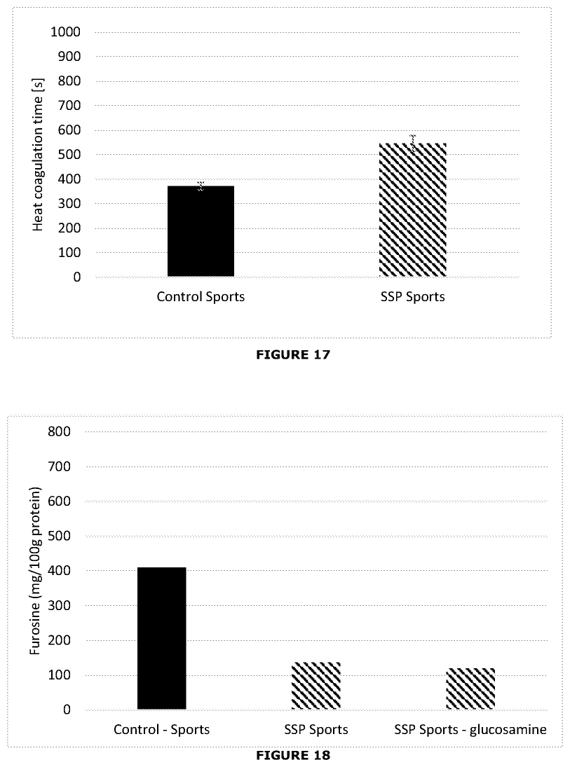

As observed in other trials discussed above, the SSP samples showed a clear processability advantage over those produced using conventional processing. The Sports formulations produced using SSP were heat treated with no sign of fouling as indicated by consistent temperature profile over the duration of processing. As seen in FIG. 17, the Sports formulations produced using SSP exhibited markedly increased heat coagulation times compared to control samples prepared using conventional processing.

Moreover, representative complete sports formulations comprising glucosamine were able to be produced by SSP, whereas comparable formulations comprising added glucosamine could not be processed using conventional, single stream processes, as the latter showed a heat coagulation time of 50 s which was not processable.

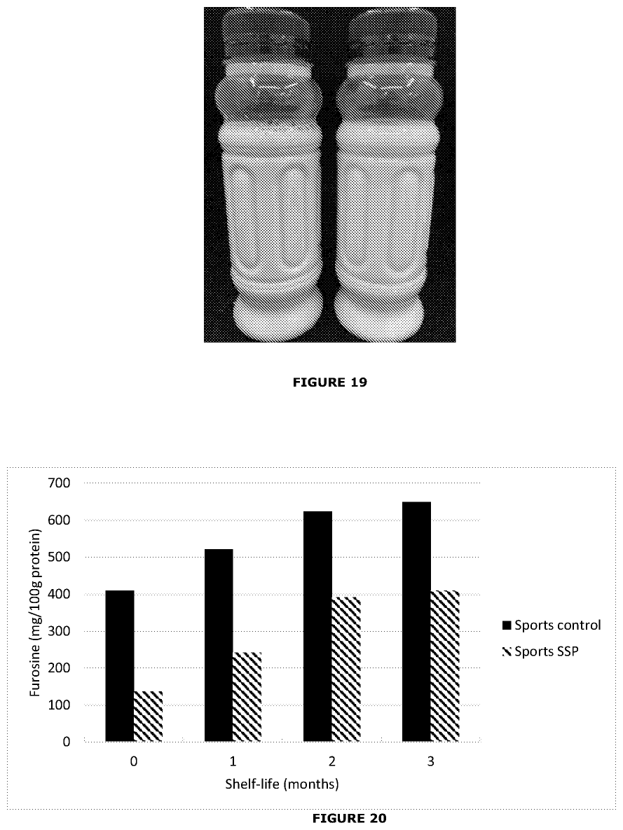

After processing, analysis of Sports formulations showed that, like other products produced by SSP processes in the examples herein, the SSP Sports products also evidenced reduced Maillard reaction as shown by substantially lower furosine levels compared to control samples (see FIG. 18). Product colour benefits compared to control sample were also observed, as shown in FIG. 19 which shows an SSP Sports formulation (right hand side) and a control sample (left hand side) after storage for 3 months at 25° C., and in Table 22 which shows that the SSP Sports formulation maintained its whiteness index over storage better than the control sample. The SSP process enabled the production of Sports formulations comprising a substantial amount of native lactoferrin, whereas no detectable native lactoferrin was found in the control sample, as shown in Error! Reference source not found.

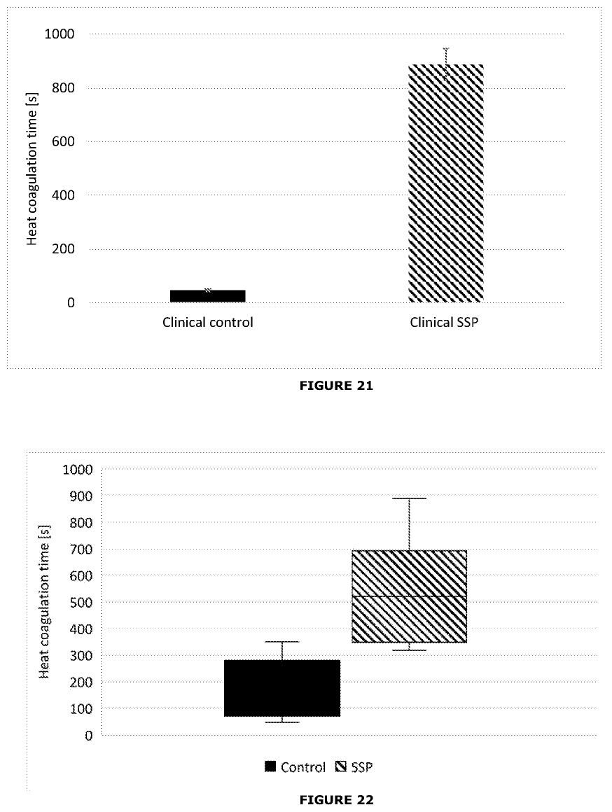

Sensory evaluation with an expert panel (n=5) found that control Sports formulations were browner, had a more cooked flavour, and had stronger protein off flavours than Sports samples produced by SSP. The SSP Sports products showed low viscosities (<10 cP 100/s), and good stability over shelf life. A further indicator of good stability of the SSP Sports products over shelf life is presented in FIG. 20, which shows that furosine levels remained low after 3 months shelf life at 25° C. and remained much lower than that observed in control samples stored under the same conditions.

TABLE 22
Whiteness index for nutritional compositions at 8% protein,
0.7% fat and 7.2% carbohydrate after UHT treatment

| Colour measurement | Sports Control | Sports SSP |
|---|---|---|
| Whiteness index | 83.2 | 83.4 |
| (after UHT) | | |
| Whiteness index | 79.6 | 83.1 |
| (3 months storage at 25° C.) | | |

TABLE 23
Lactoferrin survival as measured by
HPLC for sport-like formulations

| Sample | Lactoferrin survival % |
|---|---|
| Sports Control | 0 |
| Sports SSP trials | 88 |

### Example 7: Clinical

This example presents data from trials carried out using nutritional compositions typically referred to as Clinical formulations with compositions as set forth in Table 24 Error! Reference source not found. These trials used representative SSP methods as described herein, again using both a small-scale UHT pilot plant and a commercial scale UHT pilot plant as detailed in Example 1. SSP samples were processed in two streams, Stream 1 at pH 4.0 and Stream 2 at pH 7.02-7.4 and mixed aseptically post UHT and cooling. The control sample was processed as a single stream at pH 7.3.

In one SSP trial a third stream was heat treated, cooled to 85° C. and homogenised at 50 bar prior to admixture with the first and second streams, followed by the final packing step. Stream 1 contained a carbohydrate (either glucose syrup or sucrose) and lactoferrin processed at pH 4, Stream 2 contained MPC 85 and sunflower oil processed at pH 7.1, and when present, Stream 3 contained WPC processed at pH 7.5, with micronutrients placed appropriately. In one example, Stream 1 contained lactoferrin processed at pH 4, Stream 2 contained MPC 85 and sunflower oil and Stream 3 contained carbohydrate (either glucose syrup or a maltodextrin/sucrose combination).

TABLE 24
Composition of model clinical formulations.

| | | | | | 5.7% | 6% | 4% | 4% |
|---|---|---|---|---|---|---|---|---|
| | | | | | protein + | protein + | protein | protein |
| | | 4% | 6% | 8% | whey protein | value add | carbohydrate | Sucrose + |
| Nutrient | Unit | protein | protein | protein | triple stream | ingredients | triple stream | Maltodextrin |
| Protein | g/100 g | 4.06 | 6.06 | 8.06 | 5.7 | 6.06 | 4.06 | 4.06 |
| Whey | g/100 g | 0.86 | 1.26 | 1.66 | 3 | 1.26 | 0.86 | 0.86 |
| Casein | g/100 g | 3.2 | 4.8 | 6.4 | 2.7 | 4.8 | 3.2 | 3.2 |
| Fat | g/100 g | 5.8 | 7.8 | 5.8 | 5.5 | 7.8 | 5.8 | 5.8 |
| Carbohydrates | g/100 g | 18.4 | 8 | 18.4 | 18.4 | 8 | 12 | 18.4 |

| | | | | | | |
|---|---|---|---|---|---|---|
| Lactoferrin | g/100 g | 0.06 | 0.06 | 0.06 | 0.06 | 0.06 |

| Ingredients | MPC85, sunflower oil, carbohydrates (glucose syrup or sucrose/maltodextrin), lactoferrin, potassium chloride, | | |
|---|---|---|---|
| | ferrous sulfate or iron pyrophosphate, zinc sulfate or zinc oxide, potassium chloride, magnesium chloride or | | |
| | magnesium phosphate dibasic,, choline chloride, cupric sulfate, manganese sulfate, trisodium citrate, vitamins A, D, | | |
| | E, K, B1, B2, B3, B5, B6, B7, B9, B12, C, mixed tocopherols, sodium hydroxide or potassium hydroxide, , phosphoric | | |
| | acid | | |
| Added nutrients | | WPC80 | plant sterols, |
| | | | polyphenols, |
| | | | and L- |
| | | | carnitine |

* The insoluble forms of Iron and Zinc were used in clinical control while the soluble forms were used in clinical SSP.

### Results and Discussion

As observed in other trials discussed above, the SSP process and samples again showed clear processability advantages over conventional processes and the products produced using standard processing. The Clinical formulations produced using SSP were heat treated with no sign of fouling, and as seen in FIG. 21 and in FIG. 22 these formulations exhibited markedly increased heat coagulation times compared to control Clinical formulations prepared using conventional processing.

Moreover, the SSP process enabled the production of Clinical formulations comprising a variety of ingredients, such as soluble vitamins, that were not able to be produced using conventional, single stream processes. Limitations on the types and the concentration of ingredients needed to be imposed on the composition of control samples in order to meet processability requirements, as indicated by heat coagulation time (see Table 25, and FIGS. 21 and 22). Only selected control samples could be processed successfully; however, all SSP products were heat treated with no sign of fouling as indicated by consistent temperature profile over the duration of processing. The high heat coagulation times observed for Clinical formulations comprising MPC 85 as presented here indicate that comparable SSP processes could readily utilize other milk protein sources, including other milk protein concentrates, caseinates, or milk protein isolates.

The analysis of Clinical formulations showed that, like other products produced by SSP processes in the examples herein, the SSP Clinical products evidenced reduced Maillard reaction. As shown in Table 26, substantially lower furosine levels were observed in Clinical formulations produced using SSP compared to control samples, both immediately after production, and after 1 month storage at 25° C. Product colour and whiteness index benefits compared to control sample were also observed, as shown in Table 27, which also shows that the SSP Clinical formulation maintained its whiteness index over storage better than the control sample.

TABLE 25
Heat stability for a range for clinical-like nutritional compositions

| Sample type | Formulation | Heat coagulation time [s] |
|---|---|---|
| Clinical nutritional | 4-8% protein | 46-350 s |
| composition - Control | 5-8% fat | |
| (n = 23) | 8-20% carbs | |
| | Insoluble minerals | |
| Clinical nutritional | 4-8% protein | 317-888 s |
| composition - SSP | 5-8% fat | |
| (n = 10) | 8-20% carbs | |
| | Soluble minerals | |

TABLE 26
Maillard reaction data for nutritional compositions
at 6% protein, 7.8% fat and 8% carbohydrates

| | | | Clinical SSP - |
|---|---|---|---|
| | Clinical | | value-add |
| Product | Control | Clinical SSP | ingredients |
| Furosine content (after UHT) | 348.3 | 109.3 | 117 |
| [mg/100 g protein] | | (69% less than | (66% less than |
| | | control) | control) |
| Furosine content (after 1 m | 414.2 | 186.1 | |
| storage, 25° C.) | | | |
| [mg/100 g protein] | | | |

TABLE 27
Whiteness index for nutritional compositions at 6% protein,
7.8% fat and 8% carbohydrate after UHT treatment

| Product | Clinical Control | Clinical SSP |
|---|---|---|
| Whiteness index | 88 | 88.2 |
| (after UHT) | | |
| Whiteness index | 84.5 | 87.5 |
| (2 months storage at 25° C.) | | |

The SSP process enabled the production of Clinical formulations comprising a substantial amount of native lactoferrin, whereas no detectable native lactoferrin was found in the control sample, as shown in Table 28. Iron binding was also quantified using the method outlined in Example 1 and found to be 78% for Clinical SSP triple stream product.

TABLE 28
Estimated lactoferrin survival over UHT based
on native lactoferrin quantification by RP-HPLC

| | % Lactoferrin | % Lactoferrin |
|---|---|---|
| | Survival | survival (finished |
| Process | (Stream 1) | product) |
| Clinical control | N/A | 0% |
| Clinical SSP Triple Stream | 85% | 25-37% |
| Clinical SSP (sucrose) | 63-75% | |

### Example 8: Whey Protein Survival

This example presents trials carried out to investigate the production of Ready to Feed (RTF) and clinical-like nutritional compositions using representative SSP methods as described herein using two different scales of heater; a small-scale UHT pilot plant and a commercial scale UHT pilot plant as detailed in Example 1.

### Methods

Stream 1 samples were processed, packed and stored. SSP samples were processed in two streams, Stream 1 at pH 3.0-4.0, Stream 2 at pH 6.9-7.7, and mixed aseptically post UHT and cooling. The control samples were processed as a single stream at pH 6.9. The nutritional compositions including whey protein are described in Error! Reference source not found. 29.

TABLE 29
Nutritional compositions containing whey protein in Stream 1

| | | | | | Stream 1 |
|---|---|---|---|---|---|
| Sample | No. of | Macro | | | fraction |
| description | streams | composition | Stream 1 | Stream 2 | (wt %) |
| RTF Stage 4 | 1 | 3.2% casein, 0.8% | Single stream processing, pH ~6.9 | | N/A |
| control | | whey, 3.4% fat, 7% | Iron Pyrophosphate and Zinc Oxide (Insoluble | | |
| (casein: | | lactose, 0.06% | Minerals) | | |
| whey of | | lactoferrin | | | |
| 80:20) | | | | | |
| RTF Stage 4 | 2 | 2.8% casein, 1.2% | ~21% lactose, | Protein-enriched low fat | 17.3% |
| SSP (casein: | | whey (0.5% in | ~3.6% WPC, | milk, Iron, Zinc, Vitamin A, | |
| whey of | | Stream 1, 0.7% in | ~0.4% | D3, mixed tocopherols; pH | |
| 70:30) | | Stream 2), 3.4% | lactoferrin, | 7.7 | |
| | | fat, 7% lactose, | Vitamins B1, C, | | |
| | | 0.06% lactoferrin | Phosphoric | | |
| | | | Acid; pH 3.5 | | |
| RTF Stage 1 | 1 | 0.5% casein, 0.74% | Single stream processing, insoluble calcium | | N/A |
| complete | | whey, 3.4% fat, 7% | used (Calcium carbonate); pH 6.9 | | |
| control | | lactose, 0.06% | | | |
| | | lactoferrin | | | |
| RTF Stage 1 | 2 | 0.5% casein, 0.74% | ~20% lactose, | Low fat milk, WPC 80, | 29.4% |
| SSP | | whey (0.06% in | ~0.3% WPC | sunflower oil, FOS, Iron, | |
| | | Stream 1, 0.68% in | 80, ~0.2% | Zinc, choline, Vitamin A, | |
| | | Stream 2), 3.4% | lactoferrin, | D3, E, K1, B3, B5, B6, B7, | |
| | | fat, 7% lactose, | GOS, 2-FL, | B9, B12, sodium | |
| | | 0.06% lactoferrin | LNnT, Vitamins | ascorbate, mixed | |
| | | | B1, B2, C; | tocopherols, L-carnitine, | |
| | | | inositol, | taurine, nucleotides, milk | |
| | | | Magnesium, | phospholipid concentrate, | |
| | | | Phosphoric | soluble Calcium (calcium | |
| | | | Acid; pH 3.5 | chloride), Potassium, | |
| | | | | Copper; pH 7.55 | |
| Clinical SSP - | 2 | 3.6% casein, 2.34% | 4.0% protein | MPC85, Sunflower oil, Fe | 37% |
| native | | whey (1.44% in | (WPC), 21.7% | Pyrophosphate, Zn Oxide, | |
| whey | | Stream 1, 0.9% in | carb (glucose | CuSO4, MnSO4, Choline, | |
| | | Stream 2), 7.8% | syrup), 0.16% | Vit A, D, K, E, | |
| | | fat, 8% carb, | LF, vit B1, B2, | B3, 5, 6, 7, 9, 12, Sodium | |
| | | 0.06% lactoferrin | C, Phosphoric | Ascorbate, Mixed | |
| | | | Acid; pH 3.0 | Tocopherols, K2HPO4, | |
| | | | | MgHPO4; | |
| | | | | pH 7.4 | |
| Stream 1 | 1 | 4-16% whey | 4-16% whey | N/A | N/A |
| whey | | protein | protein, | | |
| protein only | | | Phosphoric | | |
| | | | Acid; pH 3 or | | |
| | | | 3.5 | | |
| Stream 1 + | 2 | 5.2-7.6% protein | 8-16% whey | Protein-enriched low fat | 4-50% |
| Stream 2 | | 2.8-4.9% | protein, | milk at 5% protein; pH 7.5 | |
| processing | | carbohydrates | Phosphoric | | |
| | | | Acid; pH 3 | | |

### Results and Discussion

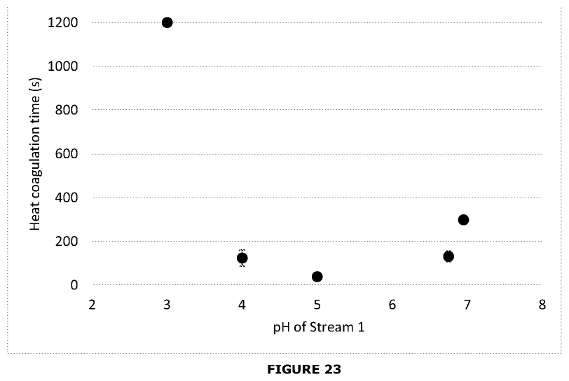

SSP processing allowed the preparation of liquid RTF and clinical formulations comprising whey protein with improved heat stability (see FIG. 23). SSP formulations were heat treated with no sign of fouling as indicated by a consistent temperature profile over the duration of processing. As can be seen in FIG. 23, formulations comprising 2 wt % whey protein produced using SSP exhibited good heat stability, with compositions prepared from SSP processes in a Stream 1 was at pH 3 when heat treated showing heat coagulation times in excess of 1200 s.

After processing, the SSP processes carried out in this example enabled the production of nutritional products and Stream 1 compositions comprising up to 16 wt % whey proteins. The ability to process this elevated amount of whey protein into the final product provided nutritional compositions having an increased whey:casein ratio of up to 45:55. Furthermore, the SSP processes supported high degrees of protein survival. As shown in Table 30, the proportion of whey protein surviving in a native state in the various whey-containing SSP compositions tested here was substantially greater than that observed in control samples. SSP samples showed more than 50% whey protein survival in all SSP nutritional compositions tested, including Ready to Feed (RTF) infant formula and clinical-like compositions. In contrast, whey protein survival was non-existent or neglible in comparator control samples.

When Stream 1 compositions comprising whey protein were produced using SSP process, no particle growth during or after heat treatment was observed. These compositions had low viscosity and did not exhibit gelation and were therefore well suited for admixture with casein-containing Stream 2 compositions. SSP processing thus allowed the formulation of nutritional compositions with a high whey protein concentration, including compositions comprising both whey proteins and caseins at whey:casein ratios up to and including 45:55 across a pH range of 5.5-6.9. The compositions so produced showed acceptable stability after 2 weeks storage at 4° C.

TABLE 30
Native whey protein survival for various nutritional compositions

| | Alpha-lactalbumin | Beta-lactoglobulin | Total whey |
|---|---|---|---|
| | survival | survival | protein survival |
| Trial Names | [%] | [%] | [%] |
| RTF Control | 26.2-37.5 | 2.8-19.7 | 0.3-25 |
| RTF SSP Trials | 75.2-100 | 52.9-85.6 | 57.6-88.3 |
| Clinical Control | 0 | 0 | 0 |
| Clinical SSP Trials | 30.3 | 59.4 | 54.9 |
| Stream 1 SSP | >55 | >75 | 75-100 |
| Trials | | | |
| (whey protein | | | |
| concentration 4-16%) | | | |

These data establish the utility of the exemplified SSP processes in the production of a range of liquid nutritional compositions having beneficial physicochemical and nutritional properties, including liquid nutritional products having elevated whey protein concentrations and high protein survivability.

### PUBLICATIONS

Nursten H. (2005) The Maillard reaction: chemistry, biochemistry and implications. Cambridge: Royal Society of Chemistry.
Erbersdobler, H., & Somoza, V. (2007). Forty years of furosine—Forty years of using Maillard reaction products as indicators of the nutritional quality of foods. Molecular Nutrition & Food Research, 51(4), 423-430).
Judd, D. B. and G. Wyszecki. 1963. Color in Business, Science and Industry. New York: John Wiley & Sons.

As used in this specification, the words “comprise”, “comprises”, “comprising”, and similar words, are not to be interpreted in an exclusive or exhaustive sense. In other words, they are intended to mean “including, but not limited to”. When interpreting each statement in this specification that includes the term “comprise”, “comprises”, or “comprising”, features other than that or those prefaced by the term may also be present.

The entire disclosures of all applications, patents and publications cited above and below, if any, are herein incorporated by reference.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

The invention may also be said broadly to consist in the parts, elements and features referred to or indicated in the specification of the application, individually or collectively, in any or all combinations of two or more of said parts, elements or features.

Aspects of the invention have been described by way of example only, and it should be appreciated that variations, modifications and additions may be made without departing from the scope of the invention, for example when present the invention as defined in the indicative claims. Furthermore, where known equivalents exist to specific features, such equivalents are incorporated as if specifically referred in this specification.

1. A method of producing a liquid nutritional composition, the method comprising, consisting essentially of, or consisting of
a. providing a first stream comprising carbohydrate, wherein the first stream is or has been heat-treated when at a pH of less than about 6; and
b. providing a second stream comprising protein, wherein the second stream is or has been heat-treated when at a pH of more than about 6; and
c. aseptically admixing the heat-treated first stream and the heat-treated second stream, wherein at admixture
i. the first stream has a pH of less than about 6; and
ii. the second stream has a pH of more than about 6;
to provide a heat-treated liquid nutritional composition.

2. (canceled)

3. The method of claim 1, wherein the method comprises aseptically admixing one or more additional heat treated or sterilised streams to the first stream, to the second stream, to the admixture of step c, or to any combination of two or more of the first steam, the second stream, and the admixture of step c.

4. The method of claim 1, wherein at admixture or when heat treated or both, the first stream has a pH in the range of from about 2.5 to about 6, and/or wherein at admixture or when heat treated or both, the second stream has a pH in the range of from about 6 to about 9.

5. (canceled)

6. The method of claim 1, wherein the carbohydrate comprises, consists essentially of, or consists of one or more reducing sugars.

7. (canceled)

8. The method as claimed in claim 1, wherein the first stream comprises from about 1% w/w to about 70% w/w carbohydrate.

9. The method as claimed in claim 1, wherein the second stream comprises at least 0.5% w/w protein, and/or less than about 5% w/w reducing sugar.

10. (canceled)

11. The method as claimed in claim 1, wherein the protein comprises, consists essentially of, or consists of one or more milk proteins, or wherein the protein comprises, consists essentially of, or consists of one or more plant proteins.

12-19. (canceled)

20. The method as claimed in claim 1, wherein at admixture the first stream has a pH in the range of from about 3 to about 5 and/or wherein at admixture the second stream has a pH in the range of about 6.5 to 8.

21-22. (canceled)

23. The method as claimed in claim 1, wherein the first stream comprises from about 0.01% w/w to about 16% w/w protein.

24-26. (canceled)

27. The method as claimed in claim 1, wherein when heat treated the pH of the second stream is at or above 6.5, and/or wherein when heat treated the pH of the first stream is at or below about 6.

28. (canceled)

29. The method as claimed in claim 1, wherein the pH of the first stream, the pH of the second stream, or the pH of both the first stream and the pH of the second stream, is not adjusted after heat treatment and prior to admixture.

30. (canceled)

31. The method as claimed in claim 1, wherein following heat treatment:
a. the protein present in the first stream is substantially undenatured; and/or
b. when lactoferrin is present in the first stream
i. the majority of lactoferrin molecules present are globular; and/or
ii. the lactoferrin is substantially undenatured; and/or
iii. at least about 50% of the lactoferrin molecules present have a native conformation; and/or
iv. the total iron binding capacity of the lactoferrin is at least 50% that of the lactoferrin prior to heat treatment; and/or
c. when osteopontin is present in the first stream
v. the majority of osteopontin molecules present are globular; and/or
vi. at least about 50% of the osteopontin molecules present have a native conformation; and/or
d. when lactalbumin is present in the first stream or the
vii. the majority of lactalbumin molecules present are globular; and/or
viii. at least about 50% of the lactalbumin molecules present have a native conformation; and/or
e. when alpha-lactalbumin is present in the first stream
ix. the majority of alpha-lactalbumin molecules present are globular; and/or
x. at least about 50% of the alpha-lactalbumin molecules present have a native conformation; and/or
f. when beta-lactoglobulin is present in the first stream
xi. the majority of beta-lactoglobulin molecules present are globular; and/or
xii. the beta-lactoglobulin is substantially undenatured; and/or
xiii. at least about 50% of the beta-lactoglobulin molecules present have a native conformation; and/or
g. any combination of two or more of a) to f) above.

32. The method as claimed in claim 1, wherein the admixture comprises
h. furosine in an amount that is not more than 20% greater than the total amount of furosine present in the first stream and the second stream prior to heat treatment; and/or
i. furosine in an amount or concentration that is not more than 80% of the amount or concentration of furosine present in a control composition prepared in a single stream process with the same ingredients; and/or
j. less than about 5 g furosine per kg protein present; and/or
k. a lactulose:furosine ratio ((mg lactulose/kg of composition):(mg furosine/100 g protein)) below about 3; and/or
l. any combination of two or more of a) to d) above; or
m. each of a) to d) above.

33. The method as claimed in claim 1, wherein the admixture is of a first stream having at heat treatment a pH less than 5, or wherein the admixture is of a second stream comprising less than about 5% w/w reducing sugar, or the admixture is of a first stream having at heat treatment a pH less than 5 and a second stream comprising less than about 5% w/w carbohydrate, wherein the admixture comprises
n. furosine in an amount that is not more than 20% greater than the total amount of furosine present in the first stream and the second stream prior to heat treatment; and/or
o. furosine in an amount or concentration that is not more than 80% of the amount or concentration of furosine present in a control composition prepared in a single stream process with the same ingredients; and/or
p. less than about 5 g furosine per kg protein present; and/or
q. a lactulose:furosine ratio ((mg lactulose/kg of composition):(mg furosine/100 g protein)) below about 1; or
r. any combination of two or more of a) to d) above; or
s. each of a) to d) above.

34-37. (canceled)

38. The method as claimed in claim 1, wherein at admixture:
t. the temperature of the first stream is at least about 15° C.; or
u. the temperature of the second stream is at least about 15° C.; or
v. the temperature of the first stream is less than about 75° C.; or
w. the temperature of the second stream is less than about 75° C.; or
x. any combination of two or more of a) to d) above; or
y. each of a) to d) above.

39-40. (canceled)

41. The method as claimed in claim 1, the method comprising, consisting essentially of, or consisting of
z. UHT treating a first stream comprising from about 0.5% w/w to about 55% w/w carbohydrate and having a pH of from about 2.5 to about 5;
aa. UHT treating a second stream having a pH of from about 6.5 to about 8, the second stream comprising
xiv. from about 0.05% w/w to about 35% w/w protein;
xv. from about 0% w/w to about 15% w/w lipid; and
xvi. optionally one or more soluble mineral salts; and
xvii. optionally one or more insoluble mineral salts; and
xviii. optionally one or more fat soluble vitamins; and
xix. optionally one or more water soluble vitamins; and
bb. aseptically admixing the heat-treated first stream and the heat-treated second stream, wherein at admixture
xx. the first stream has a pH in the range of from about 2.5 to about 5; and
xxi. the second stream has a pH in the range of from about 6.5 to about 8;
to provide a heat-treated liquid nutritional composition.

42. (canceled)

43. The method as claimed in claim 1, the method comprising, consisting essentially of, or consisting of
cc. providing a first stream comprising from about 1% w/w to about 35% w/w lactose, wherein the first stream is or has been heat-treated; and
dd. providing a second stream comprising from about 0.05% to about 5% w/w protein, wherein the second stream is or has been heat-treated; and
ee. aseptically admixing the heat-treated first stream and the heat-treated second stream, wherein at admixture
xxii. the first stream has a pH in the range of from about 3 to about 5.5; and
xxiii. the second stream has a pH in the range of from about 6.5 to about 8;
to provide a heat-treated liquid nutritional composition.

44-45. (canceled)

46. The method as claimed in claim 1, the method consisting essentially of
ff. heat-treating a first stream comprising carbohydrate and having a pH of from about 2.5 to about 5.5; and
gg. heat-treating a second stream comprising protein and having a pH of from about 6.5 to about 9; and
hh. aseptically admixing the heat-treated first stream and the heat-treated second stream, wherein at admixture
xxiv. the first stream has a pH in the range of from about 2.5 to about 5.5; and
xxv. the second stream has a pH in the range of from about 6.5 to about 9;
to provide a heat-treated nutritional composition.

47-50. (canceled)

51. A heat-treated liquid nutritional composition comprising, consisting essentially of, or consisting of
ii. from about 1% w/w to about 30% w/w carbohydrate;
jj. from about 0.1% w/w to about 35% w/w protein;
kk. from about 0% w/w to about 10% w/w lipid;
ll. optionally one or more minerals or salts thereof, including one or more soluble mineral salts;
mm. optionally one or more vitamins;
nn. optionally one or more oligosaccharides, for example one or more galactooligosaccharides, one or more fructooligosaccharides; or one or more human milk oligosaccharides;
wherein the nutritional composition
oo. is shelf stable for at least 28 days following manufacture when stored at 25° C.; and/or
pp. is whiter immediately following manufacture and/or when stored at 25° C. for 28 days after manufacture exhibits a slower rate of browning; or
qq. immediately following manufacture comprises less than about 5 g furosine per kg protein present; or
rr. when stored at 25° C. for 28 days after manufacture comprises less than about 10 g furosine per kg protein present; or
ss. when stored at 25° C. for 28 days after manufacture exhibits no more than a 3-fold increase in furosine concentration:
tt. immediately following manufacture comprises less than about 300 mg lactulose per kg product; or
uu. when stored at 25° C. for 28 days after manufacture exhibits no more than a 3-fold increase in lactulose concentration; or
vv. comprises a fermented composition and/or one or more products of fermentation by lactic acid bacteria; or
ww. any combination of two or more of any of g) to n) above; or
xx. each of g) to m) above; or
yy. each of g) to n) above.

52. The heat-treated composition of claim 51, wherein
zz. the lactulose:furosine ratio ((mg lactulose/kg of composition):(mg furosine/100 g protein)) of the composition is below about 2 immediately after manufacture; and/or
aaa. the lactulose:furosine ratio ((mg lactulose/kg of composition):(mg furosine/100 g protein)) of the composition is below about 1 immediately after manufacture; and/or
bbb. the lactulose:furosine ratio ((mg lactulose/kg of composition):(mg furosine/100 g protein)) of the composition is below about 0.8 immediately after manufacture; and/or
ccc. the lactulose:furosine ratio ((mg lactulose/kg of composition):(mg furosine/100 g protein) of the composition remains below 1 after storage at 25° C. for 28 days after manufacture; and/or
ddd. the lactulose:furosine ratio ((mg lactulose/kg of composition):(mg furosine/100 g protein) of the composition remains below 0.8 after storage at 25° C. for 28 days after manufacture; and/or
eee. the lactulose:furosine ratio ((mg lactulose/kg of composition):(mg furosine/100 g protein) of the composition after storage at 25° C. for 28 days after manufacture is at least 85% that of the composition immediately after manufacture; and/or
fff. any combination of two or more of any of a) to g) above; or
ggg. each of a) to g) above.

53-56. (canceled)
